(19) United States
(12) Patent Application Publication
(10) Pub. No.: US 2019/0361146 A1
(43) Pub. Date: Nov. 28, 2019

(54) SYSTEM AND METHOD FOR PREDICTING WELL PRODUCTION

(71) Applicant: Ground Truth Consulting, Pittsburgh, PA (US)

(72) Inventors: Michael Gary ROTH, Pittsburgh, PA (US); Murray Wayne ROTH, Highlands Ranch, CO (US)

(21) Appl. No.: 16/477,704

(22) PCT Filed: Jan. 15, 2018
(86) PCT No.: PCT/US2018/013705

§ 371 Date: Jul. 12, 2019

Related U.S. Application Data
(60) Provisional application No. 62/446,171, filed on Jan. 13, 2017.
(60) Provisional application No. 62/616,684, filed on Jan. 12, 2018.

(51) Int. Cl. G01V 99/00

(52) U.S. Cl. CPC G01V 99/005

(57) ABSTRACT

A system and method for predicting well production at various stages in the life cycle of the well utilizes data received from a plurality of databases via one or more database interfaces to generate various attributes that can be used to predict well production. Each prediction is accompanied by a determined certainty level to show the probability of the predicted result actually occurring. Additionally, users of the system and method disclosed herein can apply economic parameters to the prediction to model the economic return of the well over time. In addition to providing insight regarding existing wells, the present disclosure may be used to design new wells and to predict the production thereof before breaking ground on the well, thus allowing users of the present disclosure to prioritize the expenditure of resources on wells that are most likely to be the most productive.

### CROSS-REFERENCE TO RELATED APPLICATIONS

This application claims priority to U.S. Provisional Patent Application No. 62/446,171, filed on Jan. 13, 2017 and entitled “System and Method for Predicting Well Production,” the entirety of which is hereby incorporated herein by reference. This application also claims priority to U.S. Provisional Patent Application No. 62/616,684, filed on Jan. 12, 2018 and entitled “System and Method for Predicting Well Production,” the entirety of which is hereby incorporated herein by reference.

### FIELD OF THE DISCLOSURE

The present disclosure relates to systems and methods for predicting the production of a well at different stages of the well life cycle.

### BACKGROUND

Valuable natural resources, including oil and natural gas, are typically extracted from underground reservoirs through wells. Well-drilling technology has improved significantly over the years, with key advancements including the ability to drill horizontally as well as the development of hydraulic fracturing (or “fracking”) methods. While these and other improvements have enabled the drilling of wells with greater productivity, the ability to predict that productivity has remained elusive.

### SUMMARY OF THE INVENTION

As wells are drilled horizontally, they need to be steered to target optimal geologic targets while avoiding major hazards and severe or unnecessary undulations in the wellbore path. The technology described herein may be used to inform and/or guide the geosteering process, which may include solving for the optimal path of a well to maximize production while reducing risk. For example, aspects of the present disclosure may be incorporated into an automated geosteering system that would allow wells to steer themselves (e.g., that would allow drilling rigs to automatically steer the drill bit so as to drill an optimized well).

The present disclosure is also useful for planning wells, by identifying optimal well locations and well designs. Aspects of the present disclosure may be incorporated into an automated well planning system that will plan all wells in a given area for an operator.

The present disclosure is useful as well for planning entire fields of wells, by accounting for the impacts of well spacing on performance so as to maximize economic return. One application of the present disclosure, therefore, is an automatic field planning system that plans all future development of an oilfield for an operator.

The present disclosure describes, in part, systems and methods useful for automating various tasks, with attendant benefits such as increased efficiency, reduced costs, and improved results.

The present disclosure describes a system and method for predicting well production at various stages in the life cycle of the well. Each prediction is accompanied by a determined certainty level to show the probability of the predicted result actually occurring. Additionally, users of the system and method disclosed herein can apply economic parameters to the prediction to model the economic return of the well over time. In addition to providing insight regarding existing wells, the present disclosure may be used to design new wells and to predict the production thereof before breaking ground on the well, thus allowing users of embodiments of the present disclosure to prioritize the expenditure of resources on wells that are most likely to be the most productive.

A system according to one embodiment of the present disclosure comprises a plurality of sensors distributed throughout a geographical area, wherein the plurality of sensors convert information related to the geographical area into sensor data; a first sensor information storage system that receives sensor data from a first subset of the plurality of sensors and stores the sensor data received from the first subset of the plurality of sensors in a first database as first sensor data; a second sensor information storage system that receives sensor data from a second subset of the plurality of sensors and stores the sensor data received from the second subset of the plurality of sensors in a second database as second sensor data, wherein the second sensor data is different from the first sensor data and is used to describe a different physical aspect of the geographical area; at least one well positioned in or near the geographical area; and a computational device.

The computational device comprises a processor; a database interface that enables the processor to transmit queries to both the first sensor information storage system and the second sensor information storage system, wherein the database interface further facilitates receipt of at least some first sensor data and at least some second sensor data from the first sensor information storage system and second sensor information storage system, respectively; and a memory device that includes instructions stored thereon that enable the processor to perform the following: generate a structural model for at least some of the geographical area based on the at least some first sensor data and the at least some second sensor data, wherein the structural model is generated with reference to a set of rules that define one or more characteristics of geologic layers or formations, and wherein the structural model includes an assignment of the at least one well thereto; prepare an analysis of the structural model that includes a prediction of performance for the at least one well, wherein the prediction of performance is based, at least in part, on a location of the at least one well within the structural model, a length of the at least one well, an average distance from the at least one well to a bottom of a formation in the structural model, a distance between wells in the geographical area, and an average percentage location between a top and bottom of a primary formation in the structural model; generate a geologic property map for at least some of the geographical area based on the at least some first sensor data and the at least some second sensor data, wherein the geologic property map is generated with reference to historical production information for the at least one well; and generate user interface presentation instructions for causing the display of the prediction of performance for the at least one well along with one or both of: (i) the geologic property map and (ii) the structural model.

The database interface may structure the queries to the first sensor information storage system and the second sensor information storage system based on an identifier of the at least one well, a location of the at least one well, a location of the geographical area, and/or an identifier of the geographical area. The memory device of the computational device may temporarily store the at least some first sensor data and the at least some second sensor data while the instructions are executed. The computational device may comprise a user interface that renders at least one graphical user interface (GUI) element based on the user interface presentation instructions. The computational device may further comprise a network interface that transmits the user interface presentation instructions to a client device in a browser-based format. The prediction of performance may be displayed along with a probability of the prediction of performance. The prediction of performance may also be based on a determined depletion metric or attribute.

The first sensor information storage system may be operated by a first entity, the second sensor information storage system may be operated by a second entity, and the database queries may be transmitted over a communication network using a standard-based database query protocol. In some embodiments, the system may further comprise a reported data storage system in which reported data is stored. The database interface may further enable the processor to transmit queries to the reported data storage system and may further facilitate the receipt of at least some reported data from the reported data storage system. The generating the structural model may be further based on the at least some reported data, and the generating the geologic property map may be further based on the at least some reported data.

A server configured to predict well performance according to another embodiment of the present disclosure comprise a processor; a database interface that enables the processor to transmit queries to a plurality of databases, and facilitates the receipt of at least first data from a first database and second data from a second database, the first data and the second data corresponding to a plurality of wells within a geographic area; a user interface comprising a display; and a computer-readable memory storing instructions for execution by the processor that, when executed by the processor, cause the processor to: identify one or more data gaps within the first data and the second data; generate, for each data gap and using a mapping-set based machine learning technique, predicted data; replace each data gap with the missing data to yield quality-controlled first data and quality-controlled second data; generate, for each of the plurality of wells and based on the quality-controlled first data and the quality-controlled second data, a well attribute; generate a structural model corresponding to the geographic area based on the well attribute of each of the plurality of wells, and based on a rule set that corresponds to one or more geological characteristics; and predict, for a planned well within the geographic area and using the structural model, a planned well attribute.

The well attribute may be a depletion estimate attribute or metric. The depletion estimate attribute or metric for each well may be based on both lateral and vertical distance to one or more neighboring wells. The computer-readable memory may store additional instructions for execution by the processor that, when executed by the processor, further cause the processor to: generate instructions for causing the display to depict a graphical representation of the structural model, the planned well, and the planned well attribute. The generating a well attribute may comprise generating a plurality of well attributes, the generating a structural model may be based on the plurality of well attributes, and the predicting a planned well attribute may comprise predicting a plurality of planned well attributes. The computer-readable memory may store additional instructions for execution by the processor that, when executed by the processor, further cause the processor to generate a production prediction for the planned well based on the plurality of planned well attributes. The computer-readable memory may store additional instructions for execution by the processor that, when executed by the processor, further cause the processor to identify, based on the structural model, a location within the geographic area where a new well would have a maximum production prediction. The computer-readable memory may store additional instructions for execution by the processor that, when executed by the processor, further cause the processor to generate a production prediction for each of a plurality of planned wells based on the structural model, wherein the production prediction accounts for depletion effects of the plurality of planned wells.

A method of predicting well production according to yet another embodiment of the present disclosure comprises: receiving at a processor, via a network interface and from a plurality of information storage sources, received information about a plurality of wells in a defined geographic area, the received information comprising well location data, fracking data, production test data, completion data, production data, and directional survey data; detecting, with the processor, gaps within the received information, each gap corresponding to a missing data point; generating, with the processor, a predicted data point corresponding to each missing data point using a mapping-set based machine learning technique; substituting, with the processor, the gaps with the corresponding predicted data points to yield quality-controlled received information; generating, with the processor, for each well in the plurality of wells and based on the quality-controlled received information, a plurality of attributes; generating, with the processor and based on the quality-controlled received information and the plurality of attributes, and with reference to a set of rules defining characteristics of geologic layers or formations, a structural model corresponding to the defined geographic area; analyzing, with the processor, the structural model to yield a result comprising one or more of (i) an optimal design for a new well at a specified location within the defined geographic area; (ii) an optimal number of new wells for the defined geographic area to maximize production from the defined geographic area; and (iii) a predicted performance of a new well at a specified location within the defined geographic area and having a specified design; and transmitting, from the processor, instructions for displaying a graphical depiction of the result.

The result may be an optimal design for a new well at a specified location with the defined geographic area, and the method may further comprise transmitting, from the processor and to a drilling control system of an oil rig, instructions for drilling a well having the optimal design. The structural model may be three-dimensional, and the generating the structural model may comprise generating, with the processor and based on the plurality of attributes, a plurality of two-dimensional geologic property maps, and stacking the plurality of two-dimensional geologic property maps to yield the three-dimensional structural model.

The term “computer-readable medium,” as used herein, refers to any tangible and non-transitory storage medium that stores or is capable of storing instructions for execution by a processor. Such a medium may take many forms, including but not limited to, non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software aspects of the present disclosure are stored.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used, and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram of a system according to one embodiment of the present disclosure.

FIG. 2 is a flowchart showing a process according to one embodiment of the present disclosure.

FIG. 3 is a table with a plurality of missing data, with respect to which the process of FIG. 2 may be used to fill in the missing data.

FIG. 4 is a plurality of tables illustrating some aspects of the process of FIG. 2.

FIG. 5 is a plurality of tables illustrating some aspects of the process of FIG. 2.

FIG. 6 is a plurality of tables illustrating some aspects of the process of FIG. 2.

FIG. 7 is a plurality of tables illustrating some aspects of the process of FIG. 2.

FIG. 8 is a plurality of tables illustrating some aspects of the process of FIG. 2.

FIG. 9 is a plurality of tables illustrating some aspects of the process of FIG. 2.

FIG. 10 is a plurality of tables illustrating some aspects of the process of FIG. 2.

FIG. 11 is a plurality of tables illustrating some aspects of the process of FIG. 2.

FIG. 12 is a plurality of tables illustrating some aspects of the process of FIG. 2.

FIG. 13 is a plurality of tables illustrating some aspects of the process of FIG. 2.

FIG. 14 is a table illustrating an alternative application of the process of FIG. 2.

FIG. 15 is a flowchart illustrating a process according to one embodiment of the present disclosure.

FIG. 16 is a flowchart showing a process according to another embodiment of the present disclosure.

FIG. 17A is a side elevational view of a well.

FIG. 17B is a top plan view of the well of FIG. 17A.

FIG. 18A illustrates a process of estimating a directional survey for a well with a known surface location and bottom hole location, according to one embodiment of the present disclosure.

FIG. 18B illustrates a process of estimating a directional survey for a well with a known surface location and bottom hole location and at least one neighboring well, according to another embodiment of the present disclosure.

FIG. 18C illustrates a process of estimating a directional survey for a group of neighboring wells with a known surface location and bottom hole locations.

FIG. 18D illustrates a method of estimating the true vertical depth of a well according to one embodiment of the present disclosure.

FIG. 18E illustrates a method of estimating the true vertical depth of a well according to another embodiment of the present disclosure.

FIG. 19 is a table showing production data according to some embodiments of the present disclosure.

FIG. 20 is a table showing production data according to some embodiments of the present disclosure.

FIG. 21 is a plot of the production data in the table of FIG. 20.

FIG. 22 is a reproduction of the plot of FIG. 21, in which sampling intervals are shown by vertical lines.

FIG. 23 is a table showing data from each sampling interval identified in FIG. 22.

FIG. 24 is a table illustrating one or more benefits of aspects of the present disclosure.

FIG. 25 is a structural depth grid modeling a formation top surface, generated based on discrete formation top data points obtained from ten different wells.

FIG. 26 is a structural depth grid modeled using eight of the ten discrete formation top data points obtained from eight of the ten different wells of FIG. 25, and showing a comparison between the structural depth grid and the remaining two discrete formation top data points obtained from the remaining two of the ten different wells.

FIG. 27 is a structural depth grid modeled using the remaining nine discrete formation top data points of FIG. 25 after one outlier discrete formation top data point was excluded from consideration.

FIG. 28 is a collection of three depth surfaces, such as might be input into an automated structural model generation process according to some embodiments of the present disclosure.

FIG. 29 is a structural model such as might be output by an automated structural model generation process according to some embodiments of the present disclosure, based on an input of the three depth surfaces depicted in FIG. 28.

FIG. 30 is an illustration of a vertical wellbore in the structural model of FIG. 29.

FIG. 31 is an illustration of a horizontal wellbore in the structural model of FIG. 29.

FIG. 32 is a side elevational view of the horizontal wellbore of FIG. 31 in the structural model of FIG. 29.

FIG. 33 is a plot of a plurality of wells, each assigned to one of a Zone 1 producing formation and a Zone 2 producing formation, such as might be input into an automated geologic property map gridding process according to embodiments of the present disclosure.

FIG. 34 is a plot of the wells of FIG. 33 that are assigned to the Zone 1 producing formation only, such as might be generated during an automated geologic property map gridding process according to embodiments of the present disclosure.

FIG. 35 is the plot of FIG. 34, showing each depicted well's value for a given attribute, such as might be generated during an automated geologic property map gridding process according to embodiments of the present disclosure.

FIG. 36a is an initial gridded geologic property map showing predicted attribute values across the entire map, such as might be generated during an automated geologic property map gridding process according to embodiments of the present disclosure, based upon the attribute values of each depicted well.

FIG. 36b is an intermediate gridded geologic property map showing predicted attribute values across the entire map, such as might be generated during an automated geologic property map gridding process according to embodiments of the present disclosure, based upon the attribute values of all but two depicted wells.

FIG. 36c is a final gridded geologic property map showing predicted attribute values across the entire map, such as might be generated during an automated geologic property map gridding process according to embodiments of the present disclosure, based upon the attribute values of all depicted wells except any outlier depicted wells.

FIG. 37 is a pair of geologic property maps showing the 3-9 month water cut and 3-month gas cut for an actual geographic location.

FIG. 38 is three-dimensional structural model that provides a formation depth structure framework.

FIG. 39a is a gridded geologic property map for a specific attribute showing the location of a horizontal wellbore for which the specific attribute is unknown.

FIG. 39b is the gridded geologic property map of FIG. 39a, in which the specific attribute for the horizontal wellbore is predicted based on the values of the gridded geologic property map.

FIG. 40a shows a well within a three-dimensional structural model, for which well the property or attribute modeled in the three-dimensional structural model is unknown.

FIG. 40b shows the well of FIG. 40b, for which well the previously unknown property or attribute has been predicted using the three-dimensional structural model.

FIG. 41 is an overview of the depletion metric determination process.

FIG. 42 is a series of charts depicting different amounts of permeability overlap based on lateral well spacing.

FIG. 43 is a series of charts showing the overlap between production zones of adjacent wells for use in calculating a depletion estimate.

FIG. 44 is a chart illustrating how a distance- and time-weighted depletion estimate is determined for a well pair, using a logistic function.

FIG. 45 is an overview of the injected material metric determination process.

FIG. 46 is a series of charts showing the determination of the amount of overlap in fluid transferability of adjacent wells.

FIG. 47 is a chart illustrating how a distance- and time-weighted frac fluid density estimate is determined for a well pair, using a logistic function.

FIG. 48 is a pair of frac hit detection charts showing changes in oil production rate and water production rate, respectively, over time, as well as completion data of target wells.

FIG. 49 is a dashboard interface with a chart showing the predicted production of a well at the permitting stage, together with the uncertainty level of that prediction.

FIG. 50 is a dashboard interface with a chart showing the predicted production of a well at the drilled stage, together with the uncertainty level of that prediction.

FIG. 51 is a dashboard interface with a chart showing the predicted production of a well at the completed stage, together with the uncertainty level of that prediction.

FIG. 52 is a dashboard interface with a chart showing the predicted production of a well at the initial production stage, together with the uncertainty level of that prediction.

FIG. 53 is a dashboard interface with a chart showing the actual production to date and the predicted production going forward of a well at the ongoing production stage, together with the uncertainty level of that prediction.

FIG. 54 is a dashboard interface with a chart showing the probability, determined at the permitting stage, of achieving different levels of production over the first thirty-six months of production for a given well.

FIG. 55 is a dashboard interface with a chart showing the predicted financial performance of an existing well over the well's life cycle.

FIG. 56 is a dashboard interface with a chart comparing the predictions and associated uncertainties for total production at six months made at different stages in the life cycle of a given well.

FIG. 57 is a dashboard interface with a chart comparing the predictions and associated uncertainties for total production at twenty-seven months made at different stages in the life cycle of a given well.

FIG. 58 is a dashboard interface with inputs for well design parameters and a chart showing the predicted production of a well based on the well design parameters.

FIG. 59 is a dashboard interface with input fields for economic parameters and a chart showing the predicted financial performance of a proposed well based on the economic parameters.

FIG. 60 is a dashboard showing a series of prediction impact plots as well as a control panel for assigning values to the variables modeled in the prediction impact plots;

FIG. 61 is the dashboard of FIG. 60, in which two of the variables modeled in the prediction impact plots have been changed.

FIG. 62 is a series of maps depicting predicted oil production by location for a given well design.

FIG. 63 is a map depicting possible locations of new wells at a first given lateral spacing between wells.

FIG. 64 is a map depicting possible locations of new wells at a second given lateral spacing between wells.

FIG. 65 is a graphical depiction of the number of available new well locations for different lateral spacings between wells.

FIG. 66 is a chart of predicted production fraction of maximum predicted production versus well spacing.

FIG. 67 is a chart of predicted net profit versus lateral well spacing.

FIG. 68 is a series of charts depicting the process for identifying an optimal well design.

FIG. 69 is a three-dimensional production prediction model.

FIG. 70 is the three-dimensional production prediction model of FIG. 69, showing a single planned well.

FIG. 71 is the three-dimensional production prediction model of FIG. 71, showing two planned wells.

FIG. 72 is an elevational view of a wellbore showing a potential hazard intersected thereby.

FIG. 73 is a perspective view of two wellbores that intersect a potential hazard, showing a predicted surface of the potential hazard.

FIG. 74 is a plan view of the two wellbores shown in FIG. 73.

FIG. 75 is a plan view of a plurality of wellbores, illustrating the projection of a potential hazard.

FIG. 76 is a plan view of a plurality of wellbores, illustrating the determination of minimum distances from each wellbore to a potential hazard.

FIG. 77 is a plan view of a plurality of wellbores, showing a plot of distance from a potential hazard.

FIG. 78 is a block diagram of a system according to one embodiment of the present disclosure.

### DETAILED DESCRIPTION

### Copyright and Legal Notices

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

One barrier to the effective use of analytics to inform analysis and decision-making in relation to oil and gas exploration and production efforts is the lack of available decision-ready data. Oil and gas data broadly falls into two different categories: proprietary data (which is data collected by an operator on the operator's own wells, or received in a data trade from other operators, and is not available to the public) and public data (which is data submitted to state and federal regulatory commissions or provided in press releases by operators, and can be accessed by the public, even if only through a subscription to one or more state databases or commercial data sources).

Proprietary data tends to be more comprehensive and accurate, but is often limited in scope as it only covers a single operator or a handful of operators, and covers only localized regions. In other words, the data provides narrow coverage, but in-depth details across the scope of coverage.

Public data tends to be less comprehensive, with less data made available and available data often having missing entries or incorrect values. However, the public data often spans entire basins. In other words, the data provides narrow coverage, but only shallow details across the scope of coverage.

To perform meaningful analytics, the data used for the analytics needs to have the wide coverage of public data while also having the accuracy and depth of proprietary data. The present disclosure includes one or more devices and methods for taking publicly available data and transforming it to be more accurate and comprehensive by (1) quality controlling the data for errors; (2) correcting errors in the data; (3) infilling missing values; (4) generating new attributes; and (5) overcoming limitations in the depth of data.

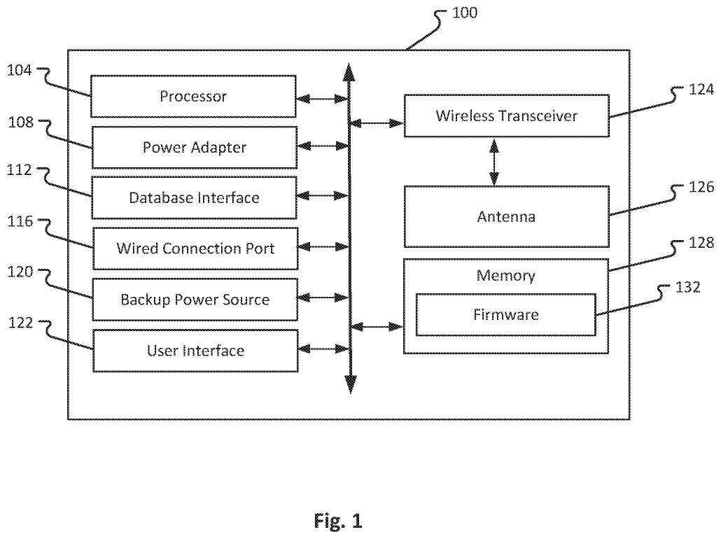

Referring first to FIG. 1, a device 100 according to one embodiment of the present disclosure may comprise a processor 104, a power adapter 108, a plurality of database interfaces 112, one or more wired connection ports 116, a backup power source 120, a user interface 122, a wireless transceiver 124 coupled to an antenna 126, and a memory 128.

The processor 104 may correspond to one or multiple microprocessors that are contained within a housing of the device 100. The processor 104 may comprise a Central Processing Unit (CPU) on a single Integrated Circuit (IC) or a few IC chips. The processor 104 may be a multipurpose, programmable device that accepts digital data as input, processes the digital data according to instructions stored in its internal memory, and provides results as output. The processor 104 may implement sequential digital logic as it has internal memory. As with most known microprocessors, the processor 104 may operate on numbers and symbols represented in the binary numeral system.

The power adapter 108 comprises circuitry for receiving power from an external source, such as a power receptacle, and for accomplishing any signal transformation, conversion or conditioning needed to provide an appropriate power signal to the processor 104 and other components of the device 100. For example, the power adapter 108 may comprise one or more AC to DC or DC to DC converters for converting an incoming power signal into a higher or lower voltage as necessary to power the various components of the device 100. Not every component of the device 100 necessarily operates at the same voltage, and if different voltages are necessary, then the power adapter 108 may include a plurality of AC to DC or DC to DC converters. Additionally, even if one or more components of the device 100 do operate at the same voltage as the incoming power signal, the power adapter 108 may condition the incoming signal to ensure that the power signal(s) being provided to the other components of the device 100 remains within a specific tolerance (e.g. plus or minus 0.5 volts) regardless of fluctuations in the incoming power signal. In some embodiments, the power supply 108 may also include some implementation of surge protection circuitry to protect the components of the device 100 from power surges.

The power adapter 108 may also comprise circuitry for receiving power from the backup power source 120 and carrying out the necessary power conversion and/or conditioning so that the backup power source 120 may be used to power the various components of the device 100. The backup power source 120 may be used, for example, to power an uninterruptible power supply to protect against momentary drops in the voltage provided by the main power source.

The one or more database interfaces 112 enable communications between the device 100 and one or more databases (not shown). The database interfaces 112 may comprise hardware and/or software. The hardware may include, for example, one or more networking or other communication ports, such as a serial port, a parallel port, a USB port, a Firewire port, or an Ethernet port. The software may comprise instructions for execution by the processor that cause the processor to receive data from a database in a first format, convert the data from the first format to a second format, then store the data in the memory 128 or transmit the data via the wired connection port 116 or the wireless transceiver 124. The second format may be common across all of the database interfaces 112, such that data may be received via each database interface 112 in a plurality of first formats, but be converted, translated, or otherwise processed into a common second format for use in carrying out additional aspects of the present disclosure. In some embodiments, the database interfaces 112 may also be used to generate and/or to translate queries, so as to allow the processor 104 to request information from one or more databases connected to the one or more database interfaces 112.

Databases from which the device 100 may receive data (whether automatically based on a predetermined schedule and/or preprogrammed query, or in response to specific queries) include databases containing well/well header data; databases containing hydraulic fracture drilling fluid chemical ingredient data; databases containing production test data (e.g. initial production data); databases containing regular production data; databases containing directional survey data; databases containing geologic formations data (e.g., geologic structure maps); databases containing elevation or other geographic data; databases containing real estate data (e.g., property boundary maps); databases containing economic data (including, for example, data about the market price of oil, natural gas, or other natural resources, whether presently or over time; data about the cost of real estate presently or over time; data about the cost of mineral rights presently or over time; data about the cost of drilling equipment presently or over time; and data about the cost of hydraulic fracture drilling fluid presently or over time); government-owned databases; and privately owned databases.

The device 100 may also comprise a backup power source 120. The backup power source 120 may be, for example, one or more batteries (e.g., 12-volt batteries, AAA batteries, AA batteries, 9-volt batteries, lithium ion batteries, button cell batteries, one or more Tesla Powerwalls or similar batteries). The backup power source 120 may be used to temporarily power the device 100 in the event of a power interruption, and/or to provide supplemental power if the power obtained by the power adapter 108 from the external power source is insufficient.

A user interface 122 is further provided with the device 100. The user interface 122 allows a user of the device 100 to input information into the device 100 and to obtain information from the device 100. The user interface 122 may comprise one or both of an output device (e.g. a display screen, a printer), an input device (e.g. a keyboard, a mouse, a trackpad), and/or a combination of the two (e.g. a touchscreen display). The user interface may be used, for example, to provide instructions to the processor 104, to obtain information from the memory 128, to adjust one or more settings of the device 100, to cause information to be stored in the memory 128, and to configure one or more database interfaces 112.

The wireless transceiver 124 comprises hardware that allows the device 100 to transmit and receive commands and data to and from one or more separate devices and/or networks. In some embodiments, for example, the wireless transceiver 124 may receive data from one or more databases, and may pass that data to an appropriate database interface 112 upon receipt. In other embodiments, the wireless transceiver 124 may be used to receive commands and/or to transmit data from a separate computing device or server, and/or via a wide area network (such as the Internet), a local area network, a peer-to-peer connection, or any other wireless network or connection. The wireless transceiver 124 may also be used for transmitting data from a well in the field to the cloud, and/or for receiving information from and transmitting commands to the control center of an oil rig that is in the process of drilling a well.

The wireless transceiver 124 may comprise, for example, a satellite communications link, a Wi-Fi card, a Network Interface Card (NIC), a cellular interface (e.g., antenna, filters, and associated circuitry), an NFC interface, an RFID interface, a ZigBee interface, a FeliCa interface, a MiWi interface, Bluetooth interface, or a Bluetooth low energy (BLE) interface.

In some embodiments, a wired connection port 116 may be used instead of or in addition to the wireless transceiver 124, to accomplish the same or similar functions. The wired connection port 116 may be utilized, for example, to connect the device 100 to a communications network. The wired connection port 116 may also be utilized to transmit commands to and receive information from an oil rig control center, so as to allow the device 100 to control (whether directly or indirectly) the operation of the drilling rig with respect to the drilling of a well.

The memory 128 may correspond to any type of non-transitory computer-readable medium. In some embodiments, the memory 128 may comprise volatile or non-volatile memory and a controller for the same. Non-limiting examples of memory 128 that may be utilized in the device 100 include RAM, ROM, buffer memory, flash memory, solid-state memory, or variants thereof.

The memory 128 stores any firmware 132 needed for allowing the processor 104 to operate and/or communicate with the various components of the device 100, as needed. The firmware 132 may also comprise drivers for one or more of the components of the device 100. In addition, the memory 128 may store one or more modules for carrying out the various steps described herein. In particular, the memory 128 may store instructions for execution by the processor that, when executed, cause the processor to receive data from one or more sources, normalize the data as necessary, make a prediction based on the data, compare the prediction to actual results, and adjust a prediction algorithm that was used to make the prediction based on the comparison so that future predictions are made using the adjusted prediction algorithm. The instructions thus allow the processor not only to make predictions based on available data, but also to utilize machine learning to improve future predictions based on a comparison of past predictions to actual results. In some embodiments, the machine learning may involve identifying one or more additional types of data or data points that should be taken into account to improve the accuracy of a prediction, or identifying one or more types of data or data points that were being used to make the prediction but that negatively affected the accuracy of the prediction, or adjusting the relative weight of one or more types of data or data points being used to make the prediction so as to improve the accuracy of the prediction.

As noted above, datasets used in embodiments of the present disclosure are frequently missing crucial pieces of information. According to some embodiments of the present disclosure, mapping set-based machine learning is used to fill in missing data. Mapping set-based machine learning provides a method for using existing data to predict the value of the missing data. The mapping set-based machine learning method may be used, for example, to fill in missing well header data, engineering data, and frac chemical data.

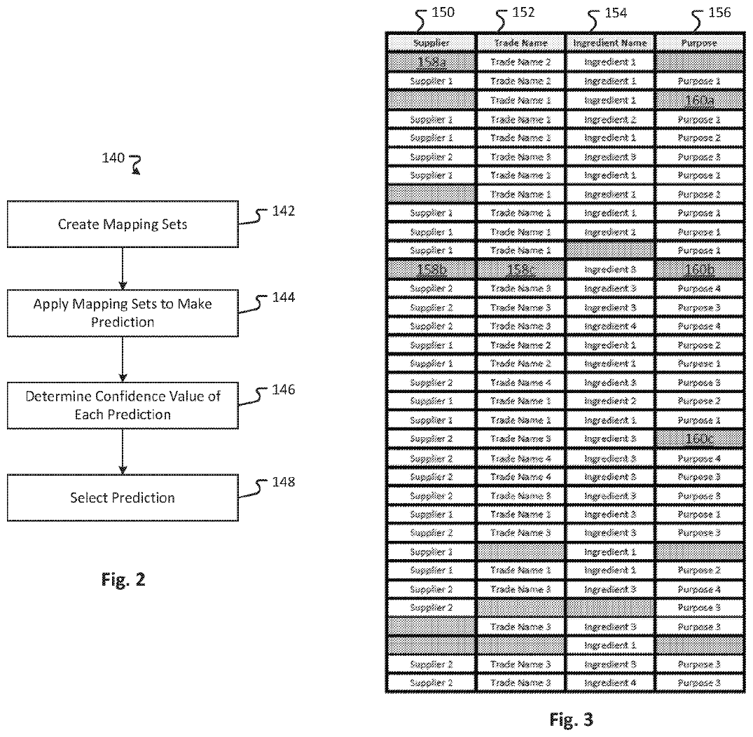

Typically, when data is missing, the missing value is imputed or filled in using the mode or median value of the variable in the data set. Most machine learning solutions involve picking a single set of input variables and using them to make a prediction for the output variable. This approach does not work well, however, in cases when values within the input variables are also missing, as is often the case with the raw data used in the present disclosure. The mapping set-based machine learning method 140 shown in FIG. 2 is unique at least in part because instead of using the mode of a given variable within the entire data set, the method uses the mode within a specific condition most similar to the condition of the input data, as explained in greater detail below.

The mapping set-based machine learning method 140 involves creating a variety of mapping sets that define relationships between sets of input values and the most likely output value (step 142). The mapping sets are created using instances where the output value is known (which mapping sets are referred to as training data). Often, mapping sets are created for hundreds of different combinations of potential input variables for a given output variable, with every combination of available input variables being used to create a mapping set. All available variables are used to build the most comprehensive mapping set possible. This means, however, that the available statistics in each set are limited.

Mapping sets created with many variables have more accuracy, but have a smaller sample as there are fewer values in the training set. Mapping sets created with fewer variables have less accuracy but a larger sample size. Ideally, a set would have both high accuracy and a large population of training data, but this is often not possible. As a result, the machine learning method of the present disclosure seeks to determine the optimal blend of these two constraints.

All available mapping sets are applied to make a prediction for an unknown output value (step 144). A mapping set is available if the input variables used to generate the mapping set are known for the desired output variable. For example, if a mapping set uses supplier name, trade name, and ingredient name to predict a purpose, but a purpose needs to be predicted based upon only the supplier name and ingredient name, then the mapping set in question (that is based on supplier name, trade name, and ingredient name) is not available. On the other hand, if a mapping set uses supplier name and ingredient name only to predict a purpose, then the mapping set may be used to predict the unknown purpose.

A confidence value for each mapping set is also determined (step 146). The confidence value is a weighting of the accuracy of the mapping set and the fraction of the data for a given set that was used as the training data (i.e. where the output value was known), and is based on three variables: N, representing the number of times a particular combination of input values is found in the data; K, representing the number of times that the output value is known for a particular combination of input values; and C, representing the number of times that the output value is equal to the most commonly occurring output value for a particular combination of input values. Using these variables, a Training Fraction is calculated by dividing K by N, and a Most Common Fraction is calculated by dividing C by K. The confidence value may be equal to the Most Common Fraction squared, multiplied by the Training Fraction. Other calculations may also be used to determine the confidence value, including but not limited to C*K, C²*K, C³*K, C*K², and C³*K².

As an example of how the confidence value is applied, suppose that when the Supplier is “Supplier 1,” the Trade Name is “Trade Name 1,” and the Ingredient Name is “Ingredient 1,” the Purpose is “Purpose 1” for seventy percent of available data. Then, where the Supplier is Supplier 1, the Trade Name is Trade Name 1, and the Ingredient Name is Ingredient 1, but the Purpose is unknown, the purpose is predicted as Purpose 1.

The prediction with the highest confidence value is selected to fill in the missing output variable (step 148).

The machine learning method 140 can be used in a variety of applications. For example, the method 140 may be used to predict missing values in hydraulic fracturing chemical databases. These databases include information on the chemicals used to hydraulically fracture wells, but are often missing values for many of the fields in the database. The method 140 can be used to fill in the missing values.

As another example, the method 140 can be used to predict missing values in well databases, which include information about each well such as the Operator, Producing Formation, Completion Type, and Completion Date. Oftentimes, values for these fields are missing, but can be filled in using the method 140. The method 140 may also be used for any other application where past trends are a strong indicator of future values, and where the input data can be grouped into mapping sets.

FIG. 3 shows an example data set with which the mapping set-based machine learning method 140 may be utilized. The data set comprises four columns of data, three of which (Supplier column 150, Trade Name column 152, and Ingredient column 154) contain input variables and one of which (Purpose column 156) contains an output variable. The shaded cells, including cells 158a, 158b, 158c, 160a, 160b, and 160c represent missing data.

All of the different combinations of input variables are used to create mapping sets for predicting the missing output variables. Thus, the mapping sets that will be created are: Supplier+Trade Name+Ingredient Name; Supplier+Trade Name; Supplier+Ingredient Name; Trade Name+Ingredient Name; Supplier; Trade Name; and Ingredient Name.

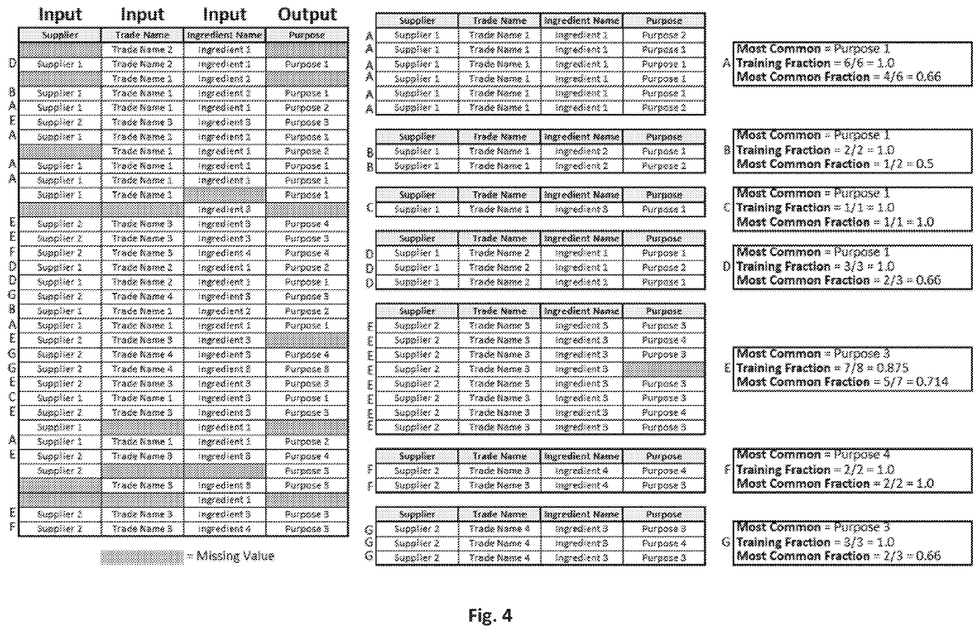

FIG. 4 shows mapping sets and mapping set statistics created for the Supplier+Trade Name+Ingredient Name combination of input variables. For the mapping set in which the Supplier value is Supplier 1, the Trade Name value is Trade Name 1, and the Ingredient Name value is Ingredient 1, the Most Common output variable is Purpose 1, the Training Fraction (representing the percentage of the data entries for which the output variable is known) is 6/6, or 1.0, and the Most Common Fraction (representing the percentage of data entries for which the output variable was equal to the Most Common output variable) is 4/6 or 0.66.

For the mapping set in which the Supplier value is Supplier 2, the Trade Name value is Trade Name 3, and the Ingredient Name value is Ingredient 3, the Most Common output variable is Purpose 3, the Training Fraction is 7/8 or 0.875 (because the output variable is not known for 1 of the 8 input variable combinations), and the Most Common Fraction is 5/7 or 0.71.

The statistics for the other mapping sets corresponding to the Supplier+Trade Name+Ingredient Name combination are set forth in FIG. 4.

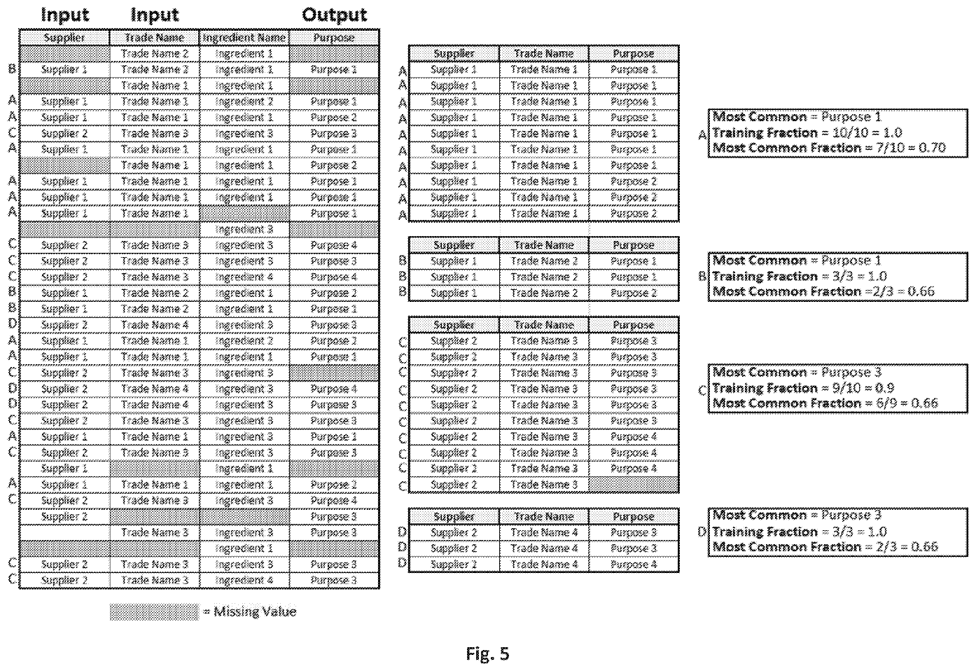

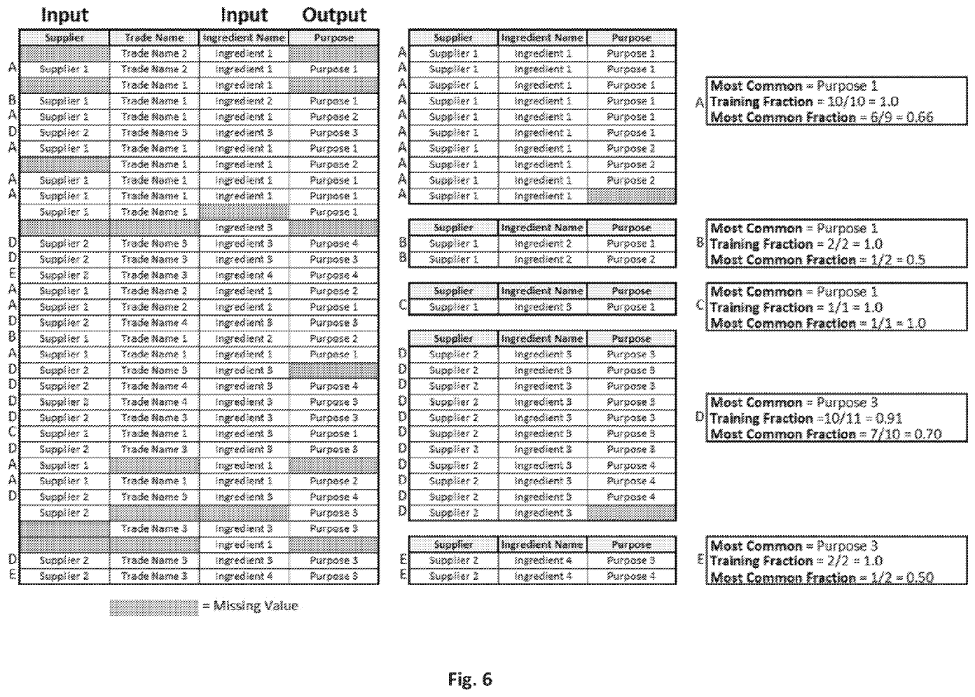

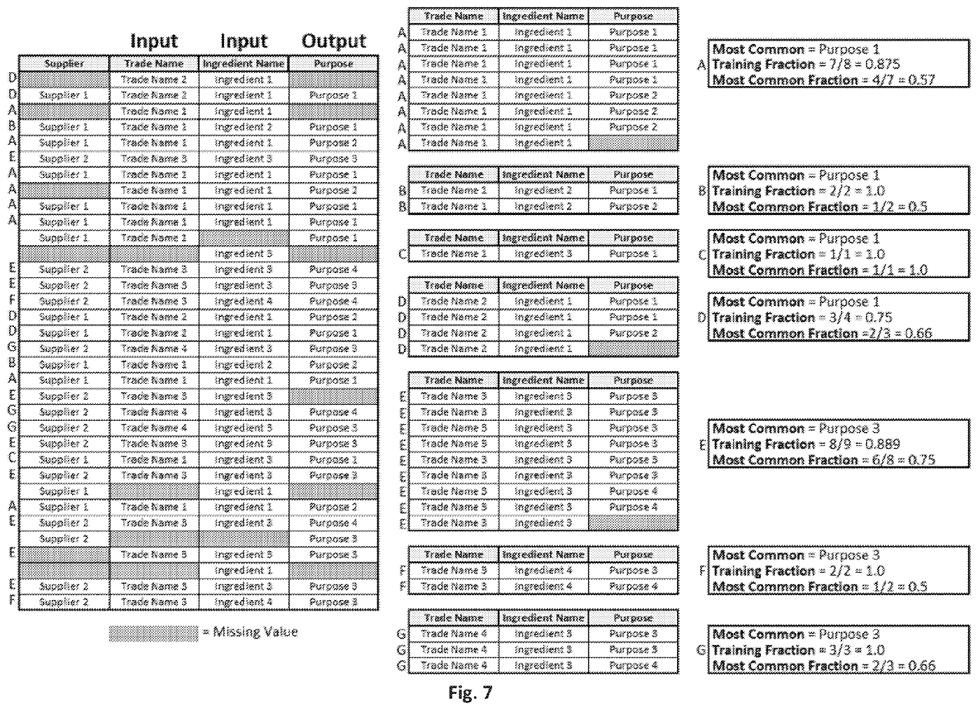

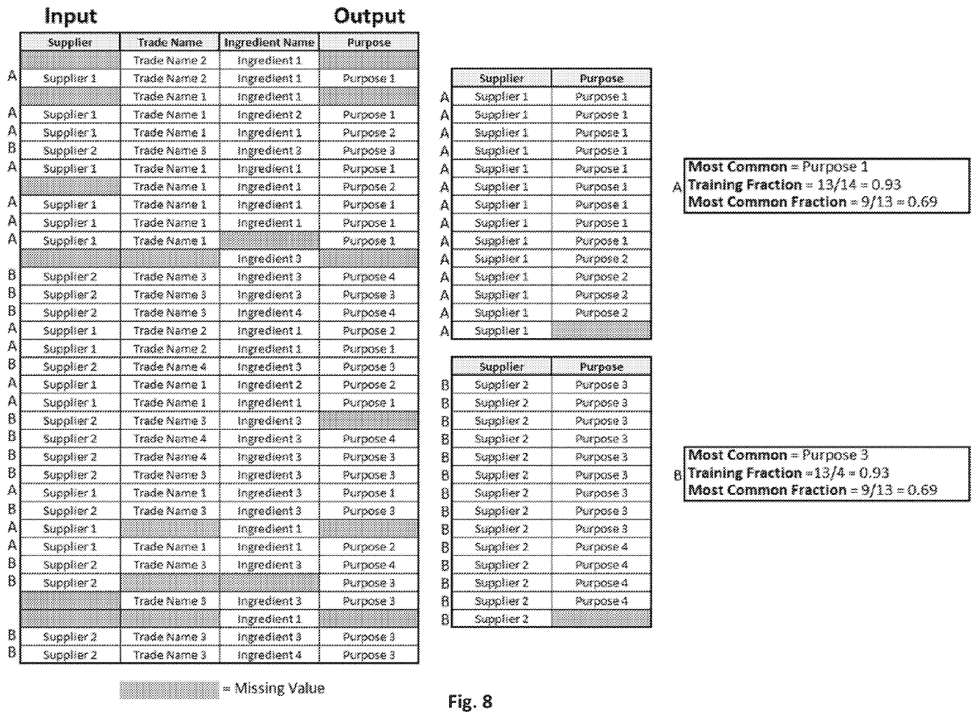

FIGS. 5-10 set forth the mapping sets and corresponding statistics for the remaining input variable combinations. FIG. 5 provides the mapping sets and statistics for the Supplier+Trade Name combination; FIG. 6 provides the mapping sets and statistics for the Supplier+Ingredient Name combination; FIG. 7 provides the mapping sets and statistics for the Trade Name+Ingredient Name combination; and FIGS. 8, 9, and 10 provide the mapping sets and statistics for the Supplier, Trade Name, and Ingredient Name input variables, respectively.

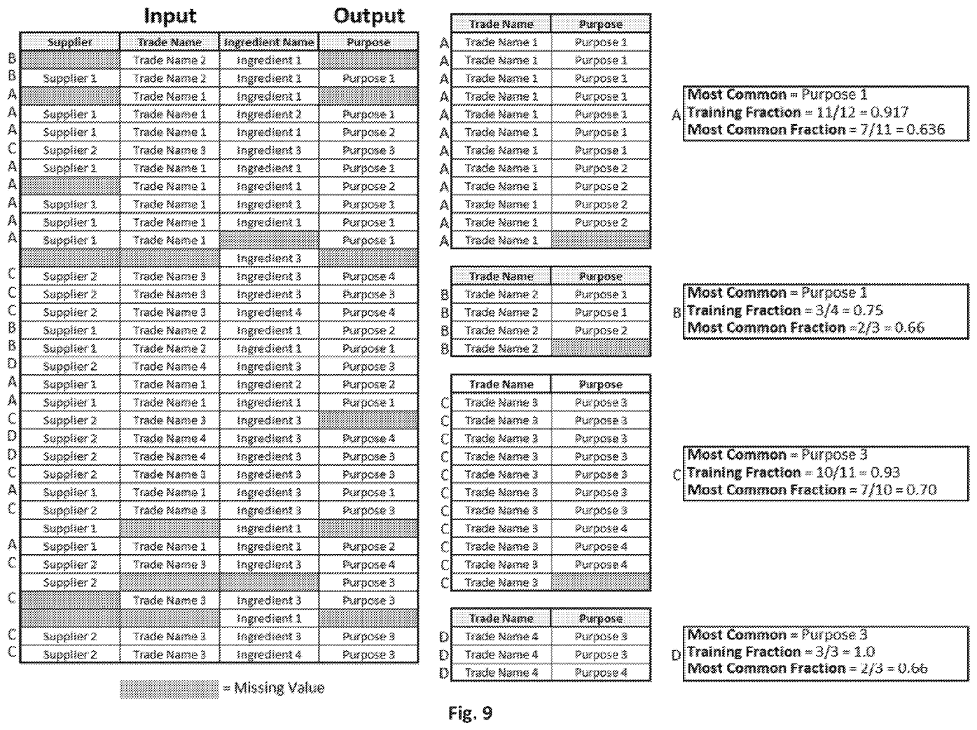

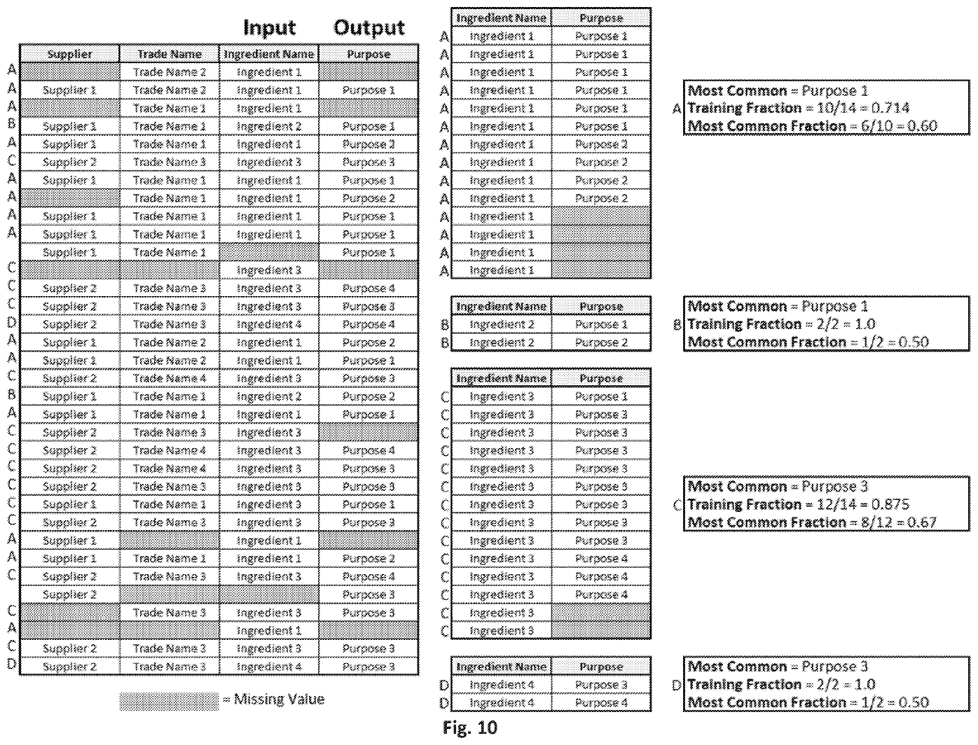

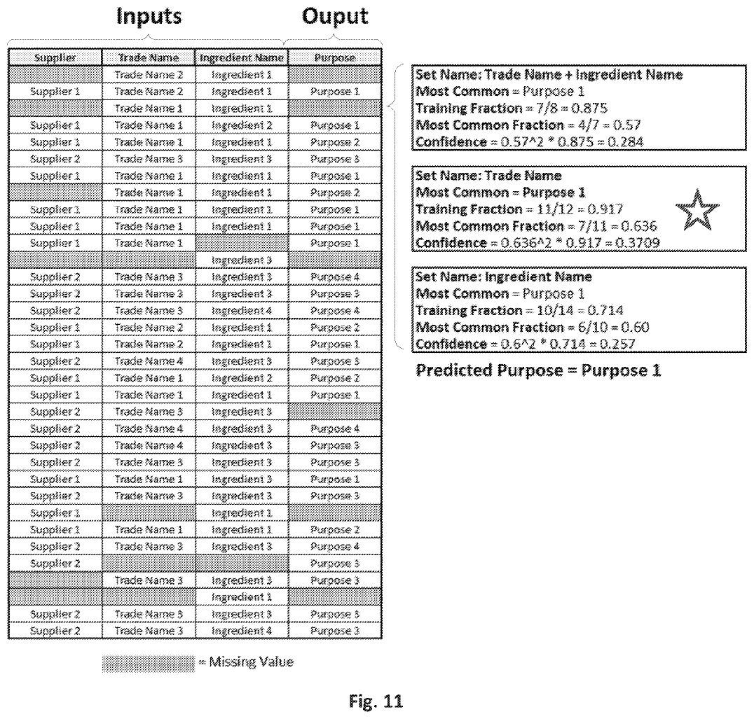

Referring to FIG. 11, to predict a missing output variable, all of the mapping sets that correspond to the available input variables are considered, together with their respective confidence values. For the missing output variable 160a, the Supplier input variable is missing, such that the only available mapping sets are Trade Name+Ingredient Name, Trade Name, and Ingredient Name. The Trade Name+Ingredient Name mapping set indicates that when the Trade Name is Trade Name 1 and the Ingredient Name is Ingredient 1, the Most Common output variable is Purpose 1 (see, for example, FIG. 7). However, the confidence value for the applicable Trade Name+Ingredient Name mapping set is only 0.284. The Trade Name mapping set indicates that when the Trade Name is Trade Name 1, the Most Common output variable is Purpose 1, with a confidence value of 0.3709 (see, for example, FIG. 9). The Ingredient Name mapping set indicates that when the Ingredient Name is Ingredient 1, the Most Common output variable is Purpose 1, with a confidence value of 0.257 (see, for example, FIG. 10). The Trade Name mapping set has the highest confidence value, so the Trade Name mapping set's prediction is used for the missing output variable value. Note that while each of the mapping sets available for use in predicting the missing output variable 160a predicted Purpose 1, in other instances each available mapping set may not predict the same value.

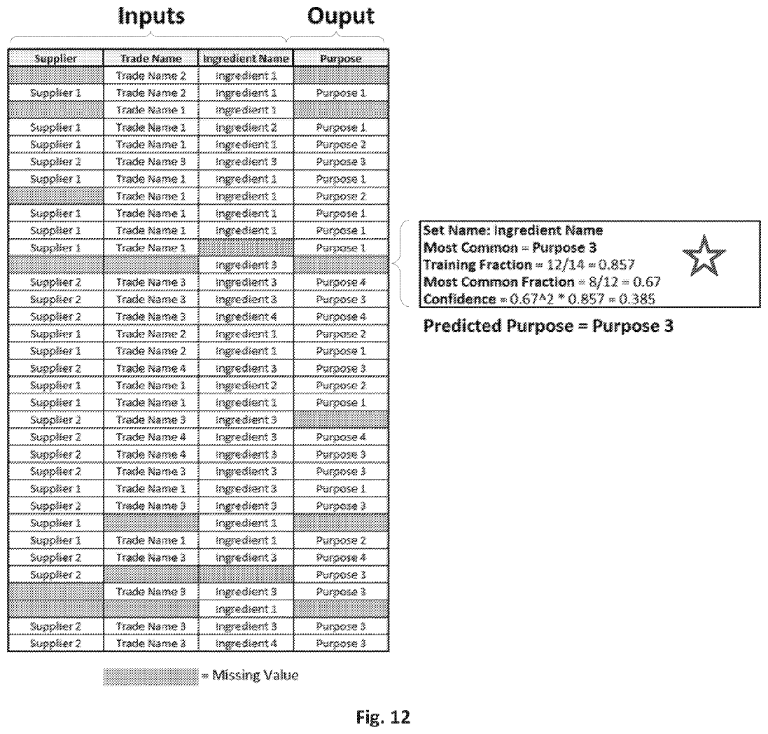

Referring now to FIG. 12, for the missing output variable 160b, only the Ingredient Name input variable is known, such that only the Ingredient Name mapping set is available to predict the output variable. The Ingredient Name mapping set indicates that when the Ingredient Name is Ingredient 3, the Most Common output variable is Purpose 3, with a confidence value of 0.385 (see, for example, FIG. 10). As this prediction is the only available prediction, this prediction is selected to fill in the missing output variable 160b.

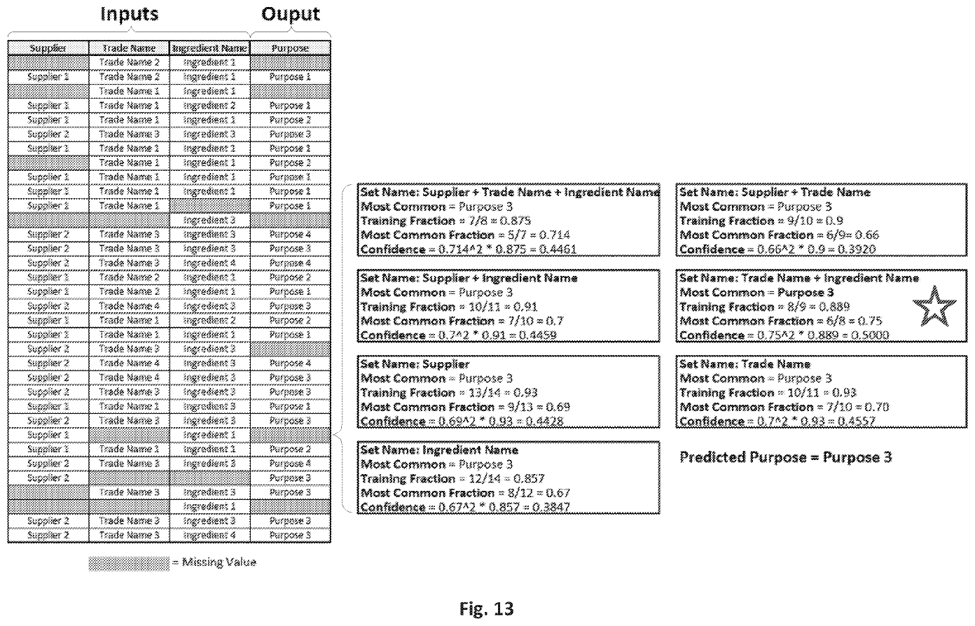

Referring now to FIG. 13, for the missing output variable 160c, all of the input variables are known, such that all of the mapping sets are available to provide a prediction. FIG. 13 shows the Most Common output variable from each of the mapping sets when the Supplier is Supplier 2, the Trade Name is Trade Name 3, and the Ingredient Name is Ingredient 3 (see also, for example, FIGS. 5-10. The confidence values associated with each mapping set range from 0.3847 to 0.5, and so the prediction from the mapping set with the highest confidence value is selected to fill in the missing output variable 160c.

When the input and/or output variables are numeric values (integer or float), they can be incorporated into the mapping set-based machine learning method in at least two ways. As one option, the numeric values can be left as numeric values, in which case sets will be made based on the actual values in the data. This works well when the numeric values in the training data will be exactly the same as the values in the prediction data. However, if a value in the prediction data is not found in the training data, there will not be a mapping set match.

Alternatively, the numeric values can be binned based on value ranges or distributions. Then, as long as the values in the prediction data fall into the value ranges or distributions, a mapping set can be applied.

FIG. 14 provides an example data set that includes “Ingredient Mass” and “Ingredient Mass (Binned)” columns instead of an “Ingredient Name” column. If the Ingredient Mass column were used as is, there would be many different mapping sets due to the high variability in the values of this input variable. Each mapping set would have a small population, often only a single row. The small population size of each set would reduce the confidence of the predictions. Also, if a missing output value had an Ingredient Mass value that did not exactly match the value in one of the sets, there would be no mapping set match to use for a prediction.

To make better use of numeric columns like the Ingredient Mass, the values can be binned. Here, the values are binned into ranges of 50, as shown in the Ingredient Mass (Binned) column. These bins can now be used to make useful mapping sets having meaningful amounts of data and therefore better confidence values than if the Ingredient Mass itself were used. Also, as long as a value in a predicted row falls within one of the ranges, a prediction can be made using the mapping sets that use the Ingredient Mass.

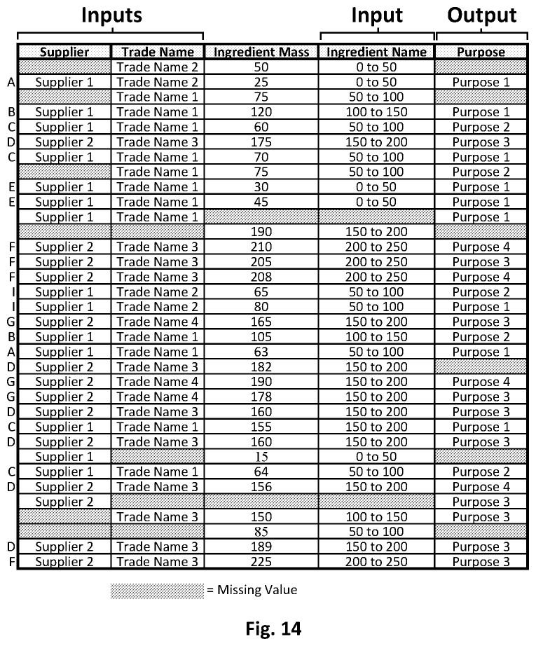

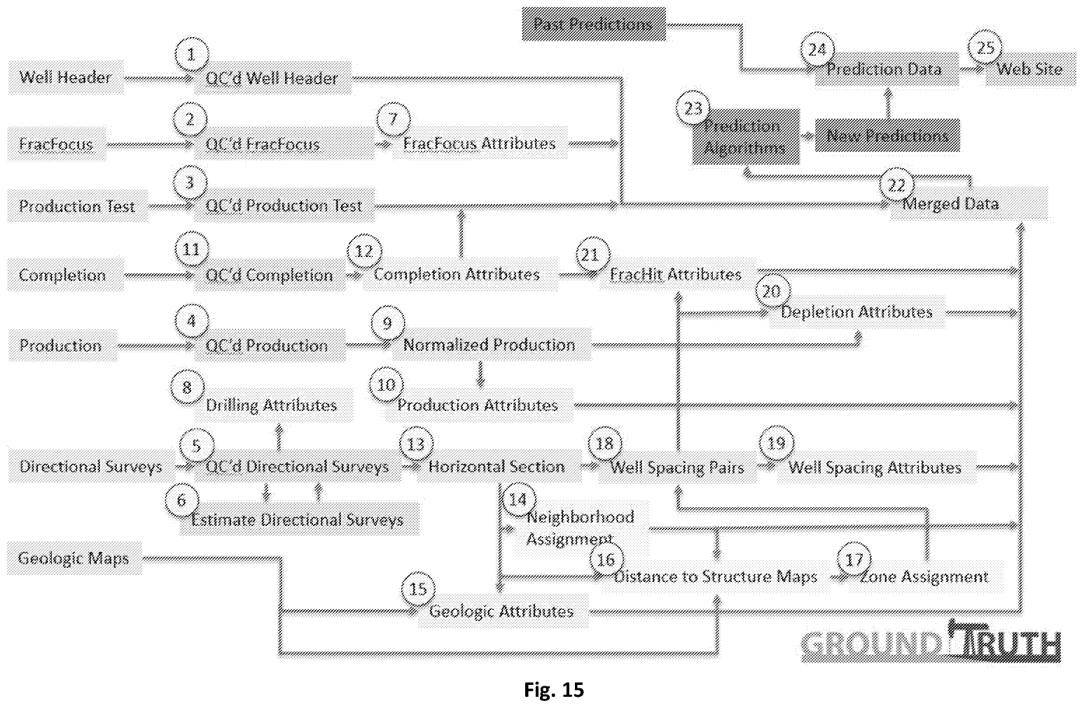

Turning now to FIG. 15, a process for making predictions of well productivity comprises a number of steps. These steps may be executed by a processor such as the processor 104, based on instructions stored in a memory such as the memory 128. The steps include: (1) processing well header data received from one or more well header databases for quality control; (2) processing FracFocus™ data received from the FracFocus™ database, and/or other hydraulic fracture drilling fluid chemical ingredient data received from one or more hydraulic fracture drilling fluid chemical ingredient databases, for quality control; (3) processing production test data received from one or more production test databases for quality control; (4) processing production data received from one or more production databases for quality control; (5) processing directional survey data received from one or more directional survey databases for quality control; (6) estimating directional survey data for wells with respect to which directional survey data has not been reported; (7) generating a FracFocus attributes data table; (8) generating a drilling attributes data table; (9) normalizing the quality controlled production data from step (4); (10) generating a production attributes table; (11) processing completion data received from one or more completion databases for quality control; (12) generating a completion attributes table; (13) generating a horizontal section data table; (14) generating a neighborhood assignment data table; (15) identifying geologic attributes using geologic maps; (16) generating a distance to structure maps data table; (17) generating a zone assignment data table; (18) generating a well spacing pairs data table; (19) generating a well spacing attributes data table; (20) generating a depletion attributes data table; (21) generating a frac hit attributes data table; (22) generating a merged data table; (23) generating a new prediction data table; (24) generating a prediction data table; (25) making the data from the prediction data table available on a web-based dashboard; (26) generating production prediction maps; and (28) estimating a number of remaining new well locations in a given area. These steps will be discussed in greater detail below.

In step (1), well header data from multiple sources (e.g. databases) is merged, and errors in the data are identified and corrected. The well header data may include basic information about wells, including, for example, operator names, formation names, and Kelly Bushing elevations. Operator names and formation names are standardized and consolidated, and Kelly Bushing elevations are estimated for wells not already associated with a Kelly Bushing elevation (while quality control is applied to wells that are already associated with a Kelly Bushing elevation). The result of step (1) is a well header data table comprising quality controlled well header data.

With respect to the standardizing and consolidating operator names, one of the most important pieces of information for a well is the identity of the well's operator. This data is required on all state and federal regulatory forms, so it is widely available in the public data. Even so, the data often lacks consistency as data entry errors, variability in naming conventions, and the existence of both parent and subsidiary companies can result in a variety of different names for the same operator. In step 1 of the process 300, the many different names that may be used for a single operator are consolidated under a standardized operator name. As just one example, the operator identifiers “Anadarko Austin Chal,” “Anadarko Austin Chalk Company,” “Anadarko E & P Co LP,” “Anadarko E & P Company Limited Prtnrship,” “Anadarko E & P Onshore LLC,” “Anadarko E&P Onshore,” “Anadarko Min Inc,” “Anadarko Minerals Incorporated,” “Anadarko Pet Corp,” and “Anadarko Petroleum Corporation” may all be standardized and consolidated as “Anadarko.” Standardization and consolidation of operator names ensures that when analysis of an operator's trends is performed, the analysis includes all of the appropriate wells.

With respect to estimating and applying quality control to Kelly Bushing elevations, the Kelly Bushing elevation is the elevation above sea level at which a wellbore is determined to start. The Kelly Bushing elevation is usually 15-20 feet above the ground elevation, although this offset value varies based on the type of well, the type of drill rig, and the drilling date. All downhole measurements in a well are referenced based on their measured depth from the Kelly Bushing elevation. Errors in the Kelly Bushing elevation (whether the stated elevation is too high or too low) affect the depth of various sub-surface well measurements (including, for example, the depth of subsurface formation measurements, the position of wells relative to subsurface formations, and the position of wells relative to other wells).

The Kelly Bushing elevation value is determined by estimating the ground elevation (historically determined by surveyors, although more recently determined using GPS units) and then adding the height from the ground to the Kelly Bushing. Kelly Bushing elevations are commonly incorrect in publicly reported information, either because of measurement inaccuracy or due to a data entry error.

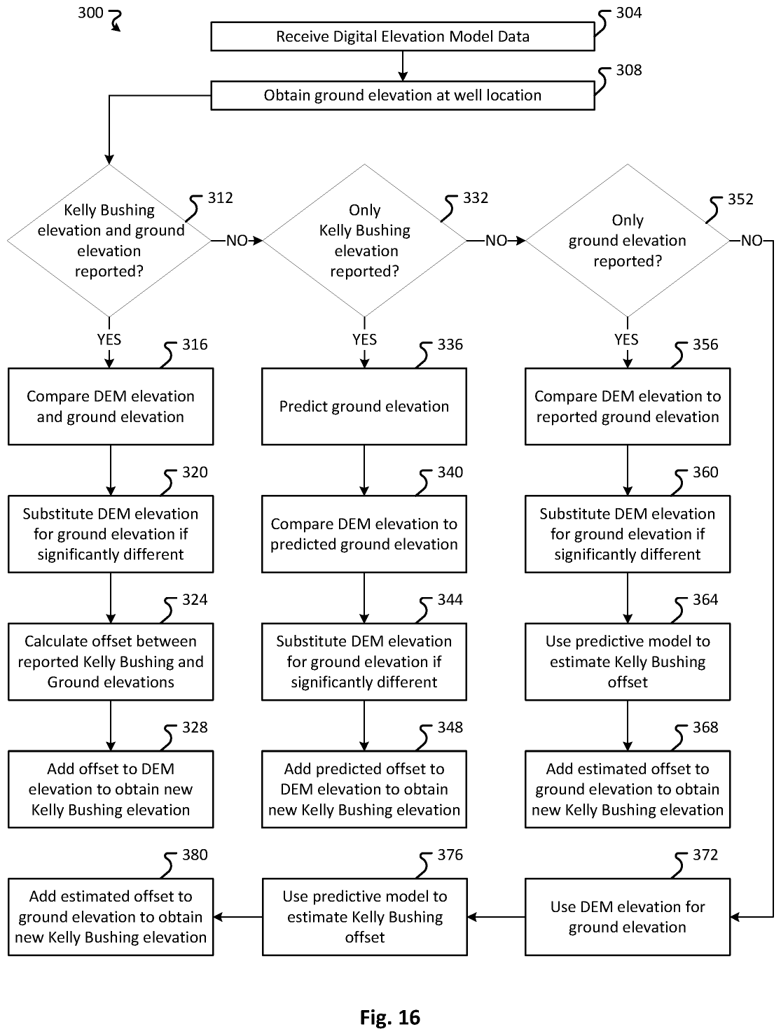

FIG. 16 shows a flowchart of a process 300 for determining the proper Kelly Bushing elevation for a given well. The process 300 may be executed, for example, by a processor 104 of a device 100, based on instructions stored in a memory 128. The process 300 includes receiving, via one or both of a database interface 112 and a wireless transceiver 124 (or wired connection port 116), digital elevation model (DEM) data (step 304). Such data may be available and received, for example, from the United States Geological Survey, from another government entity, or from a private geological data source. The DEM data comprises elevation data for a given area of land, which elevation data may have been measured, for example, using techniques/technologies such as photogrammetry, lidar, low frequency Synthetic Aperture Radar, and land surveying. The DEM data provides variable resolution information on the elevation of the surface at a given latitude and longitude. For the continental United States, DEM data is available through a National Elevation Database at resolutions of 1 arc-second (about 30 meters) and 1/3 arc-second (about 10 meters), and in limited areas at 1/9 arc-second (about 3 meters).

The ground elevation at the surface location (defined by latitude and longitude) of a given well is obtained from the DEM data (step 308). A determination is then made as to whether both the Kelly Bushing elevation and the ground elevation for the well in question have been reported (step 312).

If so, then the DEM elevation from step 308 and the reported ground elevation of the well are compared (step 316). If the DEM elevation and the reported ground elevation are the same, then the reported Kelly Bushing and ground elevations are accepted as accurate, and no further action is needed with respect to the process 300. If the DEM elevation and the reported ground elevation are significantly different, then the DEM elevation is substituted for the ground elevation (step 320). Each operator may determine the amount by which the DEM elevation and the reported ground elevation must differ in order for the DEM elevation to be substituted for the reported ground elevation. For example, in various embodiments, the DEM elevation and the reported ground elevation may be judged to be significantly different if they differ by more than 5 feet, or by more than 10 feet, or by more than 20 feet, or by more than 50 feet, or by any other amount.

Additionally, the offset between the Kelly Bushing elevation and the reported ground elevation is calculated (step 324). For example, if the Kelly Bushing elevation is 5300 feet and the reported ground elevation is 5280 feet, then the offset would be calculated by substracting the reported ground elevation (5280 ft) from the Kelly Bushing elevation (5300 ft), yielding an offset of 20 feet.

The calculated offset is then added to the DEM elevation to obtain the new Kelly Bushing elevation (step 328). Thus, if the DEM elevation at the location of the well in question is 5330 feet, then the new Kelly Bushing elevation would be calculated by adding the 20-foot offset to the DEM elevation of 5330 feet, yielding a new Kelly Bushing elevation of 5350 feet.

If, at step 312, it is determined that the Kelly Bushing elevation and the ground elevation are not both reported, then the process 300 determines whether only the Kelly Bushing elevation was reported (step 332). If so, then an offset between the reported Kelly Bushing elevation and the unknown ground elevation is predicted using a predictive model based on a variety of input parameters, such as the date the well was drilled, the drilling company, the type of well, and the location of the well, and the predicted offset is used to predict the ground elevation (step 336). The predictive model can be built and/or trained using data from wells where both the Kelly Bushing elevation and the ground elevation were reported. Thus, if the offset between the Kelly Bushing elevation and the ground elevation for a given well type drilled by a given company is 20 feet for eighty-five percent of the wells that meet these criteria, then a well of that type drilled by that company, but for which the ground elevation is not reported, has a high chance of having an offset of 20 feet. This predicted offset can then be subtracted from the reported Kelly Bushing elevation to obtain the predicted ground elevation.

The predicted ground elevation is then compared to the DEM elevation obtained at step 308 (step 344). As in step 320, the DEM elevation is substituted for the predicted ground elevation if the DEM elevation is significantly different than the predicted ground elevation, and each operator or user may select different criteria regarding whether the DEM elevation is significantly different than the predicted ground elevation (e.g. whether a difference of more than 5 feet, or of more than 10 feet, or of more than 20 feet, or of more than 50 feet, or of any other value is enough to trigger the substitution). If the DEM elevation is not significantly different than the predicted ground elevation, then the predicted ground elevation is used and no further action is needed with respect to the process 300.

If the DEM elevation is substituted for the predicted ground elevation, then the predicted offset is added to the DEM elevation obtained in step 308 to obtain a new Kelly Bushing elevation (step 348).

If the result of step 332 is no (i.e. if it is not true that only the Kelly Bushing elevation was reported), then the process 300 proceeds to determine whether only the ground elevation was reported (step 352). If so, then the DEM elevation obtained in step 308 is compared to the reported ground elevation (step 356), similar to steps 316 and 340. As in steps 320 and 344, the DEM elevation is substituted for the reported ground elevation if the two elevations are significantly different (step 360), which determination is made using criteria selected by the user or operator of the device 100. The predictive model described with respect to step 336 is then used to estimate the Kelly Bushing offset (step 364), and the estimated or predicted Kelly Bushing offset is added to the ground elevation (whether the DEM elevation or the reported ground elevation, whichever is being used after step 360) to obtain the new Kelly Bushing elevation (step 368).

If the result of step 352 is no (i.e. if it is not true that only the ground elevation was reported), then the process 300 proceeds to use the DEM elevation for the ground elevation (step 372). The predictive model described above with respect to step 336 is used to estimate the Kelly Bushing offset for the well (step 376), and the estimated offset is added to the DEM elevation to obtain the new Kelly Bushing elevation (step 380).

Once operator names and formation names have standardized and consolidated, and Kelly Bushing elevations have been estimated and quality-controlled, the resulting data is compiled in a well header data table as the output of step (1).

Returning to FIG. 15, in step (2), hydraulic fracture drilling fluid chemical ingredient data from multiple sources (including, e.g., FracFocus™ v.1 and v.2 and state-specific chemical ingredient databases) is merged, and errors in the data are identified and corrected. Ingredient names, supplier names, purpose descriptions, tradenames, and chemical identification numbers (e.g. CAS numbers) are standardized. When one or more values for a given ingredient are missing, the missing values are estimated or predicted using the mapping set-based machine learning process described above, executed by a processor 104 of the device 100 or of a similar device. The result of step (2) is a data table comprising quality controlled hydraulic fracture drilling fluid chemical ingredient data.

In step (3), initial production test data from multiple sources (e.g. state-specific initial production databases) is merged, and errors in the data are identified and corrected. Generally speaking, identifying and correcting errors in the data comprises identifying outlier values based on where the values fall in the distribution of data. Where multiple reported values do not agree, those values may be reconciled by, for example, selecting the value that has a greater probability of being correct based on the distribution of data, after filtering the data to focus on wells of a similar design and geology. In other words, the data may be organized into mapping sets, and a likelihood of a particular value being correct within each set may be determined and used to identify the value with the greatest probability of being correct.

Production test data may comprise, for example, data points regarding oil production rate, water production rate, gas production rate, oil production as a percentage of total production, water production as a percentage of total production, gas production as a percentage of total production, production pressure, and choke size (typically expressed as a fraction). Depending on the scope of the databases from which the data is received, data corresponding to initial production tests may need to be categorized as such or otherwise separated from data corresponding to subsequent tests. Mapping set-based machine learning techniques may be applied to fill in missing values in the data. Additionally, choke size information included in the data is converted from a fraction to a decimal. The result of step (3) is a production test data table comprising quality controlled production test data.

In step (4), production data from multiple sources is merged, and errors in the data are identified and corrected. Production data is typically reported by well operators on a regular basis to the state or other jurisdiction in which the well is located, and contains information about the total production of a well during the period in question. Production reports typically provide the volume of production, but often do not provide the number of days that the well was producing during the period. For production records in the data that do not include the number of producing days over which the production was achieved, the number of producing days is estimated. Additionally, the total amount of production is allocated to production type categories (e.g. oil, gas, water, and condensate). The result of step (4) is a production data table comprising quality controlled production data. The production data table comprises total production values for each reporting period and an actual or estimated number of producing days for the well for each reporting period.

More specifically with respect to step (4), although production reporting is a fairly standard requirement, production data reporting requirements and practices vary by state, with some states requiring monthly reporting and others requiring only quarterly or biannual reporting. Additionally, production data can be based on a different number of producing days (Days On) for each well. For example, because months do not always have the same number of days, or of production days (e.g. because the well may be turned off during some of the reporting period), a monthly reporting system may capture more producing days in one month and fewer producing days in another month. As a result of these discrepancies, production between wells cannot be properly compared without first normalizing the production, which in turn requires a reliable measurement of the Days On. In embodiments of the present disclosure, the production is normalized and interpolated so that 30-day increments of producing days, or Days On, can be compared between wells.

To make reliable estimates of Days On for each production period, embodiments of the present disclosure use the production volume of subsequent periods, and assume that production rate (volume/days) of all material out of the well (Oil+Gas+Water) should decrease from one production period to the next. Unless there is a complication or human intervention, wells typically produce at their highest rate initially and then decline over time. For each producing period, the total volumes of oil, gas, and water (whichever are available) are summed to create a “Total Production” value, which is divided by the total number of possible producing days in that period to get the “Estimated Production Rate.” For a month-long producing period, for example, the number of days in the month is used as the total number of possible producing days.

For gas production, the volume of gas (measured in thousand cubic feet) is divided by 6 (the energy generation equivalence) to get what is called the “Barrels of Oil Equivalent” so that the gas production volumes are comparable with oil production volumes.

Then, over N number of periods ahead of each producing period in question, the “Peak Production Rate” (which is the highest “Estimated Production Rate” in those N periods) is found. Using the assumption that production rate should not increase from one period to the next, the “Estimated Production Rate” for a period should not be less than the “Peak Production Rate” of the subsequent periods. If this is the case, it means the “Days On” is being over-estimated by using the maximum number of days in the month. Accordingly, for each period, if the “Estimated Production Rate” is less than the “Peak Production Rate” of the subsequent N periods, “Total Production” is divided by the “Peak Production Rate” to get the required number of “Days On” for the period to have a production rate equal to the “Peak Production Rate.” If the “Estimated Production Rate” for the period is greater than the production rates of the subsequent N periods, the “Days On” is taken as equal to the maximum number of days in the period.

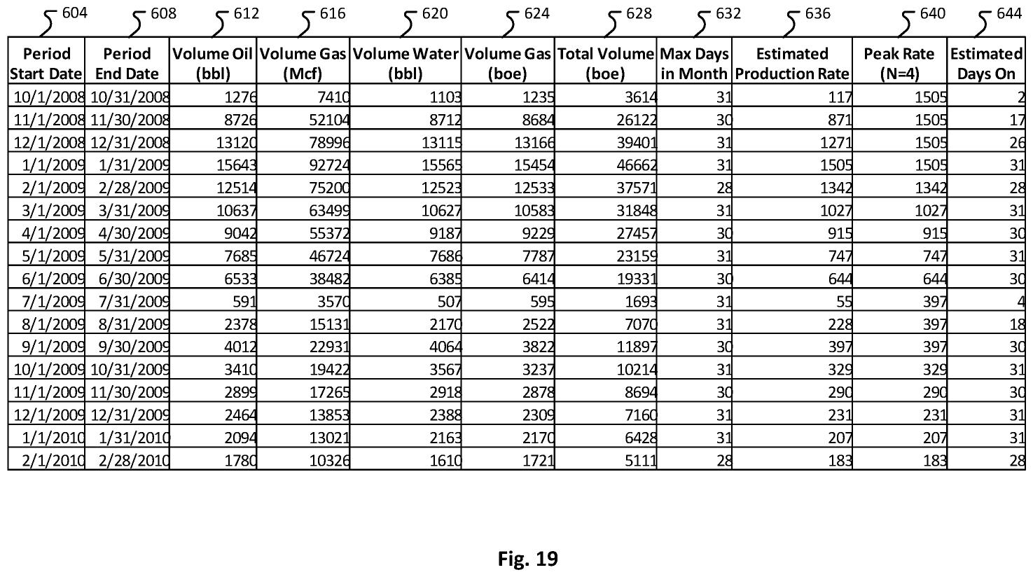

FIG. 19 shows a production data table that includes the start and end dates of each reporting period in columns 604 and 608, respectively, as well as the volume of oil produced in column 612, the volume of gas produced in column 616, and the volume of water produced in column 620. Column 624 shows the Barrels of Oil Equivalent for the reported gas production, calculated by dividing the data in column 616 by the number six. The total production volume (calculated by summing the data in columns 612, 620, and 624) is set forth in column 628, and the number of days in the reporting period are set forth in column 632. The Estimated Production Rate, calculated by dividing the Total Volume of column 628 by the maximum number of days of the reporting month in column 632, is set forth in column 636.

Column 640 shows the Peak Production Rate over the N periods after the reporting period in question, where N=4. Thus, for the Oct. 1, 2008-Oct. 31, 2008 reporting period, the Peak Production Rate is 1505, as shown in column 636 for the Jan. 1, 2009 to Jan. 31, 2009 reporting period. The Estimated Days On (column 644) is calculated by dividing the Total Volume (column 628) by the Peak Rate (column 1505), and rounding to the nearest whole number. The Estimated Days On data is included in the production data table that is produced during step (4).

In step (5), directional survey data from multiple sources is merged, and errors in the data are identified and corrected. The directional survey is a report of the path of a wellbore from its surface location down through to its bottom hole location. The directional survey is comprised of samples that specify the X, Y, and vertical depth values (from the Kelly Bushing elevation) of the wellbore at each sample point, or that specify the change in X and Y values from the well's X, Y surface location, plus a measured depth from the Kelly Bushing elevation. The directional survey is an essential component of various aspects of the present disclosure, including for example for determining spacing between wells, determining the producing formation of wells, and extracting geologic attributes. Oftentimes, however, the directional survey reports can be missing for wells in public data sources. As a result, it is necessary to estimate missing information. Additionally, true North survey values are converted to Grid North survey values to ensure that all values are based on the same reference. The result of step (5) is a directional survey data table comprising quality controlled directional survey data.

In step (6), which may be considered a subpart of step (5), directional survey estimates are used to fill in for missing directional survey data. Thus, when the directional survey data received and merged in step (5) does not include directional survey data for a particular well, the directional survey data for that well is estimated in step (6). The directional survey estimates are made using information such as surface location, bottom hole location, true vertical depth, and neighboring well directional surveys. The result of step (6) is an updated directional survey data table comprising estimated directional survey data where directional survey data was previously missing.

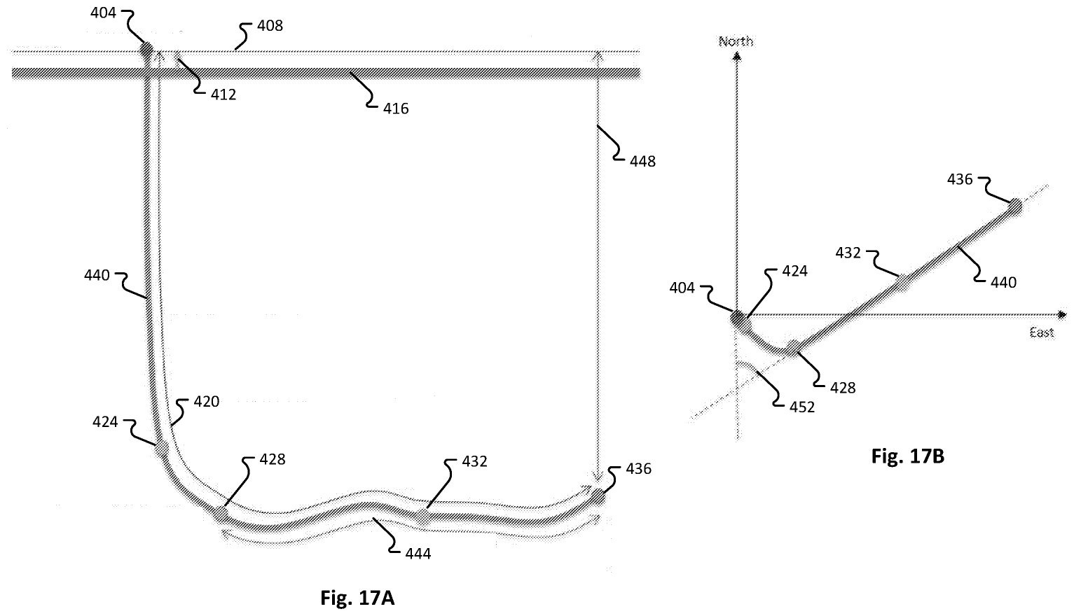

FIGS. 17A and 17B show side (elevation) and top (plan) views of a well 440, respectively. The surface location 404 is the beginning point of the well 440, and is defined by latitude, longitude, and the Kelly Bushing elevation 408. The Kelly Bushing offset 412 is the height above ground elevation 416 of the starting point of the well 440. The total measured depth 420 is the total length along the wellbore between the surface location 404 and the bottom hole location 436. The bottom hole location 436 is the end location of the wellbore, and is defined by latitude, longitude, total measured depth 420, and true vertical depth 448. The true vertical depth 448 is the depth of the wellbore below the Kelly Bushing elevation 408. The midpoint location 432 is the halfway point in measured depth along the horizontal section length 444. The horizontal azimuth 452 is the angle of the horizontal section relative to North.

The kickoff point 424 is the location where directional drilling operations commence in order to build the wellbore to the desired design orientation. The horizontal section start or heel location 428 is the point at which the inclination of the well 440 exceeds 85 degrees. The horizontal section length 444 is the portion of the total measured depth 420 that is between the horizontal section start 428 and the bottom hole location 436.

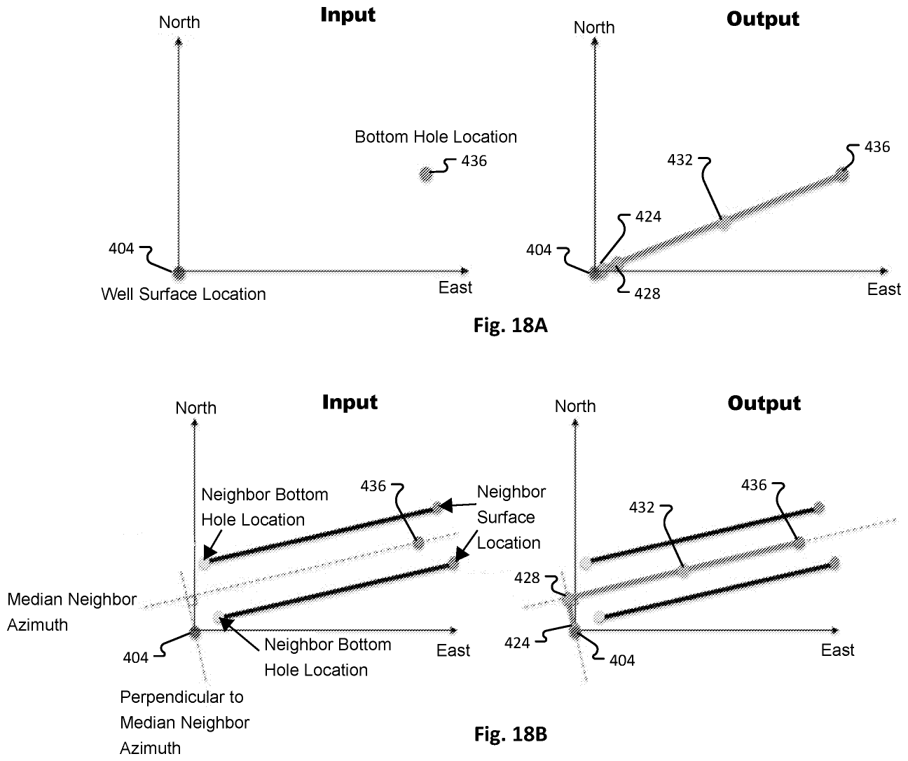

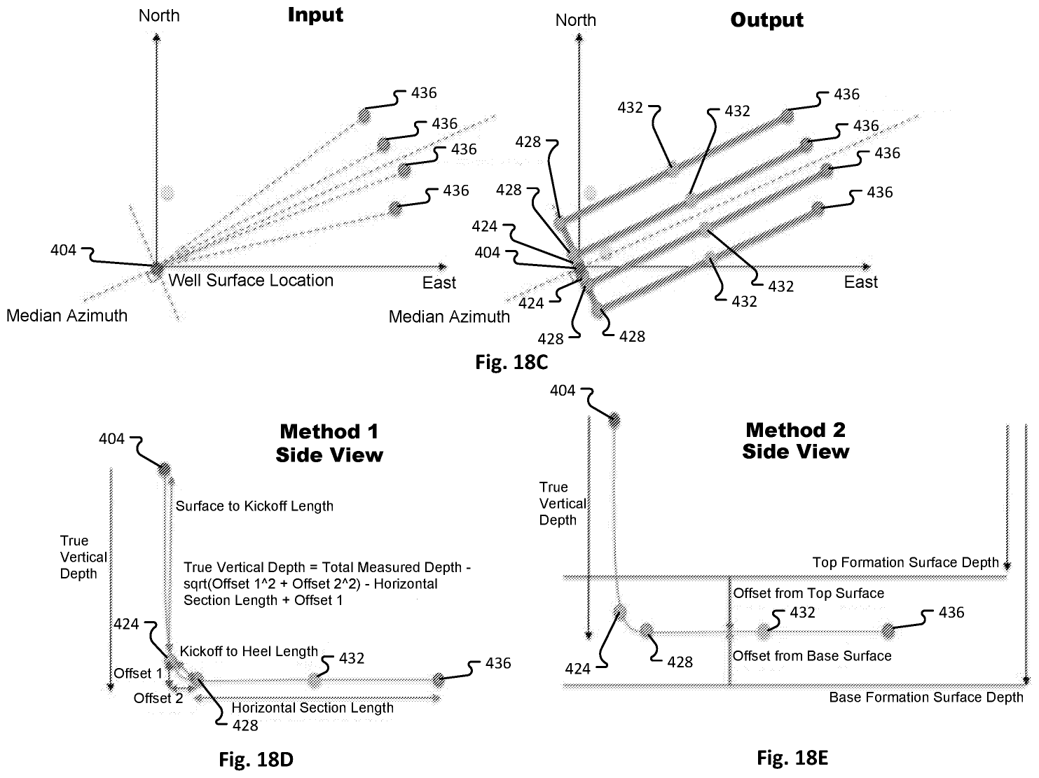

The process of estimating directional survey data depends upon the amount and type of available information. In a first case, illustrated in FIG. 18A, where a well is a standalone well (e.g., has no neighbors), and only the surface location 404 and the bottom hole location 436 are reported, the well path is assumed to be a straight path (in the x-y plane) between the surface location 404 and the bottom hole location 436.

In some instances, a well may have at least one neighbor with a reported directional survey. For a second well to be considered a neighbor of the first well, the azimuth of a straight line connecting the surface location 404 and bottom hole location 436 of the first well must be within a specified tolerance, and the midpoint of the second well and the straight line connecting the surface location 404 and the bottom hole location 436 of the first well must be within a specified distance. A user or operator of the device 100 may determine the specified tolerance and the specified distance to be used.

Neighboring wells tend to be drilled with the same azimuth as one another. As a result, in a second case, illustrated in FIG. 18B, where a well has at least one neighbor with a reported directional survey, the azimuth of the estimated well is assumed to be equal to the median azimuth of all of the wells that qualify as neighboring wells. To estimate the path, a straight line is projected through the bottom hole location 404 at the estimated azimuth. A line through the surface location 404 that is perpendicular to the estimated azimuth is projected. The estimated path follows the projected line from the surface location 404 until it intersects the projected line from the bottom hole location 436, at which point the estimated path then follows the line to the bottom hole location 436. This technique can also be applied using the average azimuth instead of the median azimuth.

In some instances, a group of nearby wells may lack directional surveys, and may also lack any neighboring wells with reported directional surveys from which to estimate a well azimuth. Such groups of wells can be drilled from the same surface location 404, in a technique known as “pad drilling.” In this third case, illustrated in FIG. 18C, all wells in the group are assumed to have the same azimuth, which is typically the case. To estimate the azimuth of the wells, straight lines are projected from the surface location 404 to the bottom hole location 436 for each well in the group. Then, the median azimuth of the projected lines is calculated. All wells are assigned this median azimuth value. Once the azimuth is determined, the well paths are created using the same methodology as described above with respect to the second case (FIG. 18B), with the median azimuth of the group substituting for the reported neighbor azimuth. This technique can also be applied with the average azimuth instead of the median.

Once the path of any wells lacking directional survey information has been estimated in the X-Y plane, the true vertical depth of the wells must be estimated. As illustrated in FIG. 18D, if the total measured depth of a well is reported, the true vertical depth is estimated first by subtracting the horizontal section length in the X-Y plane from the total measured depth, which yields the heel location 428. A fixed vertical and lateral offset between the kickoff point 424 and the heel location 428 is assumed to estimate the location of the kickoff point 424. The measured depth required to fit the kickoff point 424 (estimated, for example, by taking the square root of the sum of the squares of the vertical and lateral offsets) is also substracted from the total measured depth. The vertical offset is then added back to this value to obtain the true vertical depth estimate. A minimum curvature path that fits through the surface location 404, the kickoff point 424, the heel point 428, and the bottom location 436 can then be generated.

As illustrated in FIG. 18E, if the total measured depth of the well is not reported, but the producing formation is reported, the true vertical depth is estimated by knowing in which formation of geology the well resides. Using gridded structural maps of the top and bottom of the formation, a true vertical depth is estimated that would place the well within the correct producing formation. In some embodiments, a depth is used that would place the well approximately midway between the top formation surface depth and the base formation surface depth. Once the true vertical depth is estimated, a minimum curvature path that fits through the surface location 404, the kickoff point 424, the heel point 428, and the bottom hole location 436 is generated.

If neither the total measured depth nor the producing formation is reported, machine learning is used to estimate the true vertical depth by inputting attributes of other wells, such as the producing formation, spud date, and operator. The machine learning uses wells where the true vertical depth is known to make a prediction of what the true vertical depth should be for the well for which the true vertical depth is being estimated. In some embodiments, the planned total depth for the well, obtained from the original drilling permit, may also be considered.

In step (7), the ingredients of the hydraulic fracture drilling fluid chemicals used in a given well are categorized by purpose, and a total mass is calculated for each. Based on this data, a hydraulic fracture system type attribute is assigned to each well. For example, based on the mass of hydraulic fracture fluid chemicals whose purposes are to function as gelling agents, as well as the ratio of total hydraulic fracture fluid and total proppant mass, wells can be categorized as a gel based system type or a slickwater based system type. Attributes are also created to flag specific chemicals used in a given well, and the total masses of proppant by size, material, and coating are calculated. The calculation results and attributes created, generated, and/or assigned during this step (7) are compiled in a FracFocus attributes data table.

In step (8), well attributes such as true vertical depth, azimuth, inclination, number of peaks/troughs, toe up versus toe down, and tortuosity are calculated based on data in the directional survey data table. The result of step (8) is a drilling attributes data table.

In step (9), production data in the production data table is normalized. As discussed above with respect to step (4), regulators often require that operators report total volumes of oil and/or gas production for a given time period, but those time periods vary by jurisdiction. In some jurisdictions, water production must also be reported. To perform meaningful analysis of well performance (including, for example, by comparing the production of multiple wells), production metrics are required that are fundamentally the same. Most commonly, such metrics are the cumulative production of a well in a specific number of (e.g., 30, 60, 90) active producing days. For example, “Cum 90 Oil” is the cumulative oil produced in the first 90 active producing days.

As a result, one aspect of generating normalized production data in step (9) of FIG. 15 is projecting well production between reports, so that production data is available for each thirty producing days for each well. This is necessary when, for example, state regulations only require production data to be reported on a quarterly, bi-annually, or yearly basis. To project well production, production curves are generated based on the reported data, and those curves are then sampled at 30-day intervals.

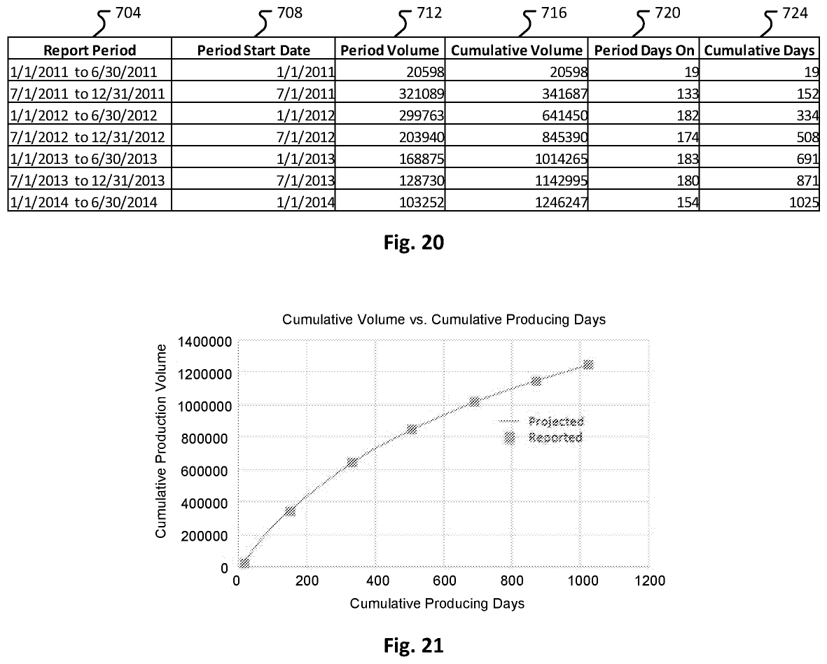

FIG. 20 shows a table of production data, as reported bi-annually, for a given well. The reporting period is identified in column 704, the period start date in column 708, the period volume in column 712, the cumulative volume (e.g., the sum of the period volume and all preceding period volumes) in column 716, the period days on in column 720, and the cumulative days on (e.g., the sum of the period days on and all preceding period days on) in column 724. Where the number of days on is not reported, the days on estimation technique described above is used to estimate the number of days on.

FIG. 21 shows a plot of the cumulative producing days at each report versus the cumulative production volume at each report (using the data of FIG. 20). A line has been fitted through the data using a predefined function or minimum curvature fitting. This line, which represents projected production in between the reporting dates, can be sampled to determine production volumes on thirty-day intervals, as described below.

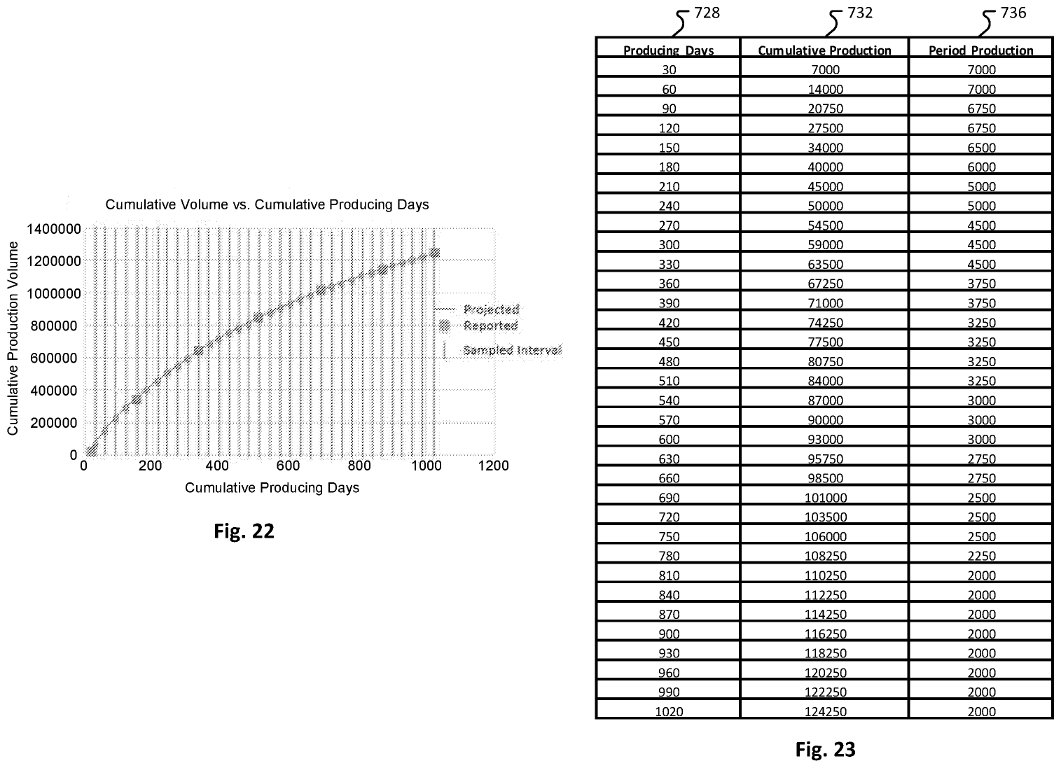

In step (10), the normalized production data from the normalized production data table created in step (9) is used to create production attributes. The creation of production attributes over comparable periods of time relative to the start of production allows for accurate comparisons between wells. Production attributes are created for various production intervals (e.g. 30, 60, 90 day) and for different production types (e.g. oil, gas, water, condensate). This is accomplished by summing the total production over 30 day increments relative to the start of production (i.e. 30, 60, 90 day cumulatives), which data is obtained by sampling the projected cumulative production curves that are fitted through the reported values. FIG. 22 shows the curve of FIG. 21, with thirty-day sampling intervals shown by vertical lines. The data corresponding to each sampling interval are shown in FIG. 23. The result of step (10) is the production attributes data table shown in FIG. 23, in which the cumulative number of producing days is shown in column 728, the cumulative production is shown in column 732, and the partial production (e.g. the amount of production for the thirty-day period in question) is shown in column 736. Although not shown, the same methodology is applied to all production types that are reported for the well (e.g. oil, gas, water, condensate).

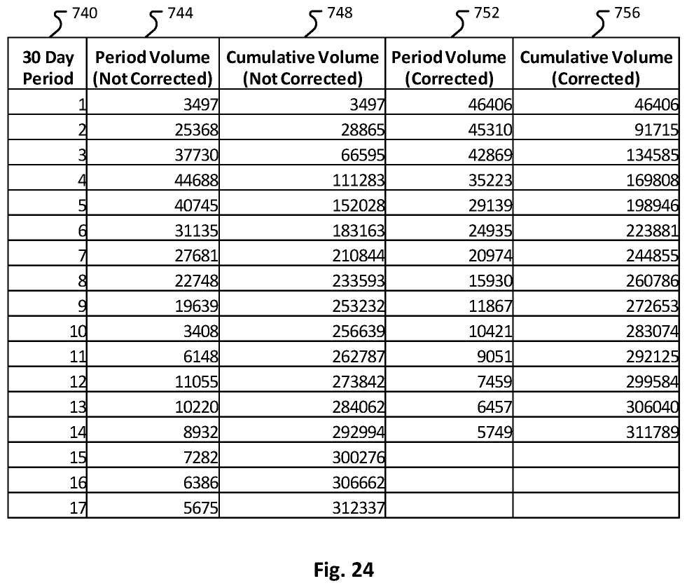

FIG. 24 is a production data table showing normalized production attributes obtained both with and without use of the “days on” estimation technique described above in connection with FIG. 19. In the table, column 740 shows an identifier for the 30-day period of each row; column 744 shows the uncorrected period volume; column 748 shows the uncorrected cumulative volume; column 752 shows the corrected period volume (i.e. the period volume obtained using the “days on” estimation technique); and column 756 shows the corrected cumulative volume (i.e. the cumulative volume obtained using the “days on” estimation technique). As evident from the table, the lower volumes in the non-corrected data of columns 744 and 748 could lead to wells being falsely considered as poor producers, when in fact they are not.

In step (11) of FIG. 15, completion data from multiple sources (e.g., public and/or proprietary databases) is merged, and values that exceed a probability threshold based on a sampling of similar wells are identified as errors and corrected. More specifically, data corresponding to wells with similar engineering and geology are used to create a distribution for the variable being subjected to quality control. Then, if the value exceeds a specified threshold of probability of existing based on the distribution, it is flagged as an incorrect value. If a separate value has been reported for this variable from a secondary source, the value from the secondary source value is used to replace the value identified as incorrect. Otherwise, the correct value is estimated as the most likely value based on the distribution of data. This error identification and correction process is similar to the mapping set-based machine learning technique described above, but instead of mode, the most probable value based on data distribution is used.

For wells that do not have a reported completion date, a completion date is estimated. The completion date for many wells is reported in regulatory filings with the state or other jurisdiction in which the well is located. If the completion date is not reported in such filings, then FracFocus.org and/or similar sites are checked for a completion date, which is utilized in step (11) if found. Otherwise, the completion date is estimated using an offset of days from the reported initial production test date, if that date is available. If the initial production test date is not available, the date is estimated using an offset of days from the first reported production date, if production has been reported. If the first production date has not been reported, then the completion date is estimated using an offset of days from the spud date (the date that drilling began).

In some instances, both a completion start date and a completion end date are reported, in which instances both dates are added to the data table created in step (11). If only the completion start date or only the completion end date is reported, then the unreported value is estimated by assuming a specific number of days between the completion start date and the completion end date. The result of step (11) is a quality controlled completion data table.

In step (12), new completion attributes are calculated using the quality controlled completion data table. The most commonly available completions attributes are: Gross Perforated Interval (the length of the well over which the well has been prepared for production by creating channels between the reservoir and the wellbore); Total Hydraulic Fracturing Fluid (the volume of hydraulic fracturing fluid that was injected into the well during stimulation); Total Proppant (the total mass of proppant that was injected into the well during stimulation); and Number of Stages (he number of hydraulic fracturing stages stimulated in the well).

A number of new completion attributes may be calculated or derived from these available completion attributes. Examples include: Proppant Intensity (Total Proppant/Gross Perforated Interval); Fluid Intensity (Total Hydraulic Fracturing Fluid/Gross Perforated Length); Proppant per Stage (Total Proppant/Number of Stages); Fluid per Stage (Total Fluid/Number of Stages); Average Stage Length (Gross Perforated Interval/Number of Stages); Fluid to Proppant Ratio (Total Hydraulic Fracturing Fluid/Total Proppant); and Proppant to Fluid Ratio (Total Proppant/Total Hydraulic Fracturing Fluid). All of these calculated or derived values are subjected to the same error-checking, using distributions from similar wells that were applied to the original attributes. The result of step (12) is a completion attributes data table.

In step (13), the quality controlled directional survey data table is used to create a horizontal section data table. More specifically, for horizontal unconventional wells (e.g., wells that require additional engineering to produce, such as hydraulically fractured wells), the production comes from the horizontal section of the wellbore. Using the directional survey data from the directional survey data table, the portion of each wellbore that is horizontal is isolated, and a data table of samples just from the horizontal section (e.g. the horizontal section data table) is created.

More specifically, the directional survey describes the entire wellbore path. Since the production comes from the horizontal section of this path, the portion of the survey showing the horizontal section of the wellbore path is of greatest interest. Consequently, samples from the directional survey that fall within the horizontal section are isolated.

However, these samples from the directional survey will be at the random sampling points where the driller happened to report a value. So instead of using the raw survey samples, interpolations based on the reported samples are used to create evenly spaced samples that represent the horizontal section of the directional survey.

Data that might be included in the data table created in step (13) include the Measured Depth, True Vertical Depth, True Vertical Depth Subsea, DeltaX (from surface), DeltaY (from surface), Azimuth (the direction the well is pointing at this sample in the X/Y plane), Inclination (the direction the well is pointing in the Z plane at this sample), and Dog Leg Severity (measure of the curvature of the wellbore at the sample location) for each interpolated sample point of the horizontal section.

In step (14), a neighborhood assessment data table is created using the horizontal section data table and neighborhood outlines. Wells can be located in different production neighborhoods (e.g. fields, basins, type-curve neighborhoods). Based on areal outlines of the neighborhoods, the neighborhood in which each well is located can be determined, and a neighborhood attribute can be created. For example, an available outline may define the areal extent of a basin, like the Permian basin. If the horizontal section of a well is predominately located within this outline, the well would be assigned this basin as an attribute. As another example, for a specific producing formation, an outline or a specific region that is or at least appears to be geologically different than other regions (e.g., a “High Porosity” neighborhood within the “Wolfcamp B Formation”) may be defined. If the horizontal section is predominately located within this producing formation and within the areal outline of the neighborhood, it may be assigned the corresponding neighborhood name (e.g. “Wolfcamp B High Porosity”). The neighborhood attributes for each well are used to create the neighborhood assignment data table.

In step (15), geologic attributes are gathered and analyzed. For example, as a wellbore passes through the Earth it crosses through many different geologic formations. Every time a well is determined to have entered a new formation, a geologic formation top can be assigned at that measured depth of the well to mark the change in geology. These boundaries may mark lithology (rock type) changes; stratigraphic feature changes (e.g. braided streams); maximum/minimum flooding surfaces; or other contrasts measured by well log data. Formation tops are often reported by operators to state regulatory sites, though the quality and consistency of the interpreted values can vary, as can the nomenclature of the events (e.g., “top of Wolfcamp B”).

Formation tops are located at discrete well points. In order to extrapolate formation depth trends between the tops, the formations must be gridded into a structural or other reference map (e.g., subsea depth, depth from surface, vertical thickness). When gridding the formation tops, any erroneous top can create artifacts in the resulting surface. Those erroneous tops must be identified and discarded to generate a high quality structural map.

A process according to embodiments of the present disclosure automatically identifies the formation tops to be discarded, and then generates a structural depth (or other) map. The process does not require human intervention. This allows for structural depth maps to be updated at a much higher frequency as new data becomes available. The result is structural depth maps that are as current as possible.

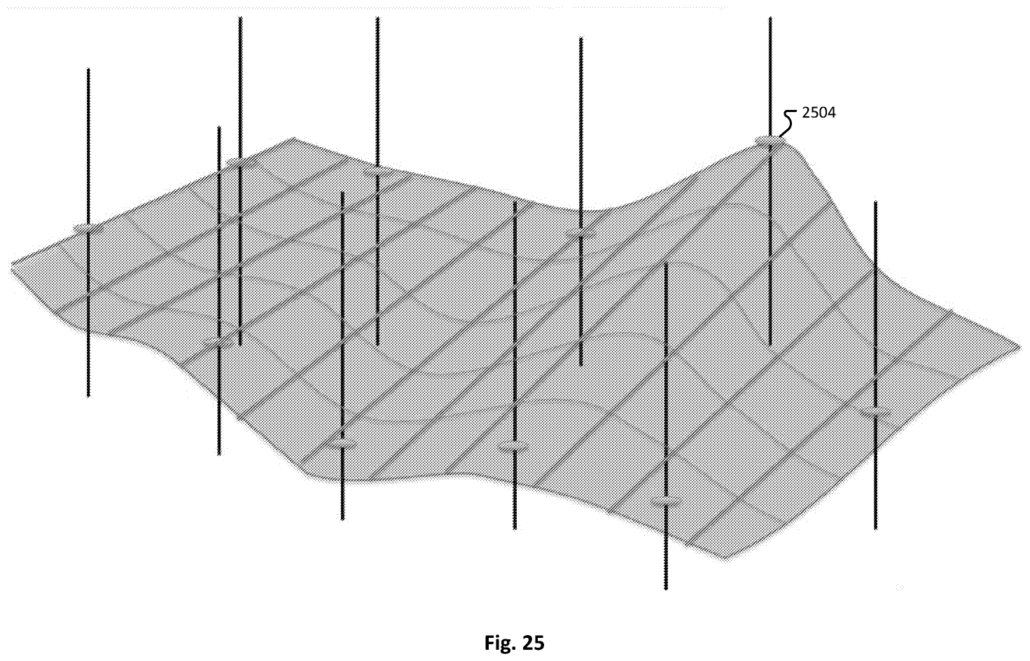

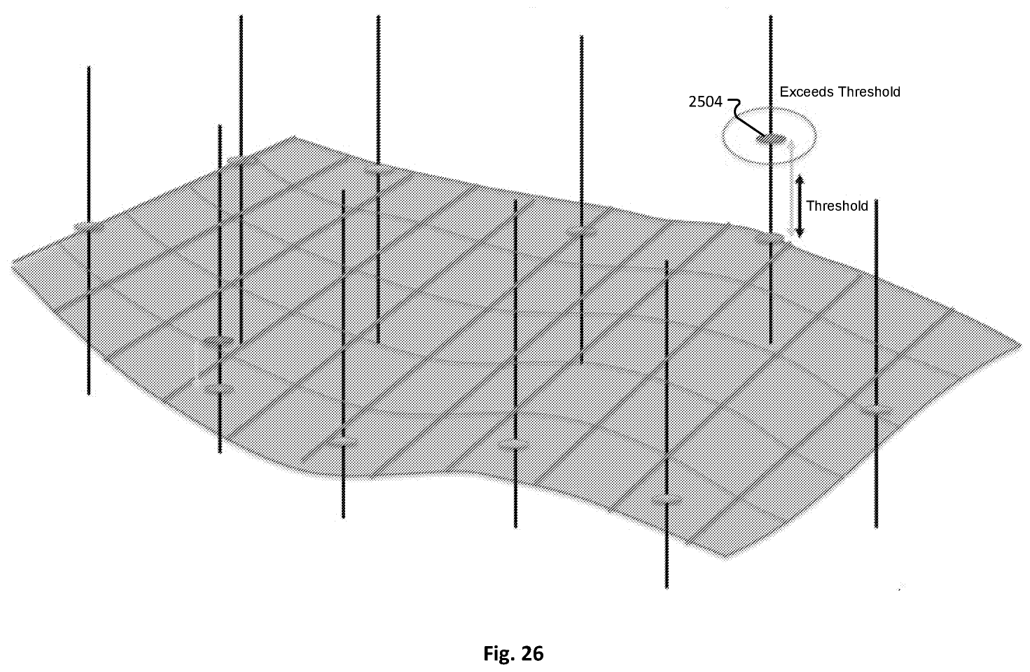

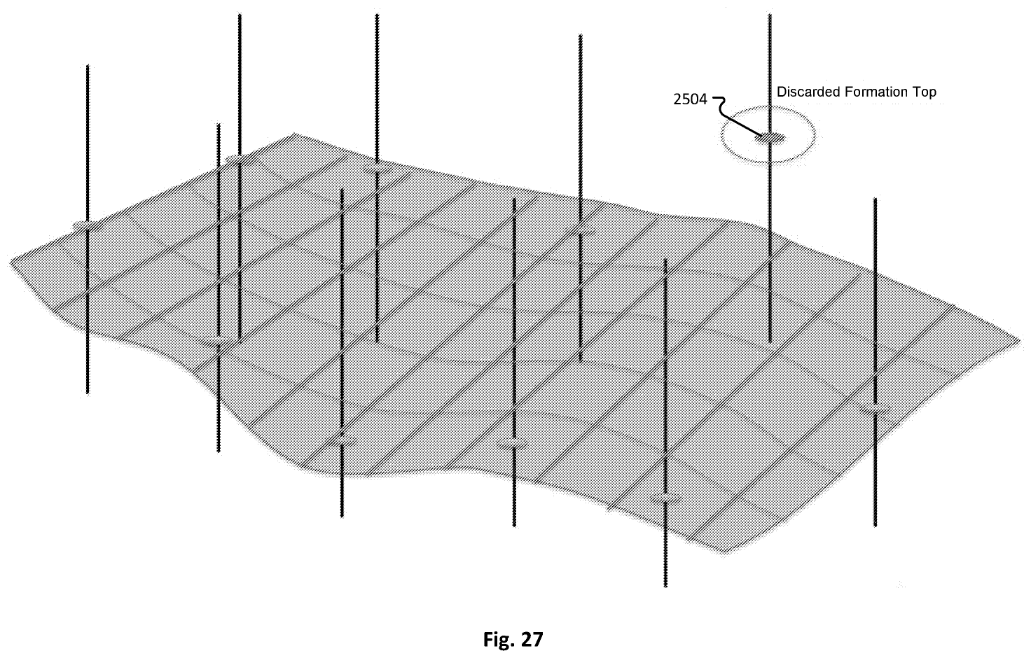

For example and with reference now to FIG. 25, formation top data from ten different wells may be available for use in the geologic formation top gridding process. In this example, data point 2504 is an outlier. The formation top data is divided into a plurality of even-sized populations. In this example, the ten data points are divided into five populations of two data points each. In an iterative process, one population is withheld while the remaining populations are used to create a structural depth grid (e.g., using an interpolation technique such as minimum curvature or B-Spline). As shown in FIG. 26, the structural depth grid is then compared to the formation tops in the population that was withheld, and any data point that is offset from the grid by more than a predetermined threshold (such as the outlier data point 2504) is discarded. This process is repeated until each of the populations has been held out and then compared to the resulting structural depth grid. As shown in FIG. 27, once all of the outlier data points have been removed, the remaining data points are then gridded into a structural depth grid that can be used in the overall prediction process.

Also as part of step (15) of FIG. 15, one or more structural models may be generated. A structural model is a three-dimensional framework that defines subsurface geologic formations. Structural models are created using a combination of three-dimensional depth surfaces along with rules about how the surfaces should be ordered and what to do if they cross one another. Additional surfaces can be generated by defining an offset from an existing surface or a percentage between two surfaces. Based on the rules, the input surfaces and the additional surfaces derived from the input surfaces are combined to create a coherent framework defining the subsurface geology. In embodiments of the present disclosure, structural models are generated automatically using the structural depth grids resulting from the automatic gridding process described above in connection with FIGS. 25-27.

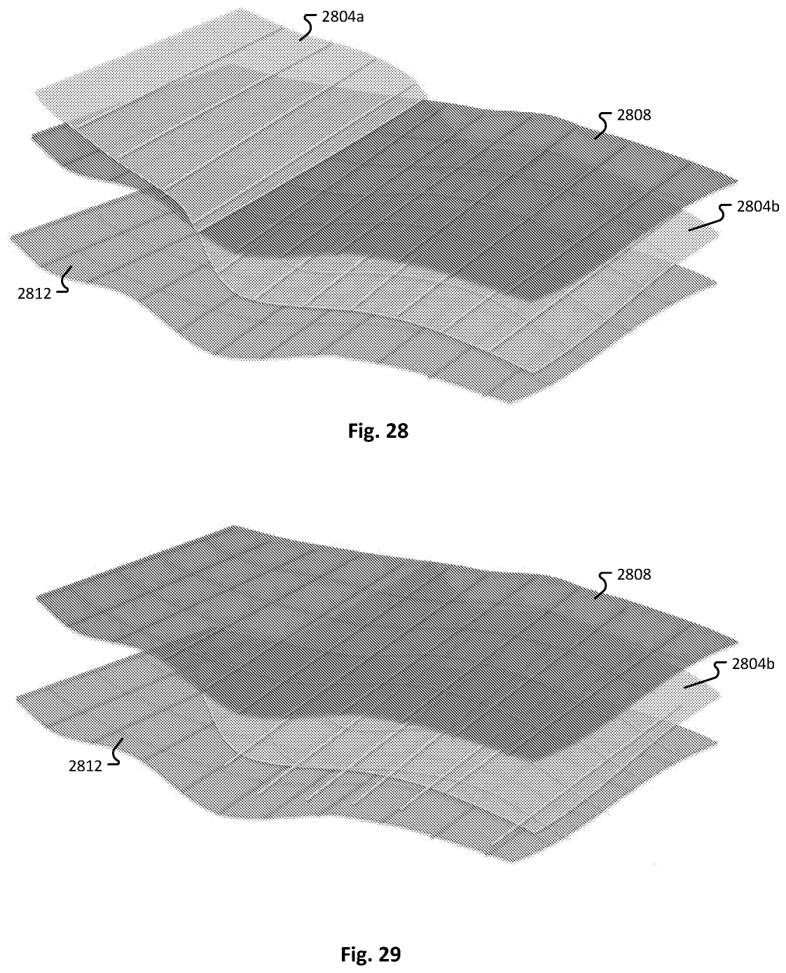

FIG. 28 shows three depth surfaces generated using the automatic gridding process described above in connection with FIGS. 25-27, such as might be input to an automated structural model generation process of the present disclosure. The automated structural model generation process may use a user- or operator-defined stratigraphic column, which is a set of rules that define geology layers or formations. These rules define the order of the geologic formations and whether the formations can ever cross one another. If not, then whenever the formations cross, the automated structural model generation process trims one or both formations to eliminate the crossing and create a satisfactory structural model. For example, as seen in FIG. 28, the depth surface 2804 comprises portions 2804a and 2804b crosses over the depth surface 2808, which, in this example, is prohibited by the predefined rules in the applicable stratigraphic column. The result of the automated structural model generation process is shown in FIG. 29. Based on the predetermined rules applied during the automated structural model generation process, the portion 2804a has been automatically removed to eliminate the crossover, leaving only the portion 2804b, which terminates upon intersection with the depth surface 2808.

The rule set used in the automated structural model generated process may be based, for example, on characteristics or properties of geologic layers and/or formations. In such embodiments, the rules increase the likelihood that the structural model will accurately predict the actual geologic structure of the modeled volume.

Once the structural model has been formed, it can be used to assign horizontal and vertical wells to a producing formation based on where they are located relative to the structural model. Often times, the producing formation of the wells is not reported. Even when the producing formation is reported, it is not always reported in a consistent manner by different operators. However, formation assignment is an essential attribute to understanding well performance trends. The structural model assignment allows the assignment of wells to producing formations in a consistent way.

For vertical wells, the producing formation is assigned based on the location of the perforated intervals within the structural model. For horizontal wells, the producing formation is assigned based on the location of the horizontal section (or perforated/frac zones, if known) of the well within the structural model.

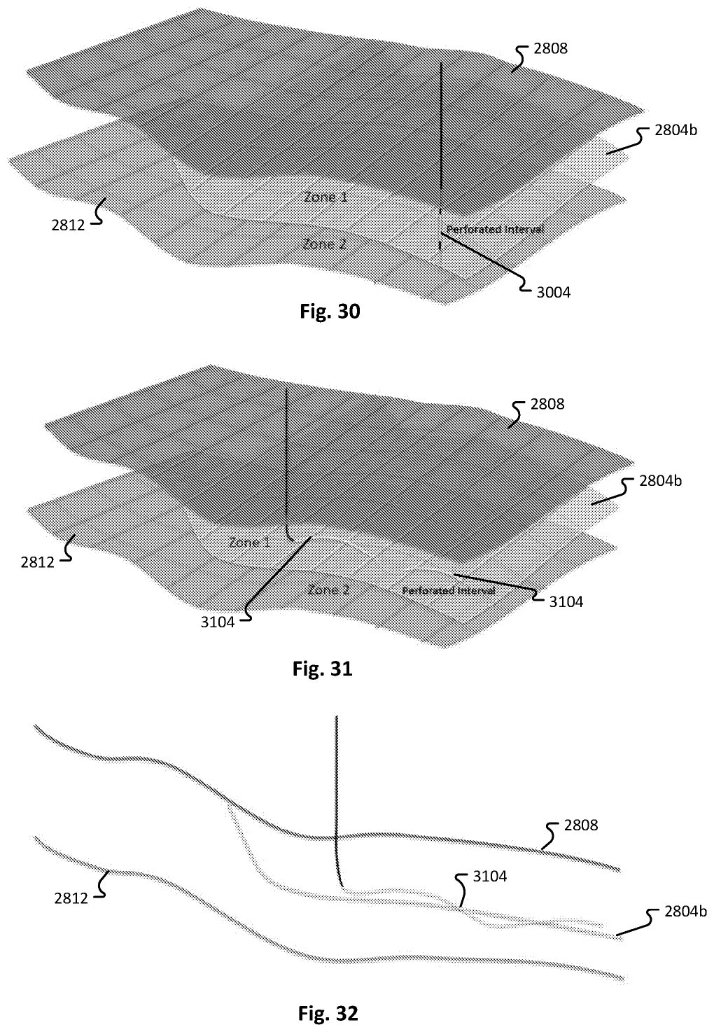

Referring now to FIG. 30, for a vertical well, the perforated interval 3004 of the wellbore is compared to the structural model. The zone of the structural model within which the perforated interval 3004 is primarily located is assigned as the producing formation for the well. Thus, in FIG. 30, the perforated interval 3004 is assigned to Zone 1 (e.g., the formation bounded on the top by the depth surface 2808, and on the bottom by the depth surface 2804b).

In cases where there are multiple perforated intervals, or where the perforated intervals span multiple zones, the zone in which the greatest amount of perforated interval is located is assigned as the producing formation for the well.

Turning to FIG. 31-32, for a horizontal well, the horizontal section 3104 of the wellbore is compared to the structural model. The zone in which the horizontal section 3104 of the well is primarily located is assigned as the producing formation for the horizontal well. In FIGS. 31-32, the horizontal section 3104 is primarily within Zone 1, and so Zone 1 is assigned as the producing formation for the depicted well.

In addition to assigning a producing formation, a variety of attributes can be calculated based on the well location within the structural model. These include, for example, attributes corresponding to the primary formation of the well, the well length within each formation, the average distance from the well to the top of each formation, the average distance from the well to the bottom of each formation, and the average percentage location between the top and bottom of the primary formation.

Once wells have been assigned to a formation, attributes of those wells that relate to the geology of the reservoir surrounding the wells can be gridded for the assigned formations of the wells to create geologic property maps. Well attributes can also be generated and used to create geologic property maps based on the averaging of well logs (or of mud logs, fiber optics, or other measurements along the well) over the portion of the log that is located within the zone. Examples of geologic property maps include: thickness, gas cut, water cut, gas oil ratio, pressure, gamma ray, resistivity, porosity, production, and API gravity (American Petroleum Institute gravity, which is an inverse measure of a petroleum liquid's density relative to water).

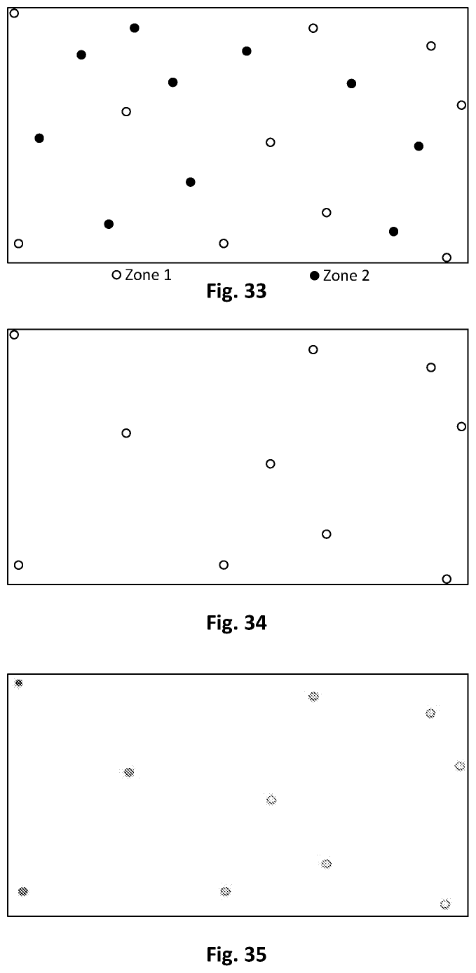

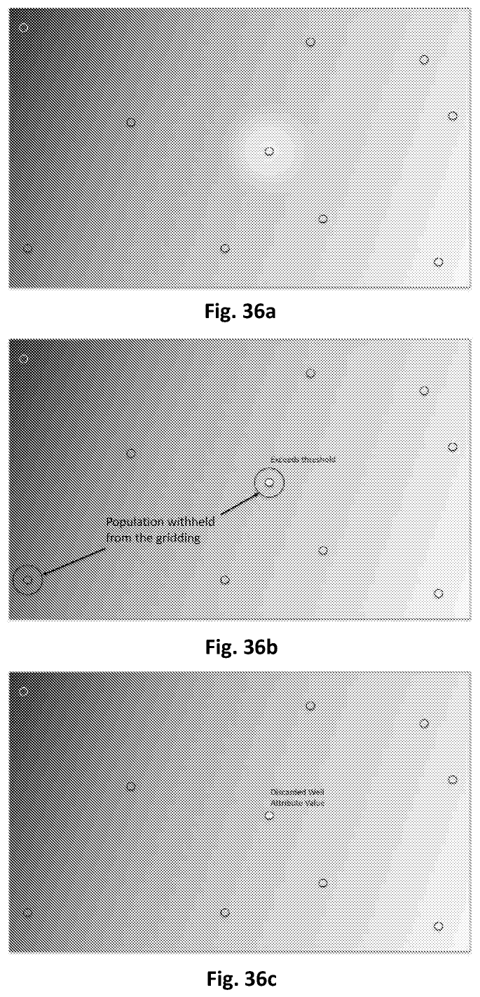

According to embodiments of the present disclosure, geologic property maps are gridded automatically, using a similar technique to the technique used to create structural maps. FIG. 33 shows all of the wells in a given area, including some wells assigned to a Zone 1 producing formation and some wells assigned to a Zone 2 producing formation. Because the purpose of the geologic property map is to map a single producing formation, all of the Zone 2 wells are excluded in FIG. 34. In FIG. 35, the value for each well of the well attribute to be mapped is shown. (FIG. 35 uses color to depict the value for each well of the well attribute to be mapped, but the value could also be depicted numerically or otherwise.) Using the well-specific data, the attribute being evaluated may be extrapolated for the entire area being mapped (or, in other words, the map is gridded based on the well-specific data), as shown in FIG. 36a. The well population is divided into N approximately equal-sized subpopulations, N−1 of which are used to grid a geologic property map in successive iterations until each subpopulation has been excluded from the gridding process once. The subpopulation that is held out is compared to the resulting gridded geologic property map, and for each well within the subpopulation, the value of whichever property is being gridded is compared to the value suggested by the gridded geologic property map. FIG. 36b shows a gridded geologic property map generated while two identified wells were withheld from consideration, as well as the attribute values of the two wells in question. As evident from FIG. 36b, one of the wells has an outlier value for the attribute in question. If the difference between the attribute value of a withheld well and the attribute value at the corresponding location of the geologic property map exceeds a predetermined threshold, the value obtained from the well in the held-out subpopulation is identified as an outlier, and that well/attribute value is not used as an input to the final gridded geologic property map. Thus, FIG. 36c shows the final gridded geologic property map, created without using the outlier well identified in FIG. 36b. As with the creation of the structural maps, machine learning and/or business rules may be used to aid the gridding process.

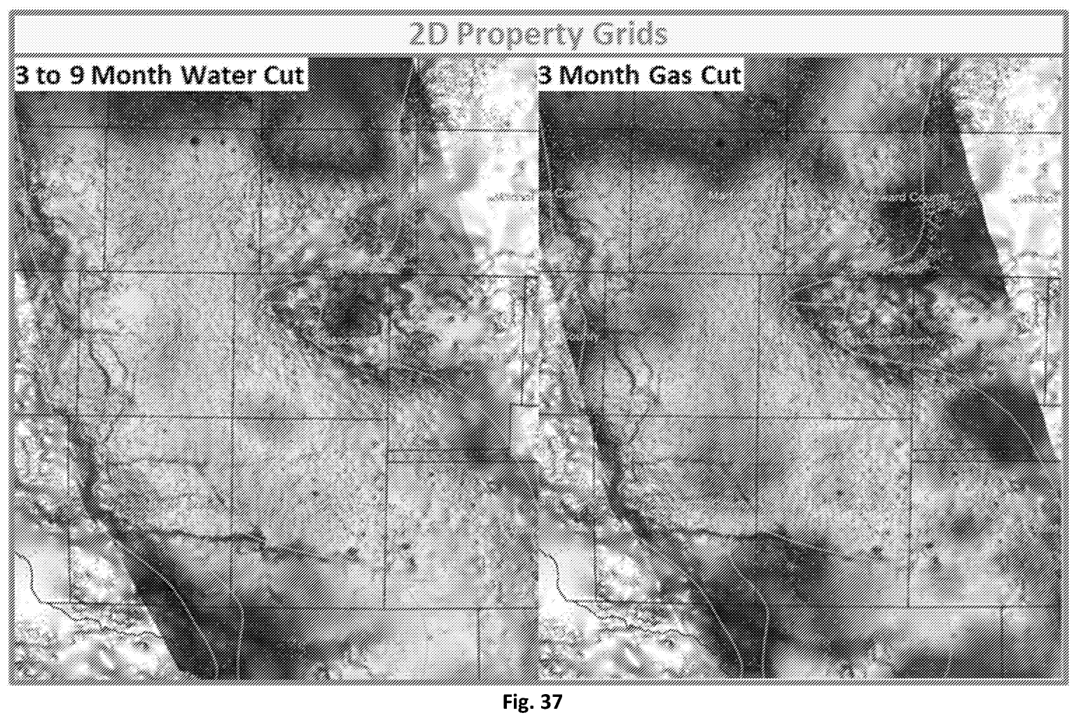

While FIGS. 36a-c illustrate the process of generating a geologic property map, FIG. 37 shows a pair of actual geologic property maps for a given geographic area. These geologic property maps show the 3-9 month water cut for the geographic area in question and the 3-month oil cut for the given geographic area in question.

The geologic property maps of the present disclosure can be both created automatically based on an initial dataset and updated automatically as new data is received, or on a periodic basis.

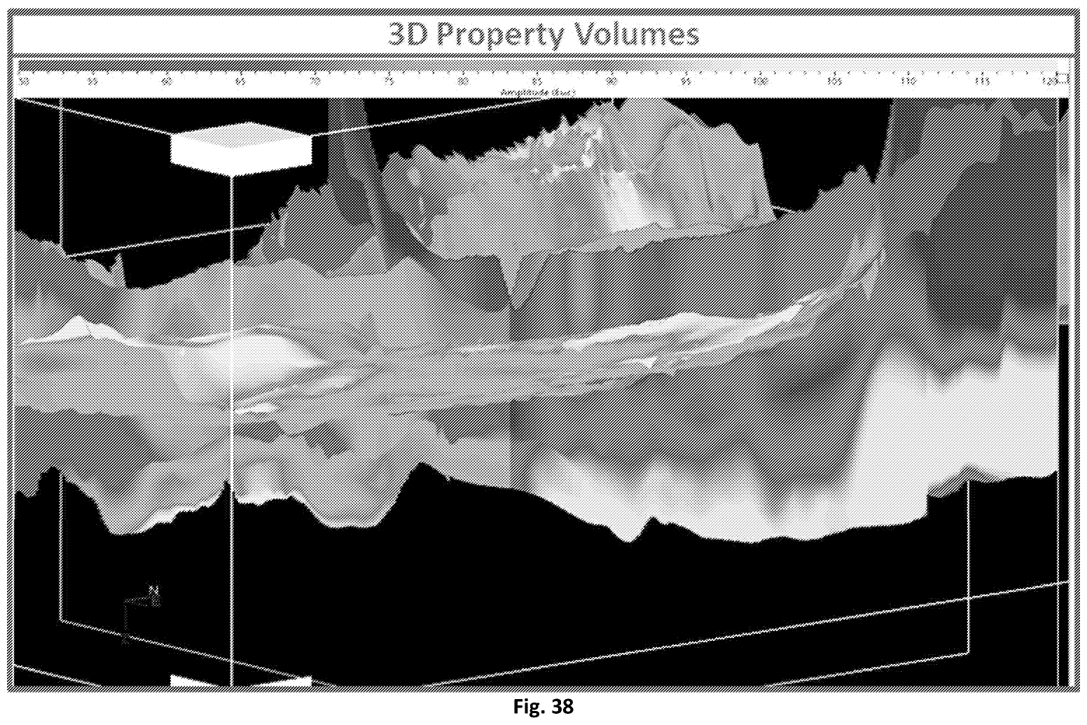

Also as part of step (15) of FIG. 15, three-dimensional property volumes, such as that depicted in FIG. 38, may be automatically generated. The three-dimensional structural models described above provide the depth structure framework for each formation. The geologic property maps discussed above provide the trends of an attribute within that formation. Combining the two, by using the geologic property map to fill in the property values within a structural model of the formation, creates a three-dimensional property volume, with vertically constant zone values. Examples of property volumes that may be shown in an automatically generated three-dimensional property volume according to embodiments of the present disclosure include gas cut, water cut, gas oil ratio, pressure, gamma ray, resistivity, porosity, production, and API gravity. The automatic generation of the three-dimensional property model enables the frequent updating of the models to reflect new data on a periodic basis or as the new data becomes available.

To obtain higher vertical resolution in the three-dimensional structural model, geologic zones can be subdivided by interpolating new geologic grids between existing grids, using rules for conformability or proportionality. Geologic properties can then be gridded for these smaller zones and incorporated into a new three-dimensional property model.

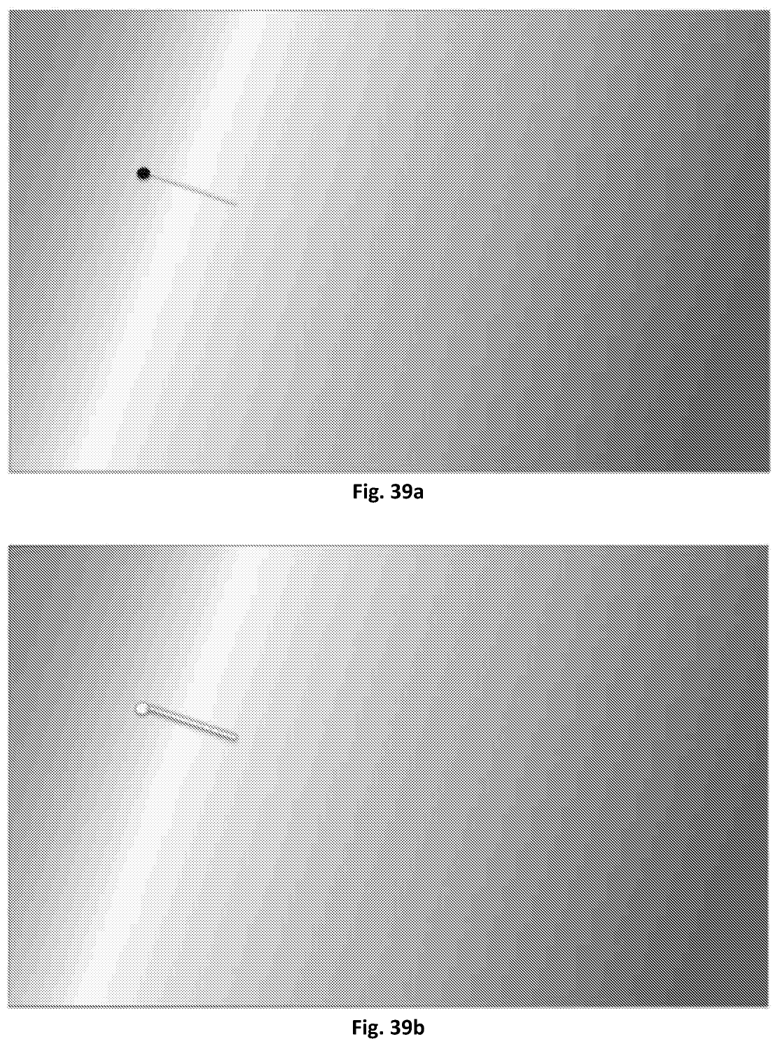

While the geologic property maps discussed above were generated from well attributes, not all wells will have a reported value for the well attribute in question. Some data, for instance, may be available for vertical wells but not horizontal wells, or vice versa. Also, some wells may simply lack a reported value for the attribute in question. Regardless of the reason for a missing attribute value for a given well, any of the geologic property maps described above that relates to the attribute in question can be used to estimate or predict the missing value. For vertical wells, the missing attribute is extracted from the geologic attribute map at the surface location. For horizontal wells, the missing attribute is extracted from the geologic attribute map along the horizontal section of the horizontal well, and then averaged to create a single well attribute. Thus, for example, in FIG. 39a, a horizontal wellbore with a missing attribute is depicted on a gridded geologic property map for the attribute in question. FIG. 39b shows the horizontal wellbore with the predicted attribute value, which was obtained by averaging the missing attribute along the horizontal section of the horizontal wellbore.

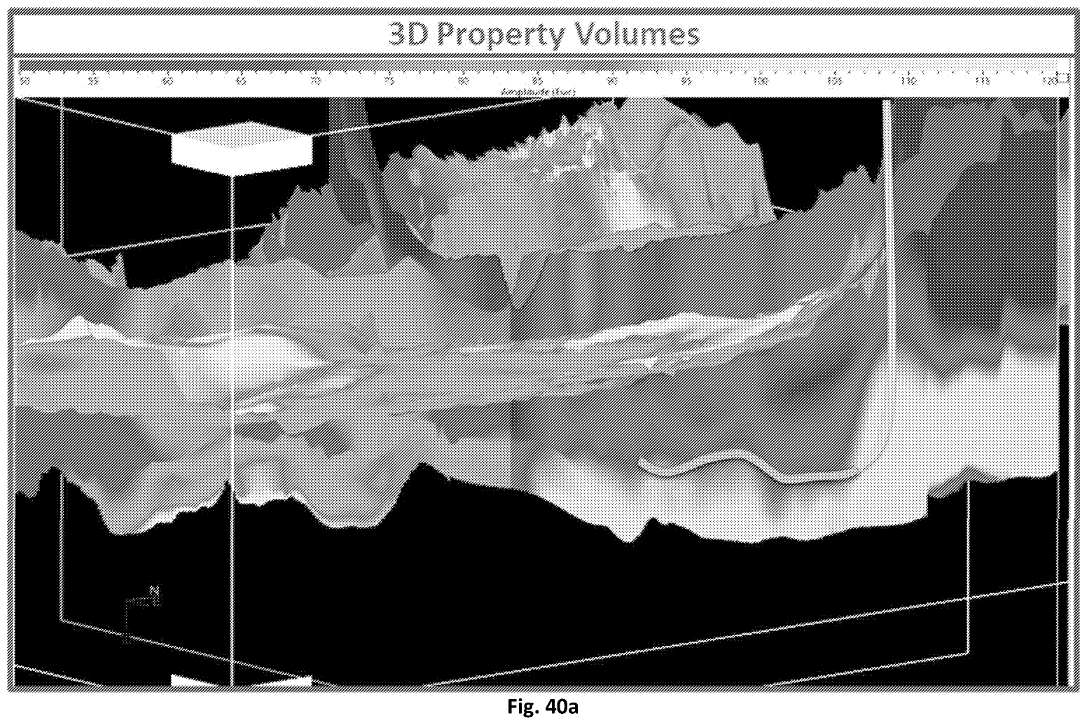

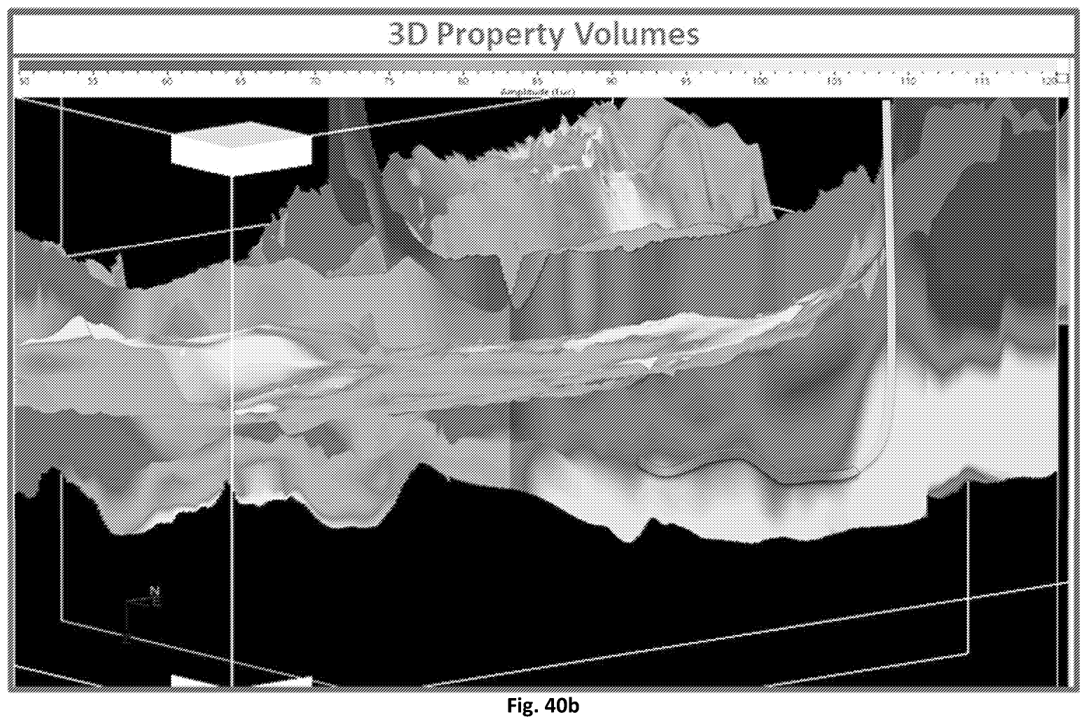

Similarly, the geologic property volumes described above are generated from geologic property maps, which again are generated from well attributes. Once again, not all wells have a reported value for the attribute in question. The missing value can be estimated or predicted, however, using the geologic property volume, in much the same manner as a geologic property map can be used to estimate or predict a missing attribute as described above. For vertical wells, the missing attribute is extracted from the geologic property volume along the perforated interval of the well and averaged to create a single well attribute value. As shown in FIGS. 40a-40b, for horizontal wells, the missing attribute is extracted from the geologic property volume along the horizontal section of the horizontal well and then averaged (using any one or more of a variety of statistical options that will be apparent to persons of ordinary skill in the art) to create a single well attribute.

In step (16) of FIG. 15, data from the horizontal section data table and from geologic structural models is used to generate a distance to structure maps data table. Using the horizontal sections of the wellbores and their projections along the structural models, the average vertical distance from each well's horizontal section to the top and bottom of each producing zone through which the well passes is calculated. These calculated distances are compiled in the distance to structure maps data table.

The producing zone of a well, while essential to know for purposes of the present disclosure, is rarely reported accurately. Thus, in step (17) of FIG. 15, the distance to structure maps data table is used to determine the producing zone within which each well is located. The determined producing zone for each well is compiled in a zone assignment table.

A well's distance to other wells is an important parameter affecting well performance. In step (18) of FIG. 15, the lateral and vertical spacing distance of each well to every other well (or at least to every other well within a predetermined distance) is calculated. Additionally, the time interval between pairs of wells is determined. Thus, if one well enters production twelve months before an adjacent well enters production, a system carrying out the methods of the present disclosure identifies a time interval of twelve months between the wells in question. Additionally, for each well pair, a variety of attributes are calculated, including lateral spacing distance (both minimum and average), vertical spacing distance (both minimum and average), time interval between wells, areal overlap, and whether the pairs are in the same or different producing zones. Both the horizontal section data table and the zone assignment data table are used to make the calculations and determinations of step (18), and the result of step (18) is a well spacing pairs data table.

In step (19), data from the well spacing pairs data table is used to calculate a variety of well spacing attributes. Step (19) may include, for example, determining the nearest time-dependent neighbors for each well based on the wells that existed at the time the well began producing; determining the nearest current neighbors for each well based on all of the current wells; determining the number of time dependent and current neighbors within a specified distance of a well; and classifying wells based on their time-dependent spacing to other wells (e.g. outer, inner, parent, infill, batch). The result of step (19) is a well spacing attributes data table in which the foregoing information is compiled.

Further regarding step (19), when analyzing the past performance of wells, the current spacing of the wells is not a useful attribute. The necessary attribute is a time-dependent spacing that only takes into account wells that existed prior to or during the time window of the production attribute being analyzed. For example, if the production of a well during its first 6 months in operation is being evaluated, the evaluation should consider only wells that existed prior to or during the first 6 months of production of the well. Thus, the first production date or comparable date attribute of each well is used to determine which neighboring wells existed prior to or during the producing window of each well. In evaluating whether a second well is a neighbor to a first well, information such as whether the first and second wells are in the same producing formation, whether the first and second wells have more than a predetermined minimum degree of lateral overlap in the X-Y plane, and/or whether the first and second wells are within a specified or predetermined vertical threshold may be considered.

Once neighbor wells that meet the appropriate timing criteria are identified, a variety of attributes can be calculated from those neighbor wells, including: lateral distance to nearest neighbor (average, minimum, and maximum distances); vertical distance to nearest neighbor (average, minimum, and maximum distances); total distance to nearest neighbor (average, minimum, and maximum distances); date difference between production date of well in question and its nearest neighbor; degree of lateral overlap with nearest neighbor; number of neighbors within X number of feet from the well (lateral, vertical or total); total production of all neighbors within X number of feet from the well (lateral, vertical or total); total number of producing data of all neighbors within X number of feed from the well (lateral, vertical, or total); nearest left hand or right hand neighbor relative to the wellbore; and target well to neighbor well spacing and sequencing relationships (inner versus outer, parent versus child, sequential versus concurrent). (“Inner versus outer” refers to whether a well is on the edges (outer) or inside (inner) of a pad of wells being examined from a map view. “Parent versus child” refers to whether a well was part of the first round of completions (parent) or whether the well was infilled afterward (child). “Sequential versus concurrent” refers to whether a well was completed at the same time as another well (concurrent) or whether the completions were staggered (sequential).)

The wells being compared for the purpose of determining target well to neighbor well spacing and sequencing relationship attributes can be a subset of total wells, filtered or defined by such parameters as, for example, lateral and vertical distance thresholds, producing formation, completion date differences, and/or lateral overlap. The filtering of the wells being considered will affect the results of the relationship attributes.

One aspect of the present disclosure is the ability take into account the effect on predicted production of a well caused by one or more neighboring wells. Traditional methods of evaluating the effect of neighboring wells on the production of a given well each suffer from one or more drawbacks. One such method, based on a determination of time-dependent spacing, does not capture all needed information. For example, if three wells are drilled adjacent to each other, they may have the same time-dependent spacing, but the well in the middle will have two neighbors, while the wells on each side will have only one neighbor. This difference in number of neighbors will affect the relative production of the three wells. Similarly, if two new wells are drilled on the same side of a third, existing well, then two wells may have the same time-dependent spacing relative to each other, but one will have both a new neighbor (the other new well) and an existing neighbor that has been producing for some time, while the other will have only one neighbor that has just been drilled.

Another traditional method is based on time-dependent total number of neighbor producing days, but also suffers from drawbacks. In this method, the total number of producing days of all neighbors with a set radius (“neighbor producing days”) is determined. However, this method does not take into account the effect of distance between adjacent wells on well production. For example, two wells may have the same number of neighbor producing days, but the first may be twice as close to its neighbor as the second, such that the production of the first may be more negatively affected than the production of the second.

Other methods include average distance to nearest neighbor (which does not capture situations with multiple neighbors, or differentiate between situations with neighbors that have been producing for a long time and neighbors that have not), total neighbor lateral feet within lateral radius (which again does not differentiate among neighbors by distance or by length of time in production), and total neighbor production within lateral radius (which does not differentiate among neighbors by distance and is strongly biased by geology, because wells in good geology will do well despite neighbors while wells in poor geology will do worse with neighbors).

As evident from the foregoing discussion, time-dependent well spacing attributes are limited in that no single attribute can provide information on the total number of neighbors, the spacing of those neighbors, and the amount of production of each of those neighbors (time or volume) prior to and during the producing window of a well. What is needed, then, is a spacing attribute that is able to combine the total number of neighbors, the spacing of those neighbors, and the amount of production (time or volume) of each of those neighbors prior to and during the producing window of a well. This metric would be a “depletion metric” or “depletion attribute” that provides context on the degree to which a reservoir surrounding a well has been depleted by the well's neighbors prior to the start of production from the well. The latter factor is relevant because wells are not all drilled and operated simultaneously, such that a well may begin operation at the beginning of its lifecycle without any neighbors, but may have two or more neighbors by the end of its lifecycle. Alternatively, a well may begin production with a single producing neighbor well near the end of its lifecycle, and may end production with one or two new wells near the beginning of their respective lifecycles.

In step (20) of FIG. 15, a depletion attribute representing the degree of depletion to which a well has been subjected by its neighboring wells is determined for each well. The depletion metric uses the current cumulative production (time and/or volume) of the neighboring wells (as compiled in the production data table) for every neighbor that existed prior to or during the producing window of the target well, in addition to the distance to the neighboring wells (as compiled in the well spacing pairs data table), and weights the production by time and distance. This depletion metric allows a robust evaluation of the impact of neighboring wells on the production of a well of interest. Additionally, because the overall prediction takes geology into account, production predictions can be adjusted accurately regardless of whether the well is in a crowded area with good geology or a less crowded area with poor geology.

To account for higher permeability nearer to the wellbore, the lateral distance between wells is typically weighted using a Gaussian, Logistic, or other mathematical distribution function that weights more heavily at closer distances and less heavily at further distances. This weighting function, which is used to model the decrease in the producibility of a well as a function of distance from the wellbore, is an approximation of the fracture permeability created by the hydraulic fracturing for a given well. Nearest to the well is the greatest amount of induced fracturing and the highest weighting factor. Moving away from the well, the amount of induced fracturing decreases, ultimately reaching zero where no frac fluid has reached from the given well. This is emulated by the fall-off of the weighting function, ultimately to zero/negligible values.

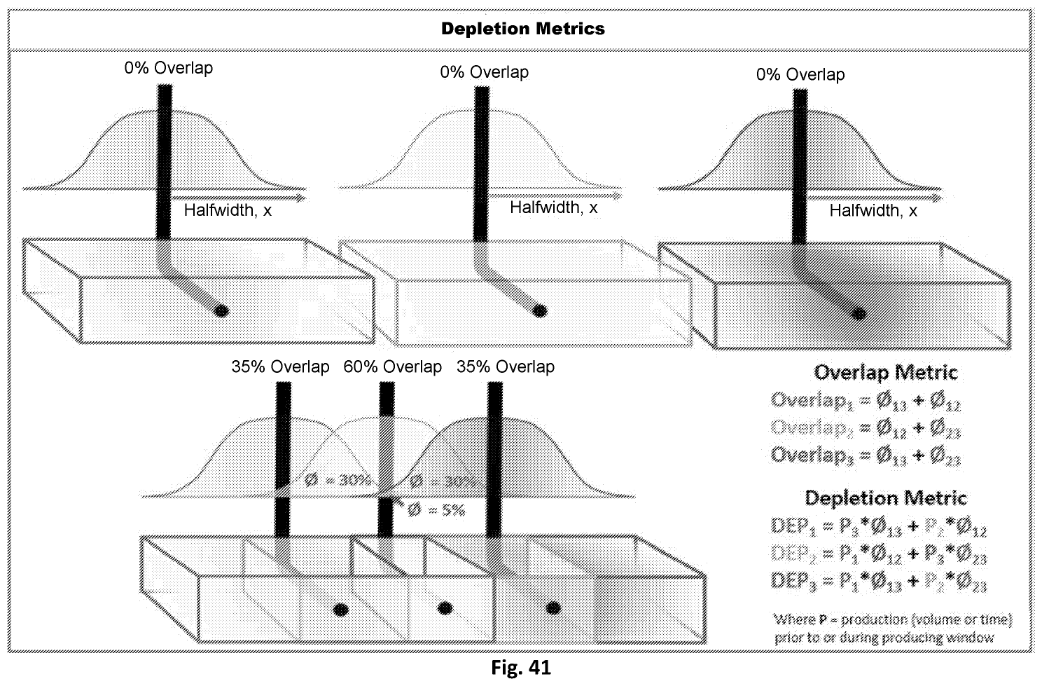

Determining the depletion metric or attribute involves modeling the decrease in producibility (e.g., fracture permeability) laterally away from the wellbore of a given well, using a function (e.g., Gaussian, Logistic, Linear) with half width X. FIG. 41 provides an overview of the process of making this determination. The production for each well is weighted by the distribution function, and then all of the weighted values are summed together to get the final depletion metric value. The depletion metric values are compiled in a depletion attributes data table.

Logically, the weighting function could be isotropic (same in all directions), but most likely the weighting function would have a different character in the vertical and horizontal directions (due to geologic layering and minimum stress orientations). The weighting function could also have different horizontal weightings for different perpendicular azimuths away from the well. In some embodiments, the weighting function may be interpolated between specified orientations to become a three-dimensional weighting function radiating away from a given wellbore. Note that the weighting function approximates hydraulic fracking effects, and can be further refined by deriving function forms from, for example, fracking intensity (water and proppant per foot), type of fracking, and rock geomechanics.

Once the distance weighted production is calculated for each neighbor, the values for all of the neighbors are summed together to create a single value which represents the magnitude of depletion experienced by the target well from all of its neighboring wells. In some embodiments, the distance weighted depletion metric is applied in only two dimensions (e.g., considering lateral distance only). In other embodiments, the distance weighted depletion metric is applied in three dimensions (e.g., considering both the lateral and the vertical distance to each neighbor). In both two-dimensional and three-dimensional implementations, the distance weighted depletion metrics could be used in conjunction with original oil in place (OOIP), original gas in place (OGIP) or another grid or volume metric that can be reduced by the weighting functions over time.

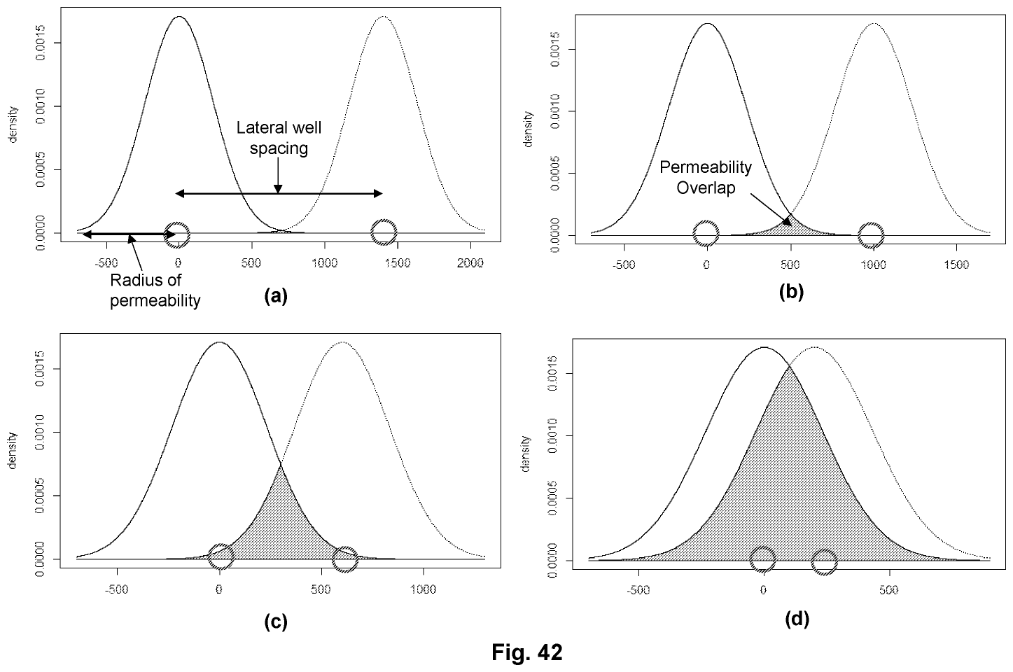

More specifically with respect to step (20), determining the depletion metric or attribute, which depends upon the assumption that wells produce more oil nearer to the wellbore than further, may involve generating a Gaussian permeability distribution attribute based on well spacing. FIG. 42 depicts four graphs, each showing a primary well (represented by a circle on the x-axis at 0), a neighboring well (represented by a circle on the x-axis at a point corresponding to the lateral distance between the neighboring well and the primary well), and a permeability curve associated with each well that indicates the permeability of the well as a function of distance from the well. The permeability of the well is a measure of the permeability of the ground surrounding the well due to hydraulic fracturing. The process of hydraulic fracturing generates cracks in the rock, props them open, and thus artificially creates permeability in the rock to a degree that oil can actually flow to the well. Because the permeability is generated by the hydraulic fracturing, the permeability is higher closer to the wellbore, where the hydraulic fracturing is more effective. As the distance away from the well increases, this effectiveness decreases, so the permeability decreases away from the well until it eventually matches the original permeability of the rock. The distance from the well to the point where there is no added permeability due to hydraulic fracturing from the well is referred to herein as the radius of permeability. As evident from the graphs of FIG. 41, wells that are spaced sufficiently far apart have no permeability overlap, while wells that are spaced closer together (at a distance less than the sum of the radius of permeability of each well) have more permeability overlap. For each well, the degree of permeability overlap between the well and neighboring wells (including planned new wells) is computed as a function of distance. The number of producing days prior to a new neighbor well's completion, as well as the number of producing days for all neighbor wells during the well's production time window, are then weighted by the degree of overlap based on the lateral spacing and the Gaussian distribution and summed together. The resulting metric is a distance-weighted measure of the depletion a well undergoes from its neighbors.

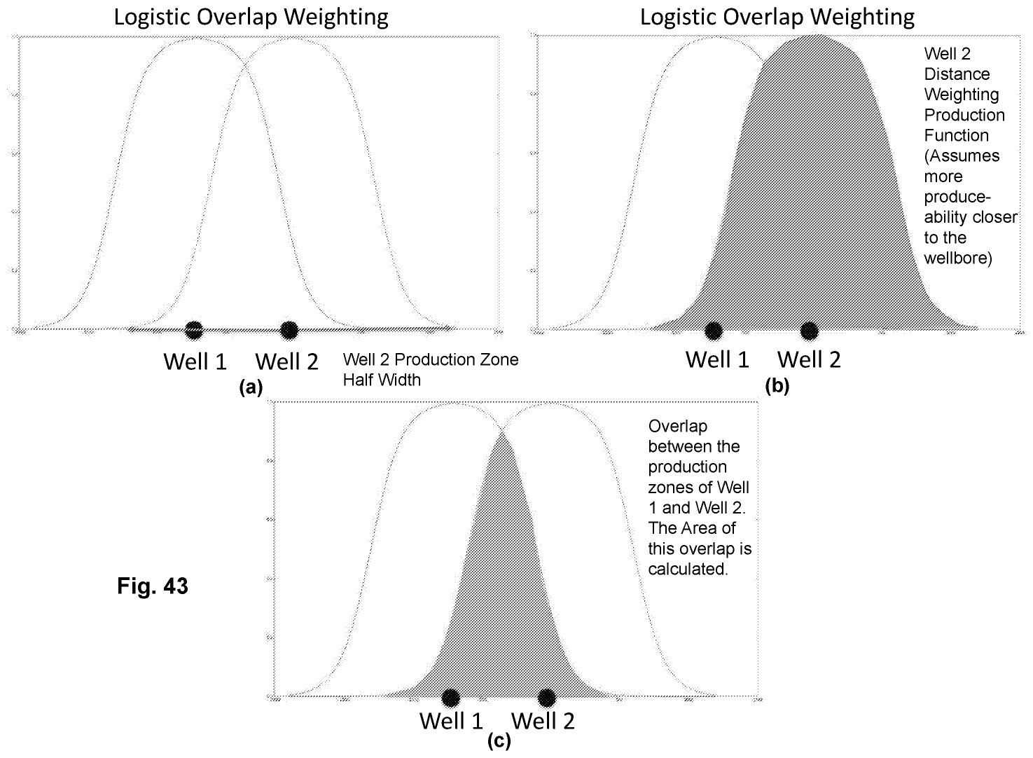

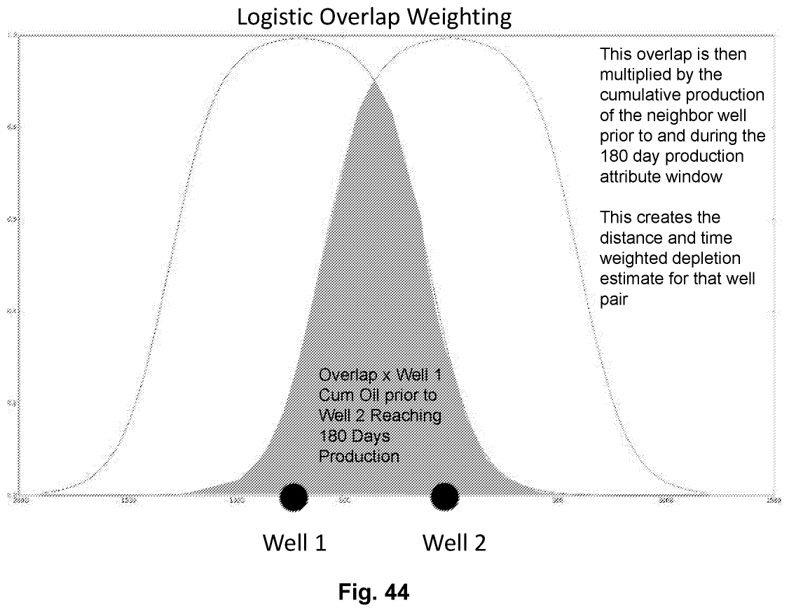

FIGS. 43 and 44 illustrate the use of a logistic function to determine the distance- and time-weighted depletion estimate for a given well pair. For each neighbor well having a producibility curve that overlaps the producibility curve of the well in question, the area of overlap is calculated, then multiplied by the cumulative oil production of the well prior to the date that the neighboring well reaches 180 days of production (or any other length of time of production determined by a user or an operator of the production prediction system). This creates the “depletion estimate” of the first well on the second well, and this process is repeated for all neighbor wells within 10,000 feet laterally of the well in question. Lateral distances other than 10,000 feet may be used, as determined by a user and/or by an operator of the production prediction system. Then, for each well, the depletion estimate contributions from each neighbor well are summed to obtain a total depletion estimate value, which becomes the depletion attribute. A depletion attribute is determined for each well. As noted above, although described here in only two dimensions, the depletion attribute can also be calculated so as to take into account three dimensions, using vertical distribution functions as well as lateral distribution functions. The depletion estimates can be applied to two-dimensional or three-dimensional models of original hydrocarbons in place, or to another production metric.

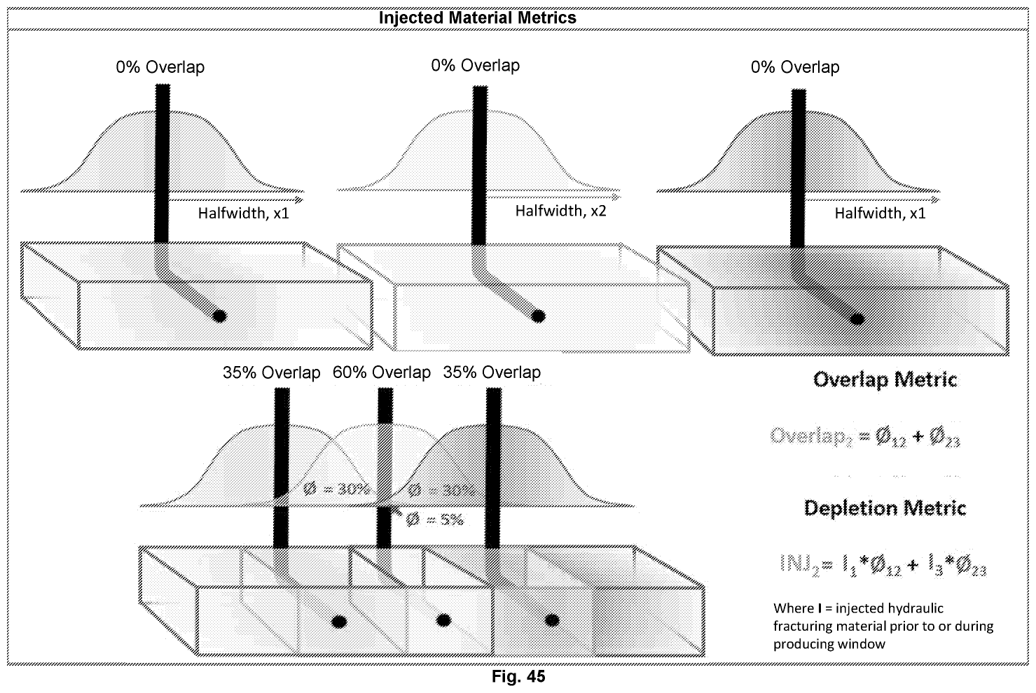

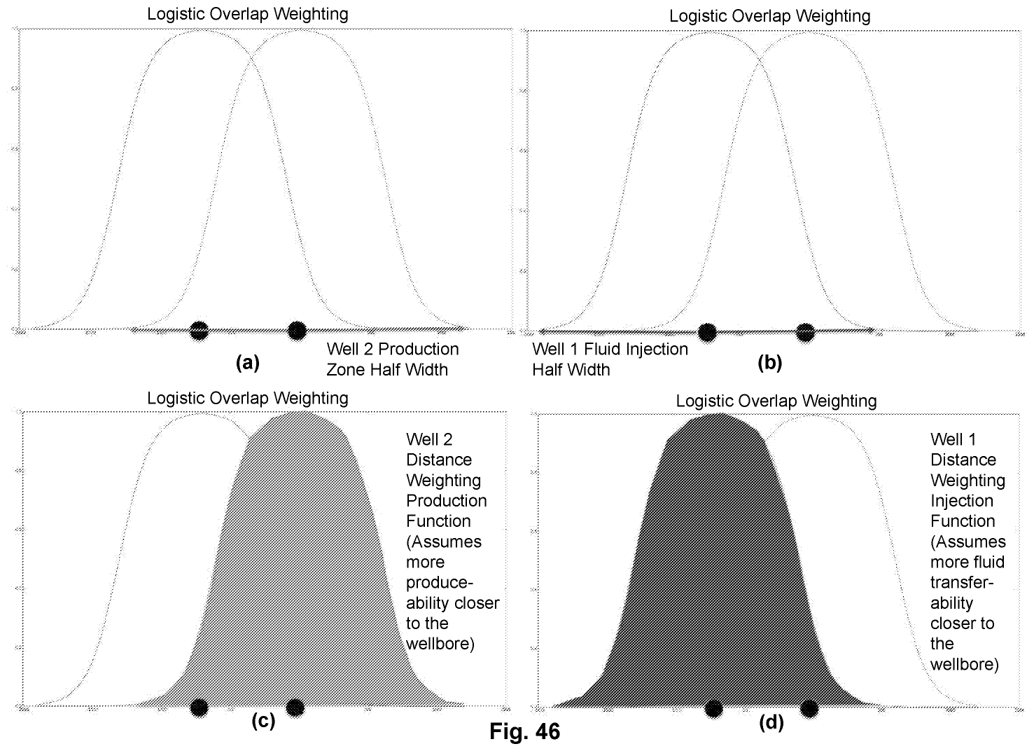

As part of determining the impact of neighboring wells on a target well, an injected material density estimate attribute may be determined. According to embodiments of the present disclosure, the determination utilizes a similar methodology to that used to determine the depletion attribute or metric. An overview of the methodology is provided in FIG. 45. The decrease in fluid transferability of neighboring wells is modeled (based on, for example, fracture density, fluid rate, reservoir pressure) laterally away from the wellbore using a distribution function with half width x1. The oil producibility is modeled laterally away from the wellbore using a distribution function with half width x2. While the depletion attribute or metric estimates the produced volume extracted from an area surrounding a target well, the injected material density estimate attribute estimates the volume of fluid injected into the area surrounding the target well. In other words, the injected material density estimate attribute provides context regarding how much hydraulic fracturing material (fluid and/or proppant) was injected by a target well's neighboring wells into the reservoir surrounding the target well prior to or during the producing window of the target well. Additionally, this metric weights the total injected material by the lateral distance to the target well for every neighbor that existed prior to or during the producing window of the target well.

To account for the higher permeability nearer to the wellbore, the lateral distance is typically weighted using a function like a Gaussian or Logistic function, that weights more heavily at closer distances and less heavily at further distances. Once the distance weighted injection volume is calculated for each neighbor, the values for all of the neighbors are summed together to create a single value which represents the amount of injected material in the reservoir surrounding the target well. This technique can be applied in two dimensions (considering lateral distance to neighbors only) or in three dimensions (considering both lateral and vertical distances to neighbors). The injected material density values can be tied to original frac intensity (e.g., frac fluid per foot), frac type, rock character, or other geologic, engineering, or mathematical properties.

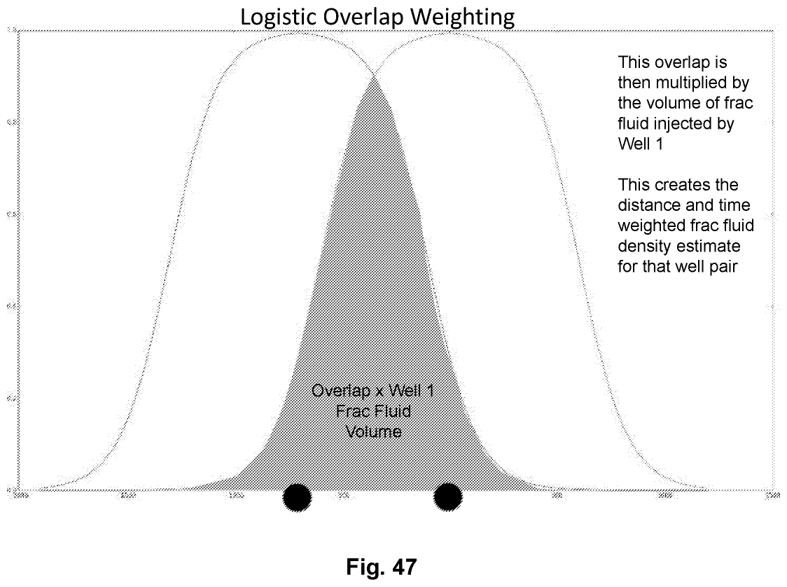

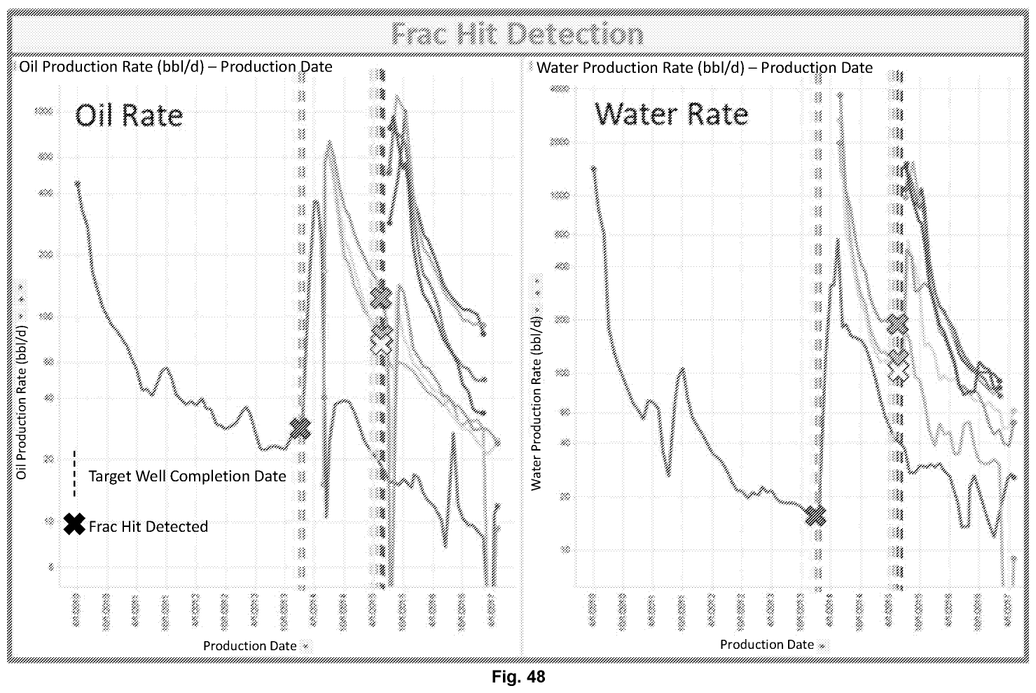

The injected material density estimate attribute determination is based on the assumptions that wells inject more hydraulic fracturing material (frac fluid and/or proppant) nearer to the wellbore than further away, and that wells produce more oil nearer to the wellbore than further away. As shown in FIGS. 45-47, when the fluid transferability functions overlap with the oil producibility function, the area of overlap is calculated, then multiplied by the cumulative frac fluid injected by the injection well. This creates an injected frac fluid density estimate of the first well on the second well. The process is repeated for all neighbor well pairs that fall within, for example, 10,000 feet laterally of each other. For each well, the frac fluid density estimate contributions from each neighbor are summed to create a total frac fluid density estimate value, which is then included in an injected material density estimate attribute table.

As noted above, the total frac fluid density estimate value can be determined in two dimensions (considering lateral distance only) or in three dimensions (using vertical distribution functions as well as lateral distribution functions). It can be used in conjunction with two-dimensional or three-dimensional models of, for example, reservoir pressure, rock type, and/or geomechanics.

In step (21) of FIG. 15, the well spacing pairs data table, the production data table, and the completion data table are used to generate a frac hit attributes data table. When new wells are hydraulically fractured, the high volume of fluid pumped into the well during the fracking process can have an impact on the production of existing wells. This impact is called a “frac hit.” Frac hits are identified by evaluating the production rate of neighboring wells prior to the completion date of the target well. If the production rate of the neighbor well shows a significant increase or decrease after the completion date of the target well, then a frac hit has occurred. The magnitude of the production change and the period of time that passes before the production rate returns to normal are recorded. By identifying the frac hits, key factors that may contribute to the increased occurrence of frac hits may be analyzed, such as the fluid volume of the target well or its proximity to the neighboring well. The results of frac hit analysis for each well are compiled in the frac hit attributes data table.

Frac hit analyses can also incorporate pressure data, fiber optics data, wellbore deformation events, and other indicators of well-to-well frac interference. Additionally, frac hit detection can be performed in two-dimensional or three-dimensional orientations, over time.

FIG. 48 shows two graphs, one of oil production rate over time and another of water production rate over time, for a plurality of wells. In each graph, target well completion dates are shown by a vertical dashed line, and detected frac hits are shown with a bold “x”. As evident from these graphs, significant changes in oil production rate and water production rate occurring on the completion date of a target well are indicative of a frac hit.

In step (22) of FIG. 15, data from the various attribute tables described above (and from data tables that were not used to create an attribute table) are merged into a single “merged data” data table. The attribute tables that are merged thus include, for example, the well header data table, the production test data table, the completion attributes table, the production attributes table, the drilling attributes table, the FracFocus attributes table, the geologic attributes table, the frac hit attributes table, the depletion attributes table, the well spacing attributes table, and the zone assignment table.

In step (23), the “merged data” data table is provided to a prediction algorithm that predicts well production for a variety of production intervals (e.g. 30-day, 60-day, 90-day) and production types (e.g. oil, gas, water, condensate) at different points in the well's lifecycle (e.g. permitted, drilled, completed, flowback tested, producing, recompleted). The prediction algorithm uses non-parametric, non-linear regression in combination with machine learning and classification techniques to make predictions using combinations of well attributes. Techniques utilized to generate the prediction include Additivity and Variance Stabilization (AVAS), the mapping-set machine learning technique described above, and decline curve analysis. The models used to predict future well production are first validated based on their ability to blindly predict past well production correctly. The result of step (23) is a new prediction data table that includes production predictions, actual production values (where available), and error ranges for the predictions.

The AVAS technique is used to model and optimize such parameters as drilling and completions effectiveness, well performance, geologic sweetspot identification, equipment lifespans, hazard avoidance, well spacing and interference, recompletion timing, hydraulic fracturing chemical compositions, oilfield supply chain, and oilfield economics. The technique is useful because it is highly transparent and generates plots of how each independent variable is estimated to influence the response variable. These plots help to verify the model has estimated relationships that are physically plausible. The plots can also be used to make optimization decisions, which makes the AVAS technique more actionable than available “black box” techniques, such as neural nets and decision trees.

The AVAS technique is described in Hastie, T. J. & Tibshirani, R. J., Generalized Additive Models (Chapman & Hall/CRC 1990), which is incorporated herein by reference. The AVAS technique and other prediction methods are described in Banks, D. L. et al., Comparing Methods for Multivariate Nonparametric Regression (School of Computer Science, Carnegie Mellon University, January 1990), which is also incorporated by reference herein. A comparison of nonparametric regression techniques, which may also be useful for understanding the present disclosure, is provided in a set of slides prepared by Dr. David Banks and available (as of the filing date of this application) at http://www2.stat.duke.edu/˜banks/218-lectures.dir/dmlect3.pdf, which slides are incorporated by reference herein. A method for determining the stability of transformations is described in Breiman, Leo, Fitting additive models to regression data (Elsevier Science Publishers 1993), which is also incorporated herein by reference.

The mapping set technique described previously can take parameters where they exist and predict values for parameters that are not reported. When predicting wells where not all information is known, instead of dropping the variables with missing values (which would result in a less detailed model), the mapping-set technique may be used to determine the various potential values and the probabilities of each potential value, and to output a list of potential values and their respective probabilities for each of a well's missing values. This is useful when data is not reported for a set of wells, as well as for new wells where the data may yet be available.

When making production predictions for wells where values are not available, the mapping-set technique is run first. This generates a field of potential well designs based on the probabilities of different values. A Monte-Carlo simulation can then be performed where many different potential values are sampled and weighted by their probabilities. Production can be predicted using the AVAS models. The many different predictions can then be aggregated into a final prediction.

To make a prediction using the AVAS technique, there needs to be an ample sample size for the production attribute being predicted. For longer-term production predictions (e.g. 5 years, 10 years, 20 years), there may be sufficient data to make prediction models because fewer wells exist with production terms of those lengths. In order to make predictions for wells out to these points in time, the AVAS technique is used to make predictions out to the furthest time possible. Then, decline curve analysis is used to fit a trend through the predictions for all of the shorter time periods, which trend is used to predict out into the future. In some embodiments, the well-known ARPS decline curve technique is used for the decline curve analysis.

With respect to predicting production of a well at the permitted stage, once a well has been permitted, the well location is known, but the drilling and completions parameters are unknown. Using the mapping set-based machine learning technique, the probabilities of various drilling and completion parameters for the new well are identified. A Monte-Carlo simulation is performed to sample many different potential combinations of drilling and completions, and the AVAS prediction models are used to make predictions of each of the simulated designs. The predictions are then aggregated into a single prediction, whether using average or median values or by building a distribution of the predictions and selecting the most likely value based on the distribution. This process may be repeated for different intervals of production (e.g. 30 days, 60 days, 90 days).

With respect to predicting production of a well at the drilled stage, once a well has been drilled, the well location is known and the drilling information is known, but the completions are unknown. Using the mapping set-based machine learning technique, the probabilities of various completion parameters for the well are identified. A Monte-Carlo simulation is performed to sample many different potential combinations of completions values, and the AVAS prediction models are used to make predictions of each of the simulated designs. The predictions are then aggregated into a single prediction, whether using average or median values or by building a distribution of the predictions and selecting the most likely value based on the distribution. This process may be repeated for different intervals of production (e.g. 30 days, 60 days, 90 days).

With respect to predicting production of a well at the completed stage, once a well has been completed, all of the well location, drilling, and completions information is known. As a result, the AVAS prediction model may be used to make predictions for the wells using the available information. This process may be repeated for different intervals of production (e.g. 30 days, 60 days, 90 days).

With respect to predicting production at the flowback test stage, once a well has been flowback tested, all of the well location, drilling, and completions information is known and a one-day production test has been performed. The AVAS prediction model may therefore be used to make predictions for the wells using the available information, including the production test. This process may be repeated for different intervals of production (e.g. 30 days, 60 days, 90 days).

With respect to predicting production at the producing stage, once a well is producing, all of the well location, drilling, and completions information is known and production information for previous months are known. The AVAS prediction model may therefore be used to make predictions for the wells for future months using the available information, including the previous months of production. Once the production prediction time is past the time where the there is a large enough sample size to use the AVAS to make a prediction, the Decline Curve Analysis is used to predict future months of production.

With respect to predicting production at the recompletion stage, when a well is recompleted, there is an additional completion of the well designed to improve the production of the well. At this stage there is information on how the well was originally drilled and completed, but there is also information from the new completion and all of the production history prior to the new completion. In this situation, the AVAS prediction model may be used to make predictions for how the recompletion will impact the future production of the well. Depending on sample sizes, the future production after the recompletion will either be predicted using AVAS, or projected using Decline Curve Analysis.

When a well is completed near an existing producing well, the producing well can experience a “frac hit,” where the existing well is impacted by the hydraulic fracturing treatment of the new well. These events can cause changes in the production of the existing producing well. Using information for the existing well and from the completion of the new well, a prediction can be made regarding whether a frac hit will occur and, if so, what impact the frac hit will have on the existing well. This prediction is made using an AVAS model.

In step (24) of FIG. 15, new predictions for wells are merged with historic predictions for the same wells, based on the new prediction data table and a past prediction data table. The result of step (24) is a prediction data table that contains both the new and the historic predictions. This allows users (after step (25) below) to view predictions made to date and to compare the predictions against the actual production, once production has started.

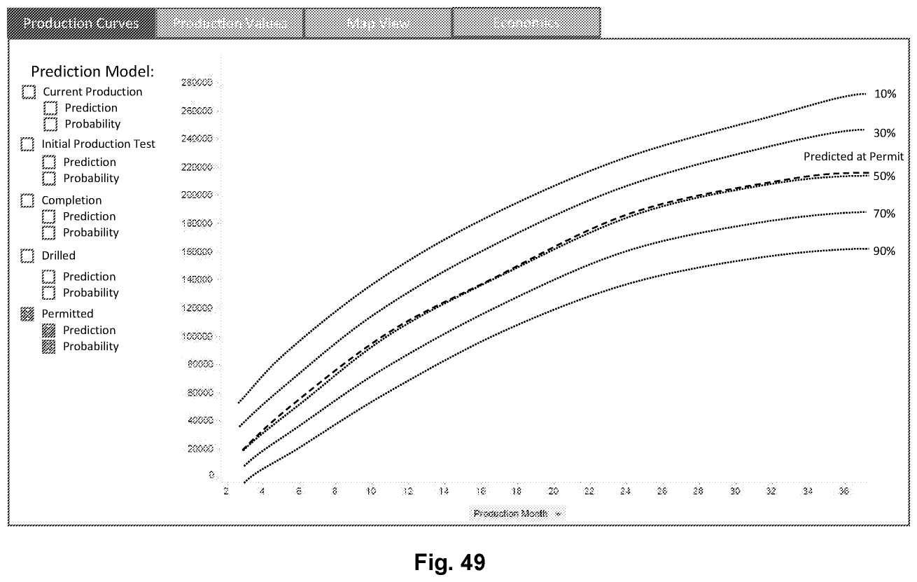

In step (25), the predictions for past, present, and future well production may be uploaded to the cloud and presented to users via a website, proprietary app, or other interface. Users can see the ranges of predictions made at different points in a given well's lifecycle; design a new well and rely on the underlying predictive models to predict how well the new well will perform; and apply economic information to predictions to evaluate the financial performance of a well with a given set of financial parameters. This information may be presented, for example, in the manner depicted by FIGS. 49-59.

With respect to FIG. 49, the processor 104 of the device 100 may cause the user interface 122 to display on a screen thereof a dashboard showing a predicted productivity of a well at a given stage in the well's lifecycle, as well as (in some embodiments) an indication of the probability associated with the prediction and/or with other predictions. For purposes of the present disclosure, the productivity of a well refers to the amount of a given natural resource (e.g. oil) that the well will produce over time. The predicted productivity may be displayed numerically and/or visually. In FIG. 49, for example, the predicted productivity is shown on a graph as total production over time. The probability associated with each prediction is provided adjacent to each curve on the graph. Thus, FIG. 49 indicates that, for the well in question and based on information available at the permitting stage (i.e. when permits have been obtained for drilling the well but before drilling as commenced), there is a fifty percent probability that the well will yield just over 200,000 barrels of oil over the first 36 months of production. FIG. 49 also indicates that there is a ninety percent chance that the well will yield at least 140,000 barrels of oil over the first 36 months of production, a seventy percent chance that the well will yield at least 160,000 barrels of oil during that time period, a thirty percent chance that the well will yield 220,000 barrels during that time period, and a ten percent chance that the well will yield 260,000 barrels of oil during that time period. In FIG. 49, the device 100's actual prediction is shown in by a dashed line, and nearly coincides with the fifty percent probability curve. The actual prediction may be made, for example, based upon the probability curves (e.g. the fifty percent probability curve may be selected as the actual prediction).

As also shown in FIG. 49, the dashboard displayed on a screen of the user interface 122 may allow a user to select a lifecycle stage for which to calculate and/or display a prediction, as well as whether the user would like to view only the selected prediction, only the probabilities associated with a plurality of predictions, or both. In FIG. 49, the user has selected the permitted stage, and has opted to view both the actual prediction (shown in the dashed line) and the prediction probabilities (shown in dotted lines with associated percentages).

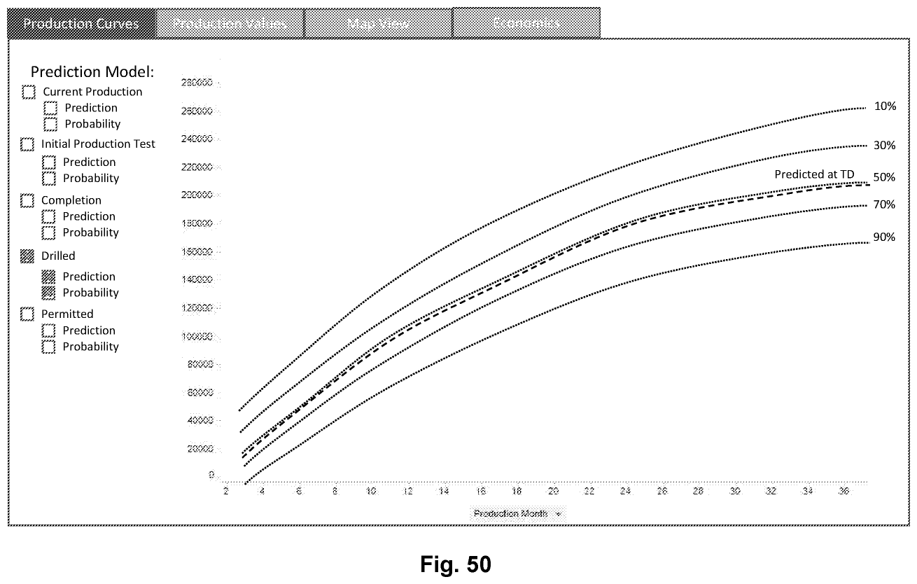

FIG. 50 shows a graph similar to the graph shown in FIG. 49, but the graph of FIG. 50 presents a prediction and associated probabilities at the time of drilling (i.e. when drilling has been completed and the well is lined with pipe). Here again, a user has opted to view both the actual prediction (displayed in a dashed line) and the probabilities associated with various predictions (displayed in dotted lines with associated percentages). Additionally, the actual prediction is still closely aligned with (although not identical to) the fifty percent probability prediction.

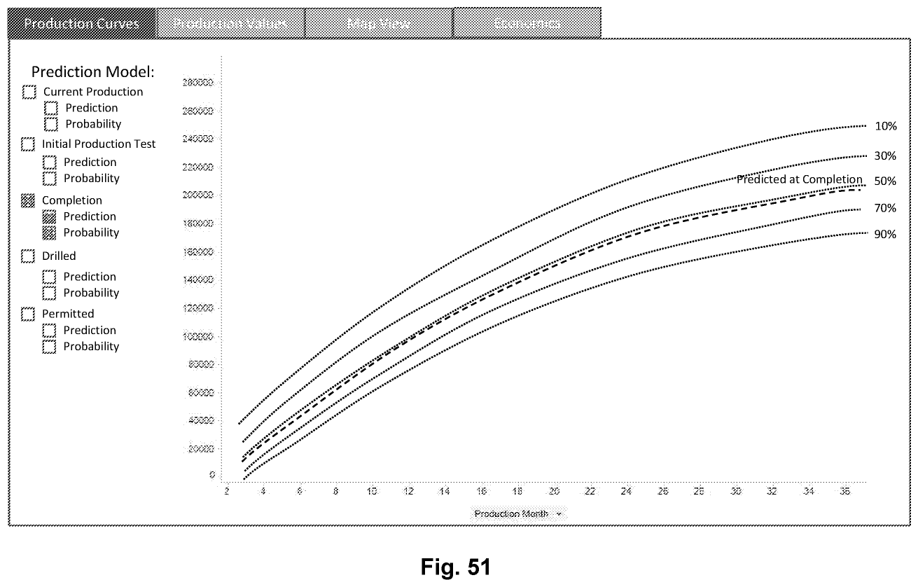

FIG. 51 shows a graph similar to the graphs shown in FIGS. 49 and 50, but the graph of FIG. 51 presents a prediction and associated probabilities at the time of completion (i.e. after hydraulic fracturing fluid has been pumped into the well). The user has again opted to view both the actual prediction (displayed in a dashed line) and the probabilities associated with various predictions (displayed in dotted lines with associated percentages).

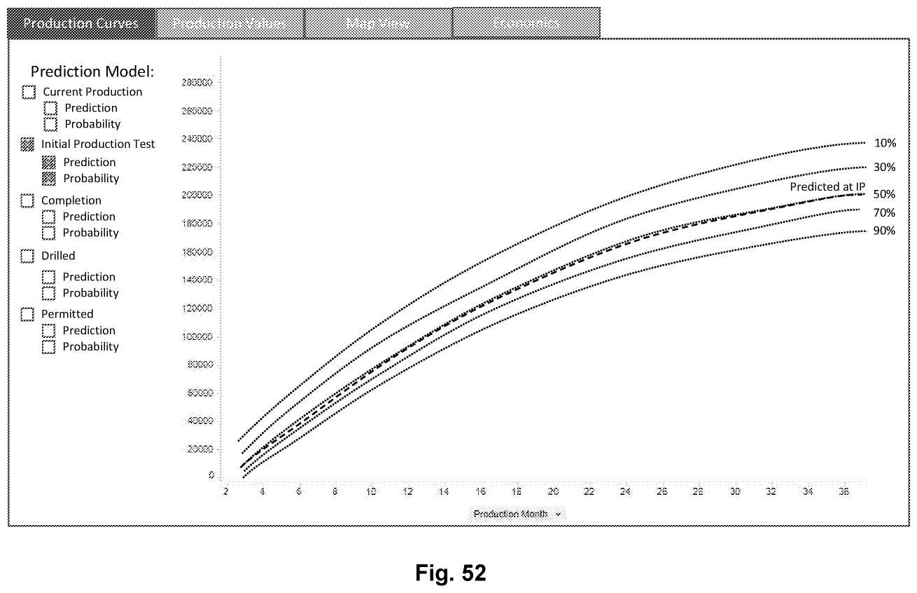

The graph of FIG. 52, like the graphs of FIGS. 49-51, presents a prediction and associated probabilities at the time of initial production (i.e. after post-completion, pre-production testing has been completed).

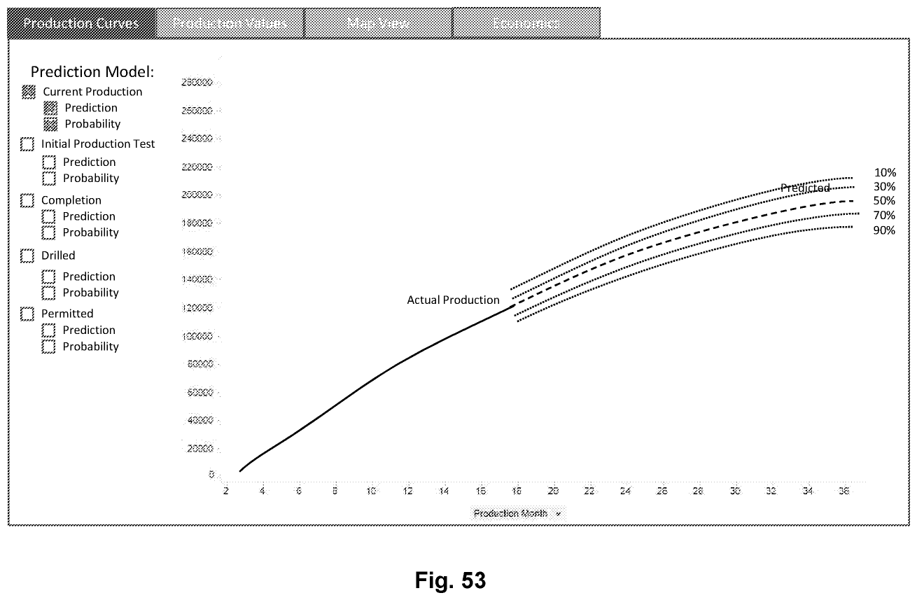

The graph of FIG. 53 differs from the graphs of FIGS. 49-52 because the user has opted to view the prediction and associated probabilities for current production (i.e. at the present time, after the well has begun regular production). Because the well has already been producing for a given period of time, this graph shows the actual production curve from the start of production to the present (in a solid line), and a predicted production curve (together with associated probability curves) from the present onward.

As persons of ordinary skill in the art will understand, the additional production information available for input into the device 100 as the well progresses through its lifecycle results in decreasing uncertainty regarding the predicted productivity of the well. Thus, while the range of probabilities depicted in FIG. 49—before any drilling on the well has commenced—ranges from a ten percent probability of production reaching 260,000 barrels to a ninety percent probability of production reaching 140,000 barrels, the range of probabilities depicted in FIG. 53—well into the regular production cycle of the well, and long after the permitting, drilling, completion, and initial production stages—spans a far smaller range, from a ten percent probabilities of production reaching 200,000 barrels to a ninety percent probability of production reaching 160,000 barrels.

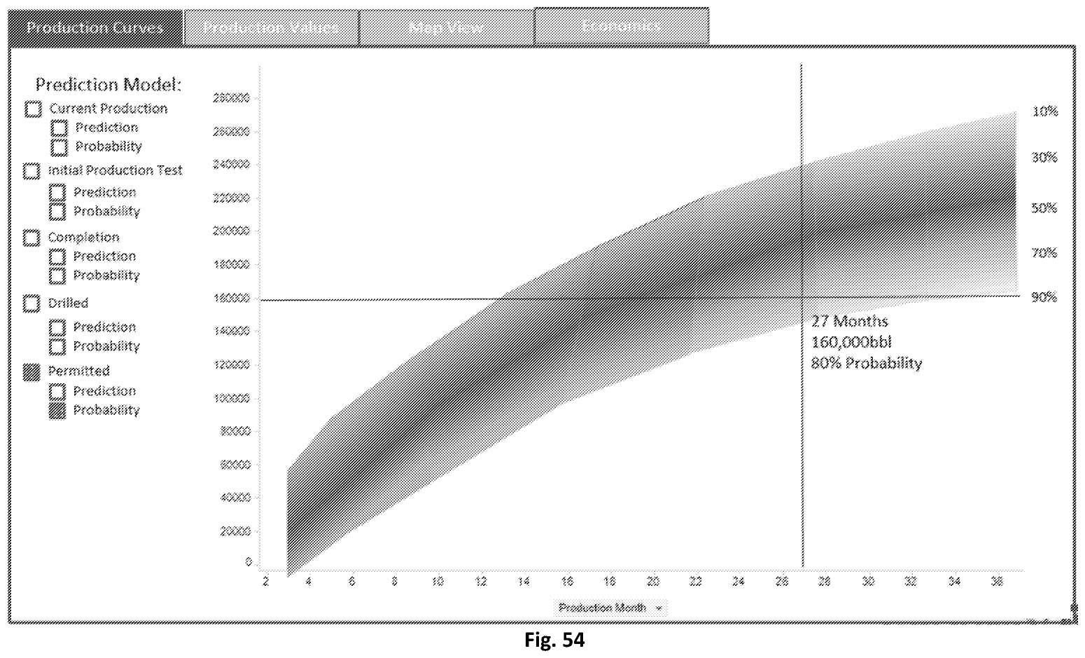

In some embodiments, such as that depicted in FIG. 54, the dashboard caused to be displayed on a screen of the user interface 122 by the processor 104 may display a shaded curve showing predicted production over time for every probability between ten percent and ninety percent. A user may then place a cursor over any particular point on the curve and view the relevant data associated with that point. In FIG. 54, for example, the relevant data for the location at which the user has placed his or her cursor shows that twenty-seven months into the well's lifecycle, there is an eighty percent probability that the well will have produced a total of 160,000 barrels of oil. This view beneficially enables the user to obtain relevant data for specific data points without having to extrapolate or interpolate based on discrete probability curves such as those shown in FIGS. 49-53.

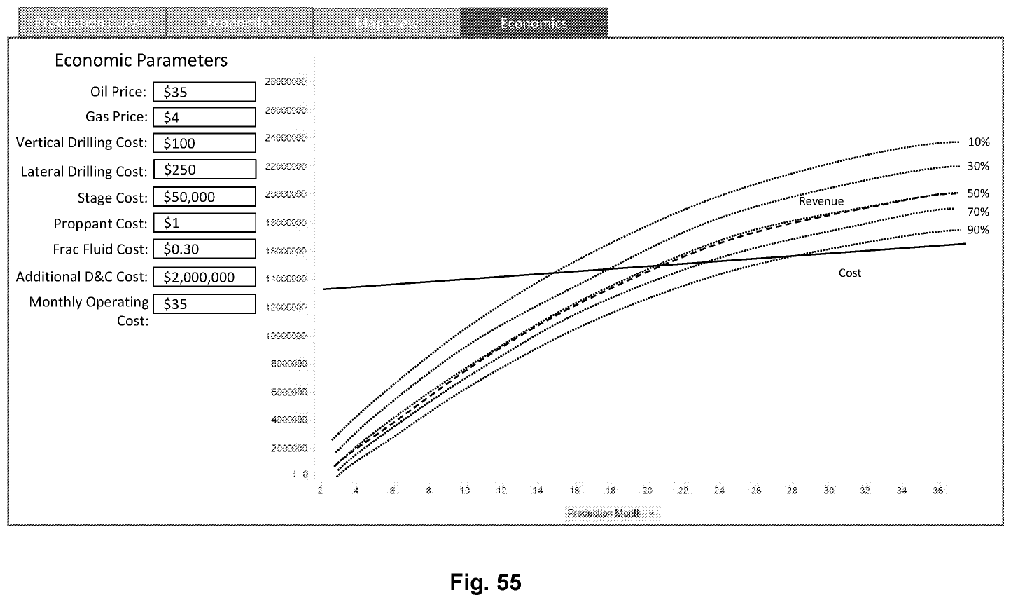

The dashboard as part of which the graphs of FIGS. 49-54 may be displayed may also display an economic prediction for a given well, as shown in FIG. 55. On this screen, a user may enter (or the device 100 may pre-populate, based on data obtained from a database via a database interface 112) relevant economic data such as the current price of oil, the current price of gas, the cost per length of drilling vertically, the cost per length of drilling laterally, the stage cost, the proppant cost per unit volume, the fracking fluid cost per unit volume, the additional drilling and completions costs, and/or a monthly operating cost. Based on this data, the processor 104 may cause the user interface 122 to display a graph showing projected well revenue over time (based on the predicted productivity of the well, with associated probabilities) together with projected well cost over time. The graph of FIG. 55 thus shows that there is a ninety percent chance that the well will break even (i.e. that revenue will match costs) by about the twenty-eighth month in its lifecycle, a fifty percent chance that the well will yield approximately four million dollars above costs by the thirty-sixth month of production, and a ten percent chance that the well will yield approximately eight million dollars above costs by the thirty-sixth month of production. This particular tool allows a user to determine, for example, how fluctuations in the price of oil and/or gas will affect well profitability, so that the user can make an informed decision about whether to expend the resources necessary to install the well. Similarly, a user of this tool could determine, for example, how fluctuations in the costs associated with drilling and completing a well might affect the well's projected profitability.

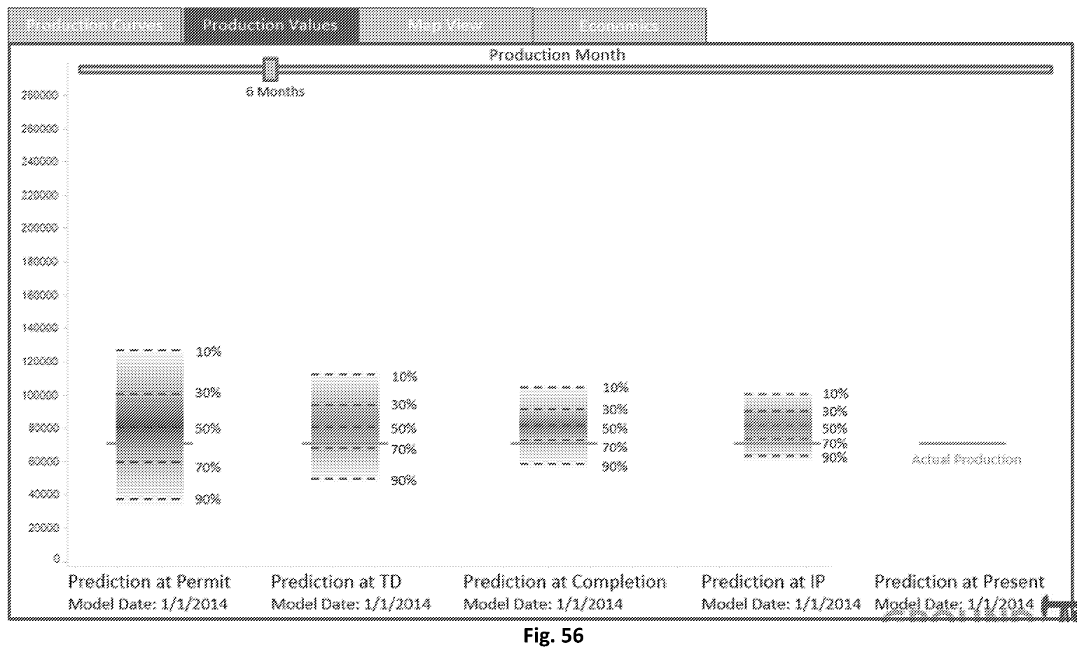

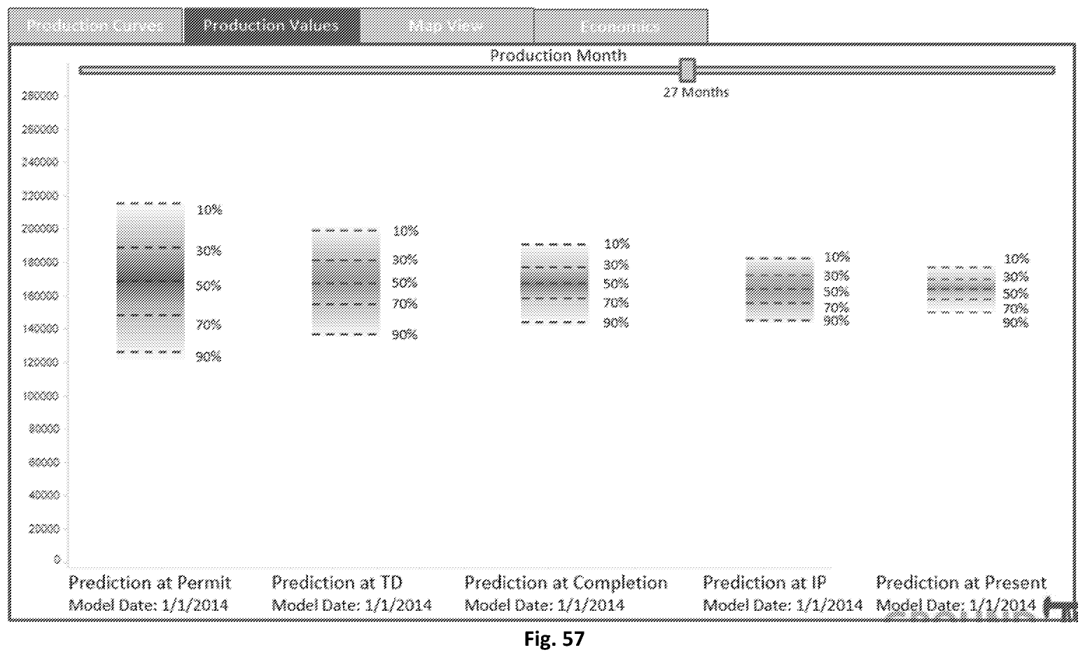

FIGS. 56-57 illustrate a different data output format available through the dashboard that the processor 104 may cause to be displayed on the user interface 122 of the device 100. Rather than present a prediction and associated probabilities for a given lifecycle stage over time, FIGS. 56 and 57 present the predictions and associated probabilities at a given time over the lifecycle stages of the well. Thus, in FIG. 56, for example, the user has opted to view the predictions and associated probabilities that were made at each lifecycle stage for the sixth month of production. In this chart, the decreasing range of probabilities (due to the increasing amount of information available at progressive stages in the well's lifecycle) can clearly be seen, as can the predictions at the various pre-production stages and the actual production amount achieved at the sixth month of production. This particular view may be used to evaluate the accuracy of the predictions made by the device 100.

FIG. 57 shows the same kinds of data as shown in FIG. 56, but for the 27th month of the well's production and without an actual prediction or an actual production amount. In embodiments, the user can select for which stages of the well's lifecycle to display the probability range and/or the actual prediction, as well as whether to display, for each stage, either or both of the probability range and the actual prediction. Of course, before the data for a given stage is available, no prediction is made for that stage, such that there may be no data to display for the stage in question. In some embodiments, once at least some data for a given stage is available, a prediction may be made using the available data, and further using data from the previous stage to fill in for any missing data. Such embodiments may be particularly useful when, for example, needed data for a given stage is subject to confidentiality protections, as is often the case (at least for a limited period of time) after a given stage. (For example, data gathered from initial production and reported to an appropriate regulatory agency may be made publicly available only after a six-month confidentiality period has expired.) Where the well in question belongs to the user of the systems, devices, and methods of the present disclosure, on the other hand, the user can provide the most up-to-date information available (whether by updating an appropriate database, or entering the data directly into a device 100 or other system), without waiting until such data is made publicly available.

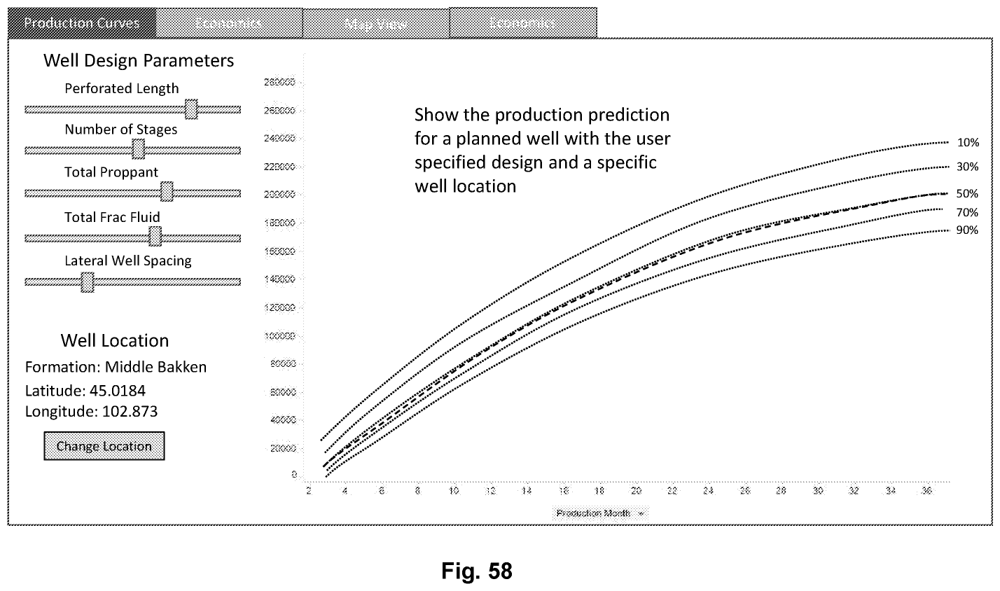

With respect to FIG. 58, the device 100 and other embodiments of the present disclosure may also be useful for evaluating a planned well. For example, a user may provide information about, for example, the perforated length of a well, the number of stages of the well, the total proppant to be used in the well, the total amount of hydraulic fracturing fluid to be used in the well, and the lateral well spacing, together with information about the planned location of the well and the underground reservoir from which the well will extract natural resources. Based on this information and other information available to it (e.g. via the database interfaces 112), the device 100 may generate a prediction of the well productivity over time. The user may then modify one or more parameters of the proposed well to view the effect of such modifications on the predicted productivity of the well. In this manner, the user may identify those parameters that result in the greatest (or at least greater) predicted productivity, and beneficially avoid expending resources to drill an underperforming well.

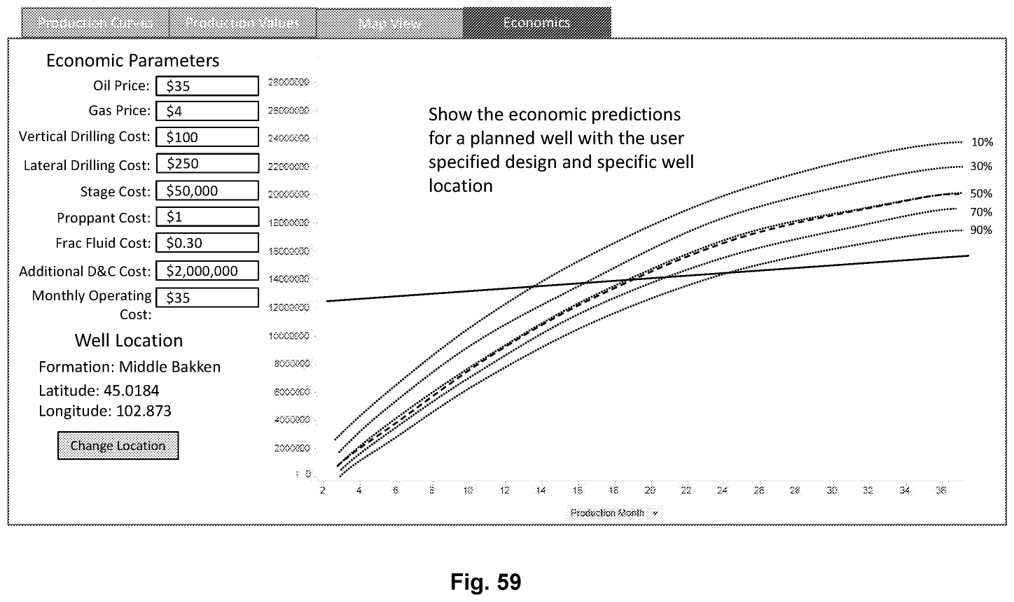

FIG. 59 provides a dashboard interface that may be used to evaluate the projected financial performance of a planned well. Once the well parameters are established as discussed above with respect to FIG. 58, a user can input various economic parameters (including, for example, oil price, gas price, vertical drilling cost, lateral drilling cost, stage cost, fracking fluid cost, additional drilling and completions, cost, and monthly operating cost, as discussed above with respect to FIG. 55) to determine how fluctuations in the selling price of oil and/or gas, or in the costs of labor and/or materials, might affect the financial performance of the planned well. This information may be used, for example, to make decisions about at what price of oil and/or gas the well becomes financially viable or ceases to be financially viable.

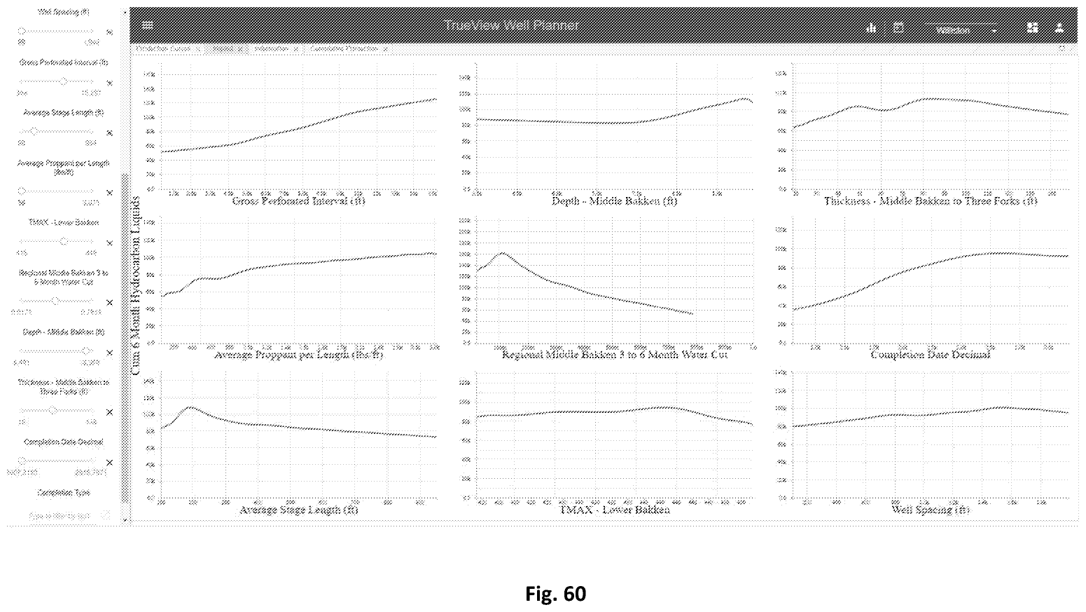

Additionally, in some embodiments of the present disclosure, prediction impact plots may be generated and displayed to allow a user to explore the impact of each variable on the predicted performance of a well. FIG. 60, for example, shows a set of prediction impact plots, each showing how changing a single variable is predicted to affect the well performance. For example, increasing the Gross Perforated Interval from 6,000 feet to 12,000 feet is predicted to increase well production from 60,000 bbl to 90,000 bbl. These plots assume a fixed value for every other parameter, which assumed fixed values are specified using the slider bars such as those depicted in the control panel on the left side of FIG. 60.

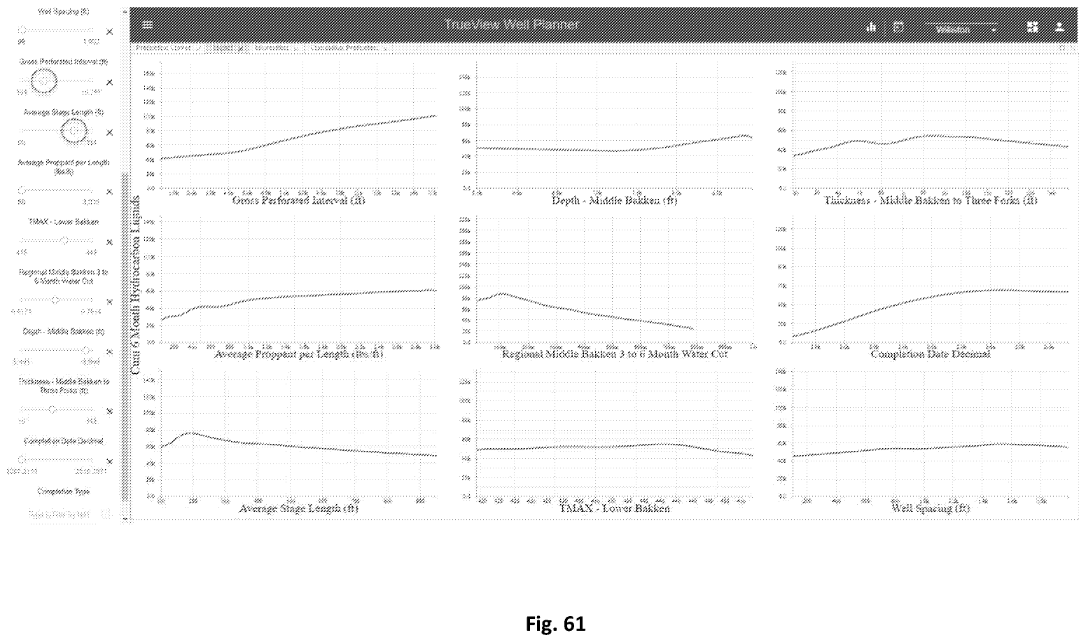

With reference to FIGS. 60 and 61, changing the fixed values in the control panel causes the impact plots to update to show the prediction relationships for the new set of parameters. These plots are useful for understanding how the model is working and why it makes the predictions that it makes. The relationships are non-linear, which allows for the model to determine points of diminishing returns, such as in the Average Proppant per Length (lbs/ft) plot, which shows that an increase in the Average Proppant per Length has a positive but small effect on production beyond the 1,500 Lbs/ft mark.

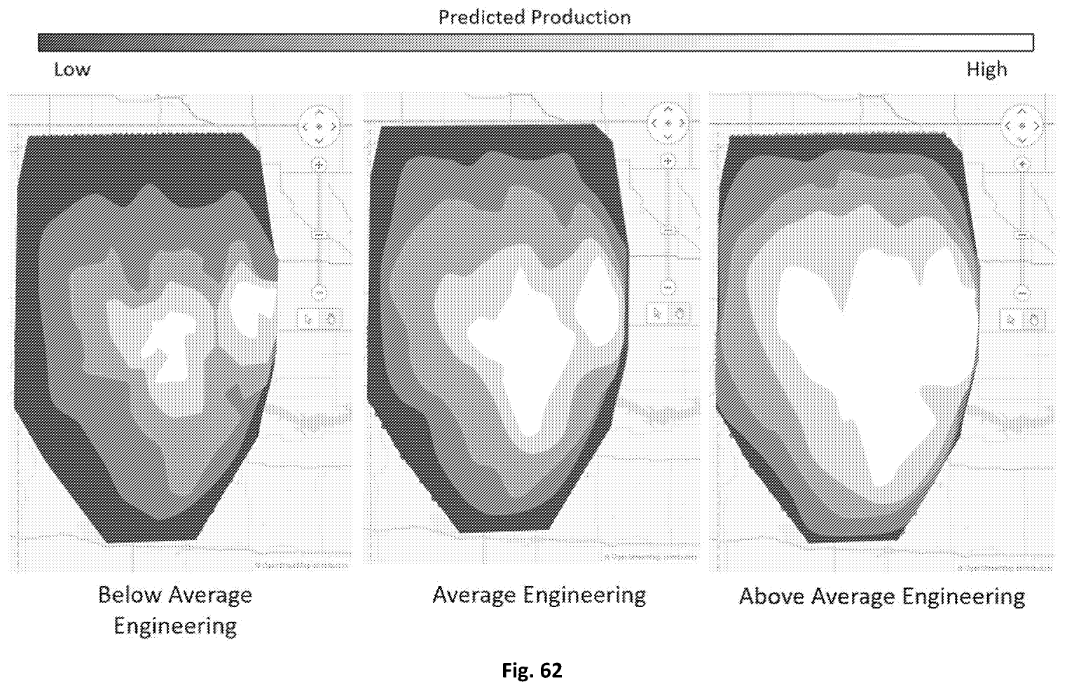

In step (26) of FIG. 15, the prediction models and geologic attribute maps are used to create maps that identify the predicted most productive locations for new wells. A user can define the design of a new well, and the map can show the best locations (e.g. the locations with the greatest predicted production) to drill the new well. For example, FIG. 62 shows a series of three maps that identify, by location, the predicted production for a new well of a given design. The maps also illustrate the impact that the quality of engineering has on the performance of the well, with a significantly higher percentage of the “above average engineering” map indicating a maximum expected production than the “below average engineering” map. Thus, wells with above average engineering—e.g., wells with a longer horizontal length (such that more of the well is in contact with the producing reservoir), more hydraulic fracture stages, more hydraulic fracture fluid, and/or greater proppant mass than the average horizontal length, number of hydraulic fracture stages, amount of hydraulic fracture fluid, and proppant mass, respectively—are predicted to produce more than wells with below average engineering (e.g., wells with lower than average horizontal length, number of hydraulic fracture stages, amount of hydraulic fracture fluid, and proppant mass).

In step (27), existing well location and directional surveys for a given operator, as well as boundary information for the operator's acreage, are used to estimate the number of remaining new well locations for the operator. The production prediction map is used to predict the production of the remaining new locations, which can then be ranked in order of greatest predicted production. Additionally, charts can be generated that show the total number of remaining well locations and the total remaining production reserve for each operator.

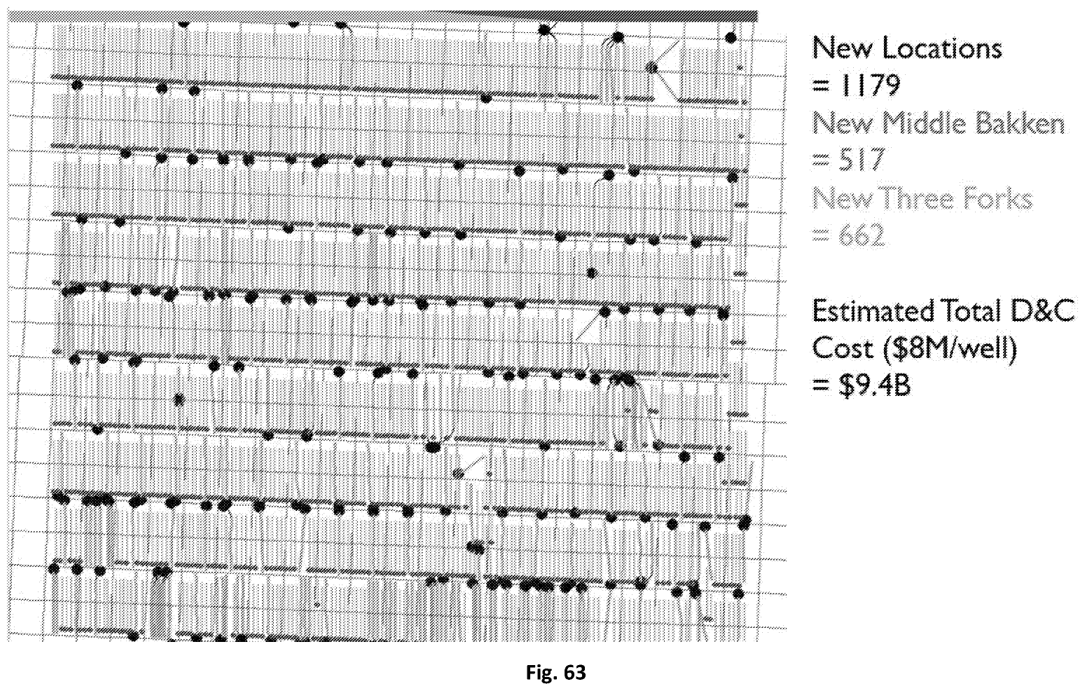

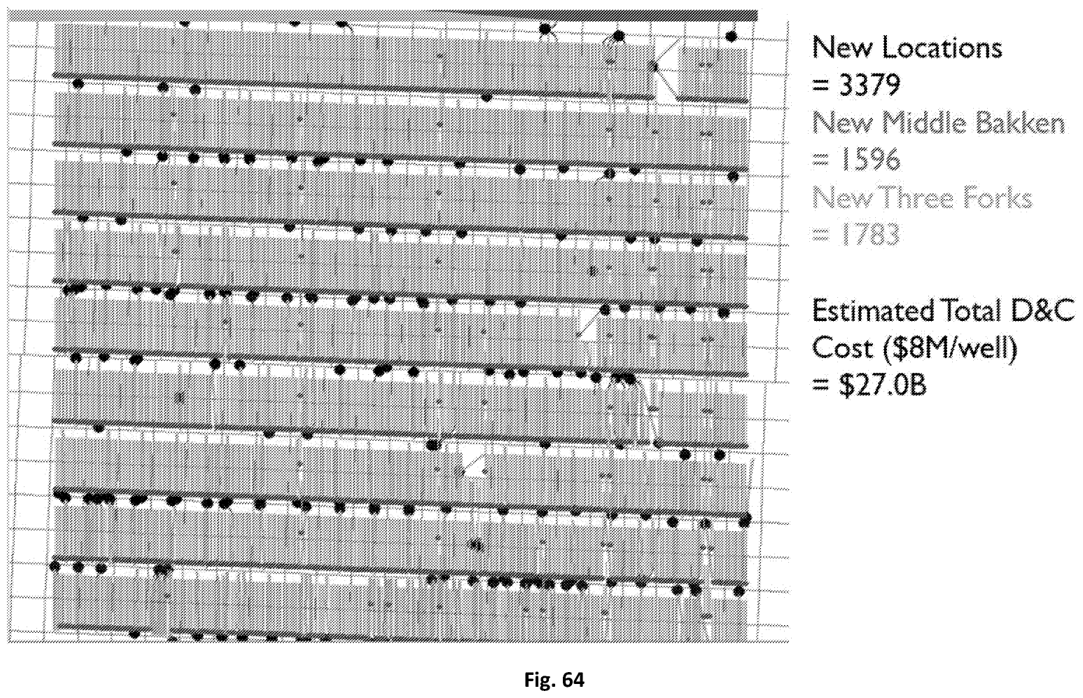

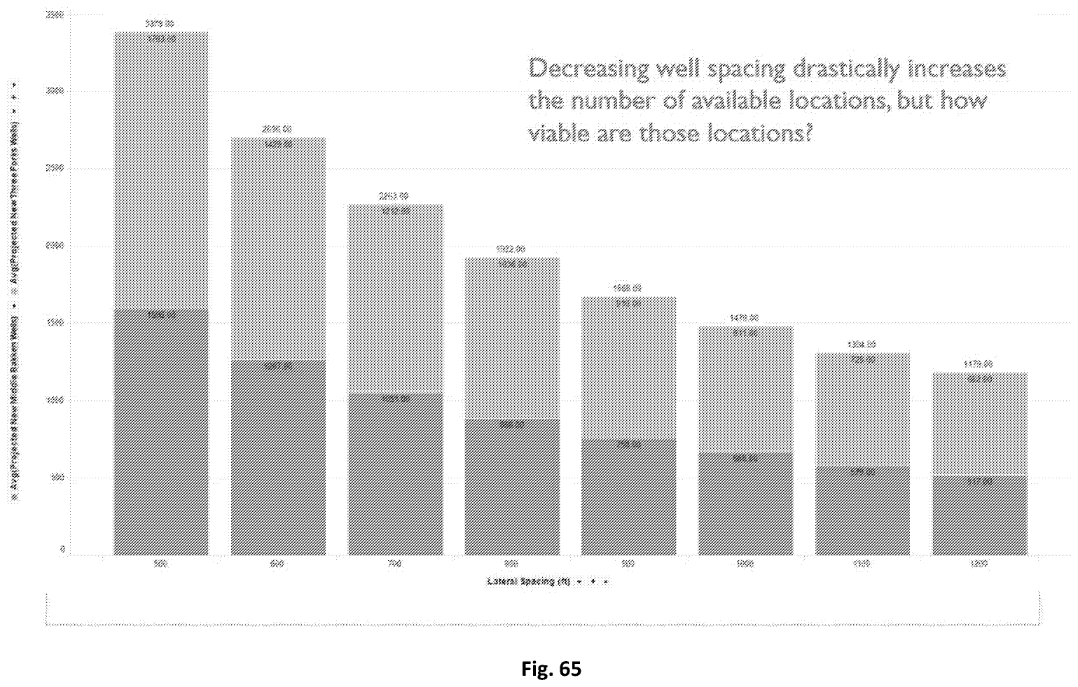

For example, FIGS. 63-64 identify available locations for new wells in a given area. The wells are categorized based on the formation into which they would be drilled (e.g. Middle Bakken or Three Forks). The well locations identified in FIG. 63 are based upon a lateral well spacing of 1200 feet between wells, and the well locations identified in FIG. 64 are based upon a lateral well spacing of 500 feet between wells. As a result, a significantly greater number of new locations are identified in FIG. 64 than in FIG. 63. The chart in FIG. 65 shows how the lateral well spacing affects the number of available new well locations, as well as providing a breakdown between wells that would be drilled into the Middle Bakken formation and wells that would be drilled into the Three Forks formation. Assuming that the drilling and completion cost of each new well is $8 million, the number of new wells can be multiplied by $8 million to obtain the total expected cost of drilling and completing all of the available wells. This total expected of drilling and completion ranges from $9.4 billion for 1179 new wells with a lateral spacing of 1200 feet, to $27.0 billion for 3379 new wells with a lateral spacing of 500 feet.

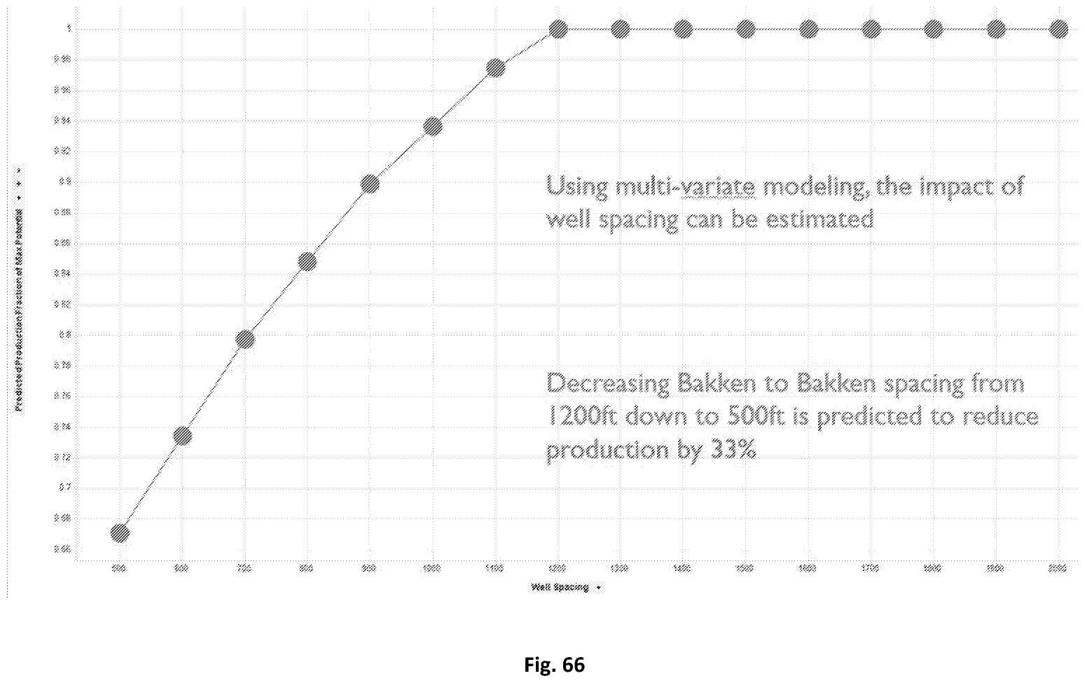

Importantly, the lateral spacing between wells affects the productivity of the wells, such that placing wells in close proximity to each other will reduce the amount of production from each well. To identify the number of wells that will lead to maximum production (and hence maximum profitability), it is therefore necessary to evaluate the expected impact on total production of reduced lateral spacing. FIG. 66 depicts a graph of the predicted well production (as a fraction of the maximum predicted production given unlimited lateral well spacing) versus well spacing, generated using the methods described herein. As evident from this graph, wells having a lateral spacing of 500 feet are predicted to produce only 66%, or approximately 2/3, of their maximum potential production. This percentage of maximum potential production rises fairly significantly with each 100-foot increase in well space, with wells laterally spaced at 1200 feet predicted to achieve their maximum potential production.

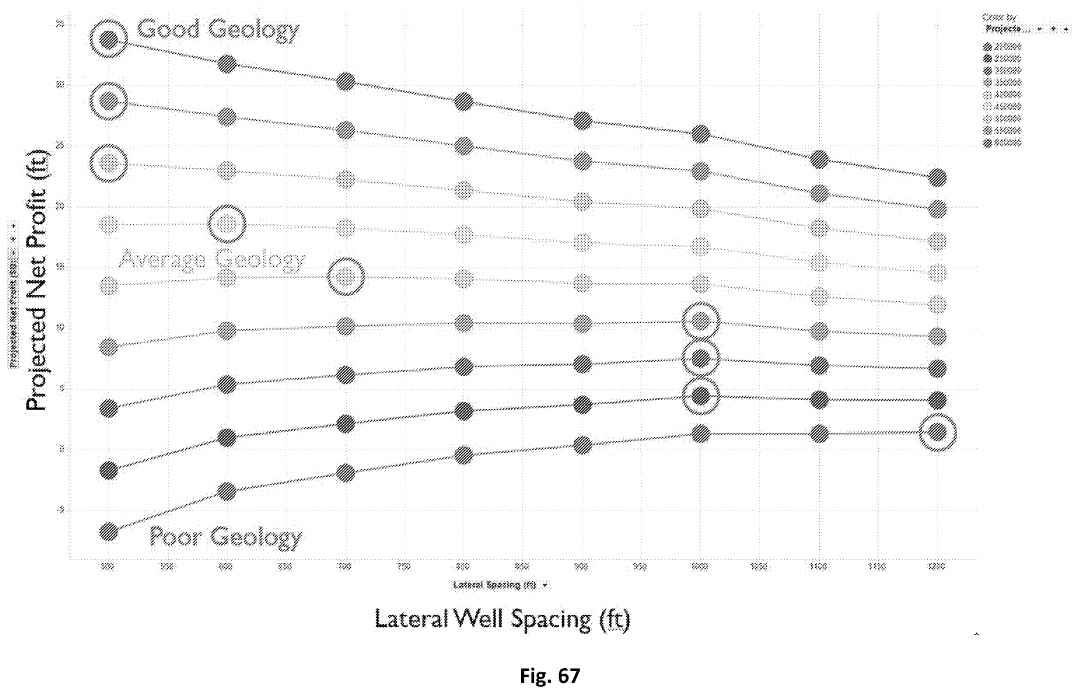

FIG. 67 provides a graph showing, for various types of geology ranging from poor to average to good, the projected net profit in billions of dollars as a function of lateral well spacing. Using a graph like that of FIG. 67, a user of the systems and methods of the present disclosure can make a better-informed decision about whether to install wells with maximum lateral spacing, minimum lateral spacing, or somewhere in between. For example, based on the graph of FIG. 67 (and recognizing that graphs for actual conditions given other locations and other well designs will necessarily be different than the graph of FIG. 67), a user could decide that because the geology in the area in question is good, profit can be maximized by installing wells with minimum spacing. Alternatively, a user could decide that because the geology in the area in question is poor, profit can be maximized by installing wells with maximum spacing.

A graph such as that of FIG. 67 can only be relied upon for the purpose of making key decisions about the number of wells to drill and the location of those wells if the graph is based on sound predictions, which are achievable through the systems and methods described herein. Stated differently, the ability of the systems and methods of the present disclosure to obtain relevant data, fill in missing data, and utilize machine learning and historical data to make predictions, compare those predictions with actual results, then improve the prediction algorithms based on the comparison enables the generation of graphs such as that depicted in FIG. 67.

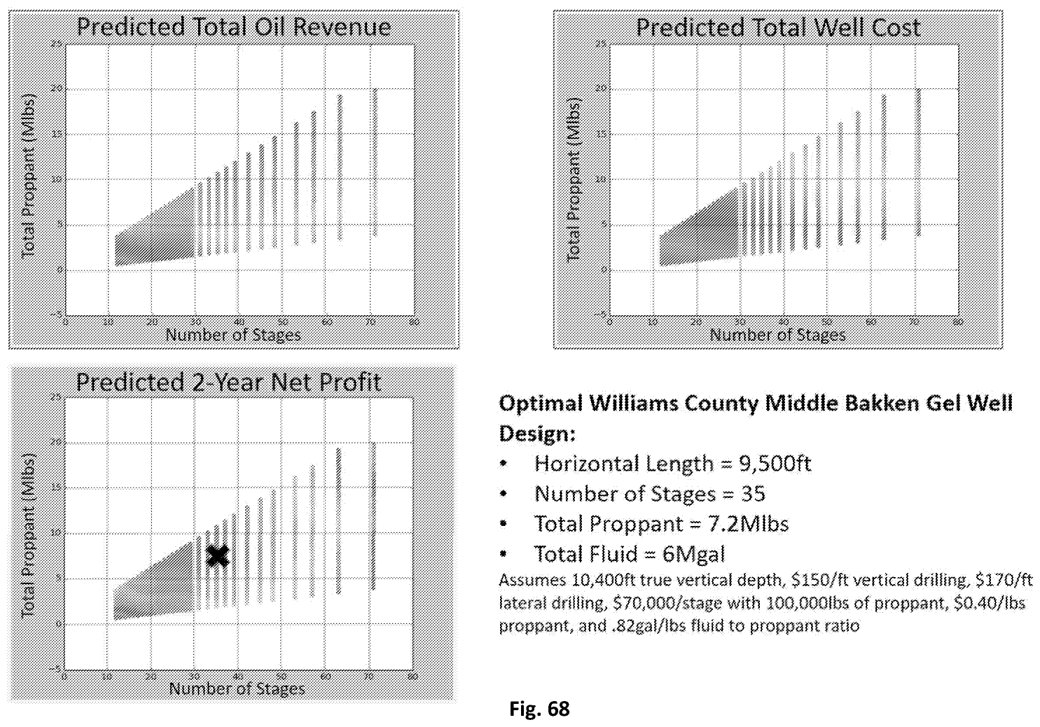

Turning now to FIG. 68, the predictions achievable through the systems and methods of the present disclosure also enable the preparation of charts showing the predicted total oil revenue for various combinations of total proppant amount and number of stages. The chart in the upper left-hand corner of FIG. 68, for example, shows that oil revenues will be small for a well with 10-20 stages and fewer than 1-2 million pounds of proppant, but large for a well with 40-70 stages and more than 12-15 million pounds of proppant. However, as shown in the chart in the upper right-hand corner of FIG. 68, the cost associated with drilling and completing the well with 10-20 stages and fewer than 1-2 million pounds of proppant would be very low, while the cost of drilling and completing the well with 40-70 stages and more than 12-15 million pounds of proppant would be very high. This data can be combined to identify the combination of number of stages and total proppant amount that will result in the well with the greatest profit (e.g. the greatest difference between predicted total revenue and predicted total cost). In this example, the well with the greatest predicted profit is on that has 35 stages and uses 7.2 million pounds of proppant.

The predictions upon which the charts of FIG. 68 are based necessarily depend upon certain assumptions, which can be modified by a user of the systems and methods disclosed herein to explore the effect of variations in those assumptions on the predicted optimal well design. Persons of ordinary skill in the art could therefore use the systems and methods disclosed herein to identify a design envelope, defined by a minimum and maximum proppant amount and a minimum and maximum number of stages, within which predicted profitability is expected to remain above a certain level notwithstanding one or more variations in the underlying assumptions of the model. In this manner, such persons can beneficially reduce risk and protect against the wasteful use of resources (e.g. such as drilling a well according to a particular design that renders the well economically susceptible to a minor variation in, for example, the cost of proppant, or the cost of drilling, or the cost of adding each stage).

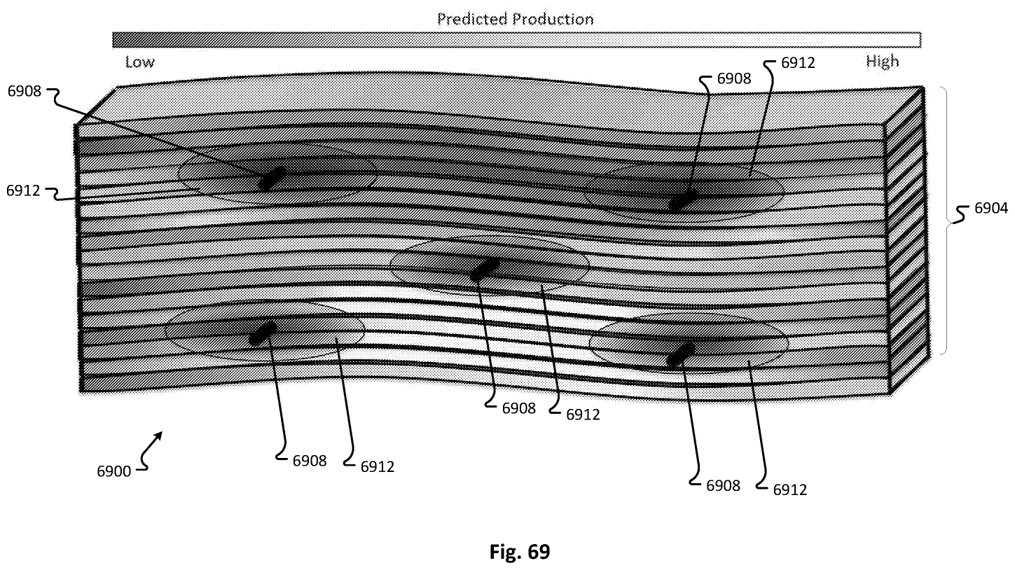

In some embodiments of the present disclosure, a system 100 is configured to generate three-dimensional production prediction models for display to a user. Such models can be created either by using the results of an AVAS model applied to a three-dimensional volume of geologic properties, or by using the results of multiple AVAS models, each applied to a separate one of a plurality of two-dimensional geologic property maps, which plurality of two-dimensional geologic property maps are then stacked together vertically to create a three-dimensional volume. FIG. 69, for example, shows a three-dimensional production prediction model 6900 generated by applying an AVAS model to each of a plurality of two-dimensional geologic property maps 6904, and then stacking the plurality of two-dimensional geologic property maps 6904 to obtain a three-dimensional model.

Where the three-dimensional production prediction model encompasses existing wells, such wells can be illustrated in the three-dimensional model. In FIG. 69, for example, a plurality of existing wells 6908 are shown intersecting the three-dimensional model. FIG. 69 also shows volumes 6912 in which predicted resource volumes are penalized or reduced due to the presence of the existing well. The appropriate penalty to be applied to volumes 6912 is determined using the well spacing and depletion relationships determined through multi-variate modeling as discussed above with respect to FIGS. 41-47. Moreover, the penalty increases as the distance from each existing well 6908 decreases, consistent with the modeling described with respect to FIGS. 41-47.

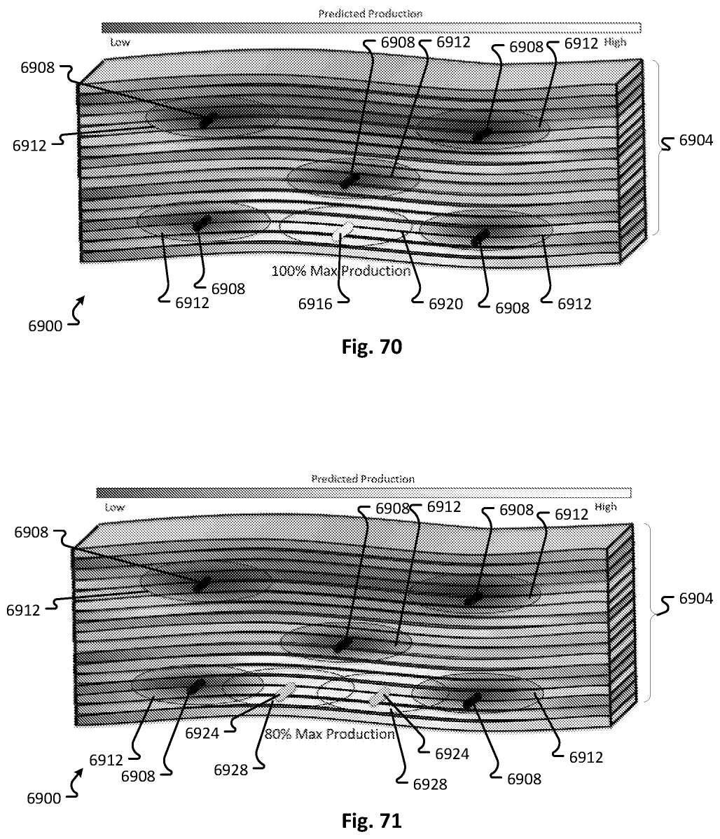

Turning now to FIG. 70, a new well 6916 can be planned using the three-dimensional prediction volume 6900. When the planned well 6916 is outside the sphere of influence of neighbor wells (e.g., outside of the volumes 6912), the production of the new well 6916 is predicted from the three-dimensional prediction volume generated based on the drilling and completions designs for the planned well 6916. The volume 6920 from which the planned well 6916 will produce does not intersect with the volumes 6912 associated with any neighboring wells, and so the production prediction for the planned well 6916 does not need to be penalized using the well spacing and depletion estimates described above.

Referring to FIG. 71, when planned wells 6924 begin to overlap the sphere of influence of existing wells (and/or of each other), the production prediction for those wells is decreased based on the well spacing penalty function determined by the prediction model. The planned wells 6924 in the example shown in FIG. 71, for example, are associated with production volumes 6928 that overlap each other and the volumes 6912 of their respective neighboring wells. As a result, the production prediction for the planned wells 6924 is only eighty percent of the maximum production prediction for the production volume in which the wells 6924 will be placed. Thus, the three-dimensional prediction model takes into account the effect of neighboring wells when predicting the production of new wells.

Systems and methods according to some embodiments of the present disclosure may include geologic hazard identification, mapping, and/or avoidance. Geologic hazards, like faulting or karsts, can dramatically affect the production of wells. Wells passing through a geologic hazard risk being out of zone for significant portions of their wellbore, which reduces their contact with the producing reservoir. Also, close proximity to a geologic hazard may decrease the effectiveness of hydraulic fracturing of wells as injected fluid may find the hazard constitutes a path of lower resistance than fracturing the reservoir. As a result, the reservoir may receive less than the planned amount of stimulation fluid (as much of it may instead go into the hazard), and obtaining necessary pressures during stimulation may be difficult. Thus, identifying wells that have passed through a hazard or that are in close proximity to a hazard may be important, and identifying and mapping such hazards may be useful for planning future wells.

Often, geologic hazards are identified using 3D seismic imaging that can reveal geologic features, including hazards. Such data is seldom publicly available. Moreover, horizontal wells often undulate up or down vertically. Even so, there are particular drilling profiles that are less common and that are indicative of wells encountering geologic hazards. For example, a wellbore that displays a sudden change in inclination and a significant change in true vertical depth, bracketed before and after by relative consistency in inclination and depth, indicates a high probability that a geologic hazard was encountered. Such a scenario may occur when a well being drilled in a specific target zone encounters a fault. The target zone would suddenly be higher or lower in depth, and the well would typically steer towards the new location of the target zone to reach it as quickly as possible. Once the well reaches the target zone again, it would resume drilling at a more consistent inclination and depth.

In some embodiments of the present disclosure, then, the drilling profile of all wells is evaluated. Wells that likely encountered a geologic hazard, based on an inclination and depth change threshold, are identified. The location along the well where the hazard was encountered is also identified. If multiple wells have encountered the same hazard, the hazard can be mapped by connecting the points of intersection between the well and the hazard both spatially and vertically. Once the hazards have been identified, the distance of all wells to the nearest hazard can be calculated, and may serve as an important attribute in the analytics described herein.

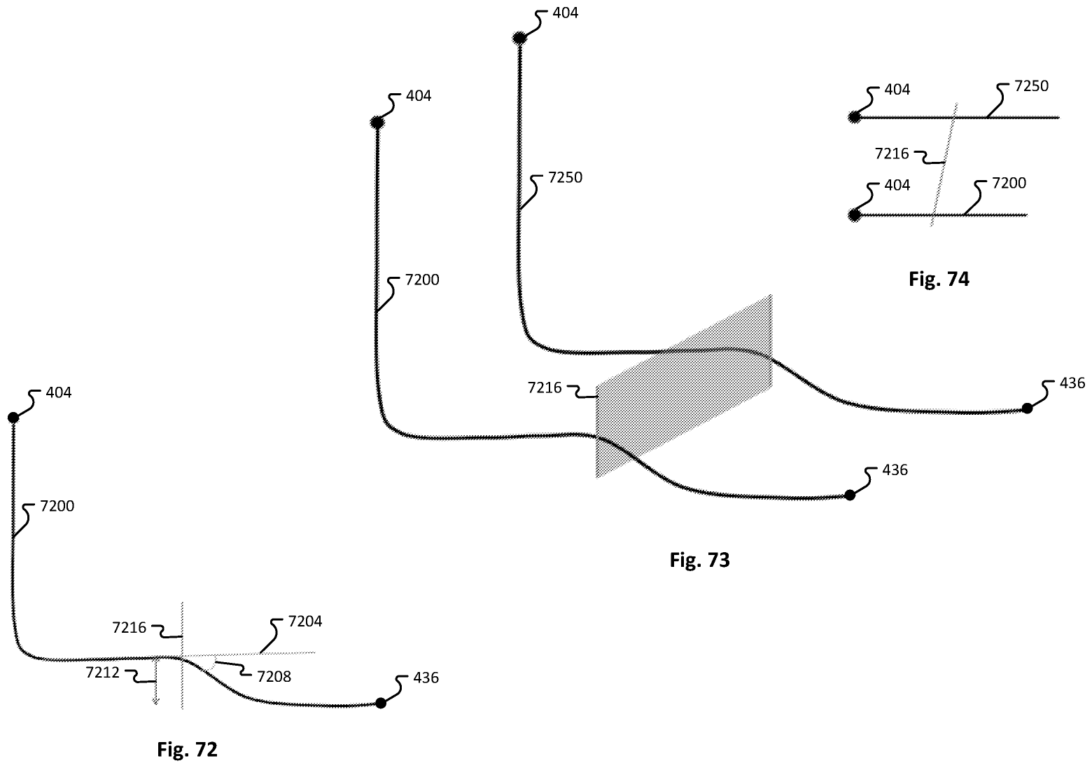

Referring now to FIG. 72, a wellbore 7200 has a surface location 404 and bottom hole location 436. The horizontal portion of the wellbore 7200 has an average inclination 7204, but has a sudden change in inclination 7208 relative to the average inclination 7204 along its length. The change in inclination 7208 corresponds to a change in the true vertical depth 7212 of the horizontal portion of the wellbore 7200. Based upon the sudden change in inclination 7208 and the change in true vertical depth 7212 exceeding predetermined thresholds (and, in some embodiments, based on the relatively consistent inclination of the horizontal portion of the wellbore 7200 before the sudden change in inclination 7208 and closer to the bottom hole location 436), a potential hazard 7216 is flagged.

Referring now to FIG. 73, when the same or similar changes in inclination and true vertical depth occur both in the wellbore 7200 and in a neighboring wellbore 7250, the potential hazard 7216 can be flagged for both wellbores 7200 and 7250, and an estimated path of the geologic hazard 7216 can be generated by connecting the locations where the wellbores 7200 and 7250 intersect the potential hazard 7216. FIG. 74 shows a map view of the geologic hazard 7216 extending between the wellbores 7200 and 7250.

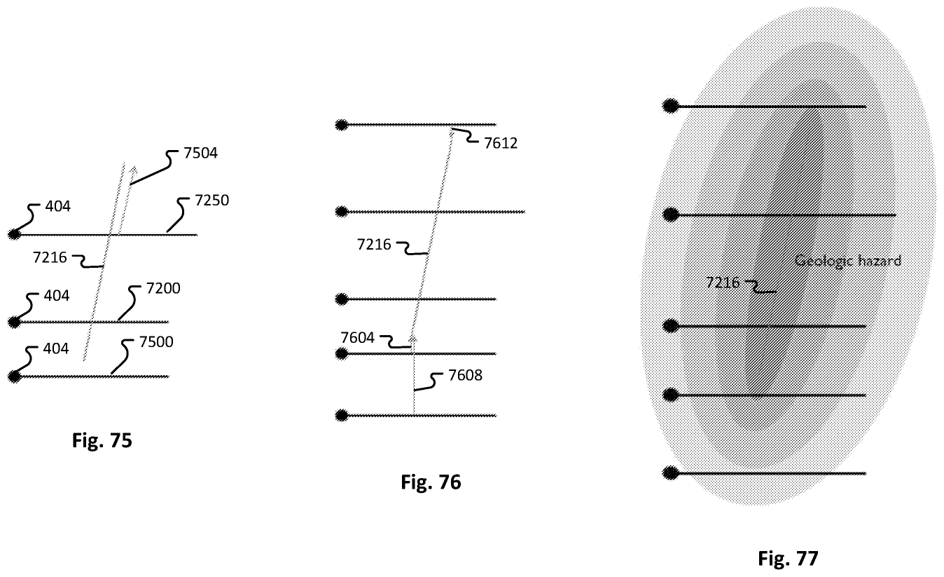

As shown in FIG. 75, the geologic hazard 7216 can be projected away from a well that intersects the hazard out to a specified distance 7504, or until the hazard 7216 approaches a wellbore 7500 for which there is no indication of the hazard, in which case the hazard can be assumed to terminate prior to reaching the wellbore 7500.

Referring now to FIG. 76, once the length and position of the geologic hazard 7216 have been estimated, the minimum distances 7604, 7608, and 7612 from nearby wells to the nearest geologic hazard 7216 can be calculated, as can the average distance of each well to the nearest geologic hazard. One or both of these distances can then be considered as an attribute of each well.

With reference to FIG. 77, a two-dimensional map (as shown in FIG. 77) or a three-dimensional volume of the distance to the nearest geologic hazard can be created. This map may be used to help plan new wells that remain a safe distance away from identified geologic hazards.

The systems and methods described herein may be incorporated into drilling equipment. For example, the systems and methods described herein may be used by or in conjunction with a control center for a drilling rig. The drilling rig may have, for example, a support structure, a winch mounted to the support structure for raising and lowering a drill head; a drive system affixed to the support structure for turning the drill head; and a control system for controlling the movement of the drill head. The control system may enable the drill head to drill both vertical and horizontal wells. The control system may comprise one or more of the components of the device 100 described with respect to FIG. 1 herein, including, for example, a processor, a database interface, and a memory storing instructions for execution by the processor that, when executed by the processor, cause the processor to receive well data about other wells from a plurality of databases; process the well data for quality control; generate a plurality of production predictions for a new well based on the well data and a hypothetical set of well design parameters, wherein each of the plurality of production predictions is associated with a different hypothetical set of well design parameters; identify a preferred hypothetical set of well design parameters based on a comparison of the plurality of production predictions; and cause the drill head to drill a well based on the preferred hypothetical set of well design parameters.

As new information is added to the databases that provide the data upon which production predictions are based, the production predictions are continuously or periodically updated. Then, the updated predictions are used to assess the predicted production of various well designs at the drilling location, iterating such items as number of stages, amount of proppant used, vertical depth, and horizontal depth. This information is then used to optimize the well construction.

Additionally, the systems and methods described herein may be used in conjunction with existing wells. For example, wells may be fitted with sensors that record one or more variables associated with operation of the well, such as total production, amount of production by material type (e.g. oil, gas, water, and condensate), and so forth. This data may be provided via wired or wireless connection to one or more databases associated with a device 100, or the data may be provided directly to a device 100. The information can then be used to update predictions for the well in question and for other existing and planned wells.

Notably, while information about third party wells typically must be obtained via government records and other publicly available data, some of which is subject to a confidentiality period that prevents instantaneous use of such information for the updating of predictions made using the systems and methods described herein, a user of the systems and methods described herein may provide information from his or her own wells for use in the systems and methods described herein as soon as such information is available. The installation of sensors on a well to enable the automatic provision of information for use in making and updating predictions may therefore be particularly useful for users of the present disclosure.

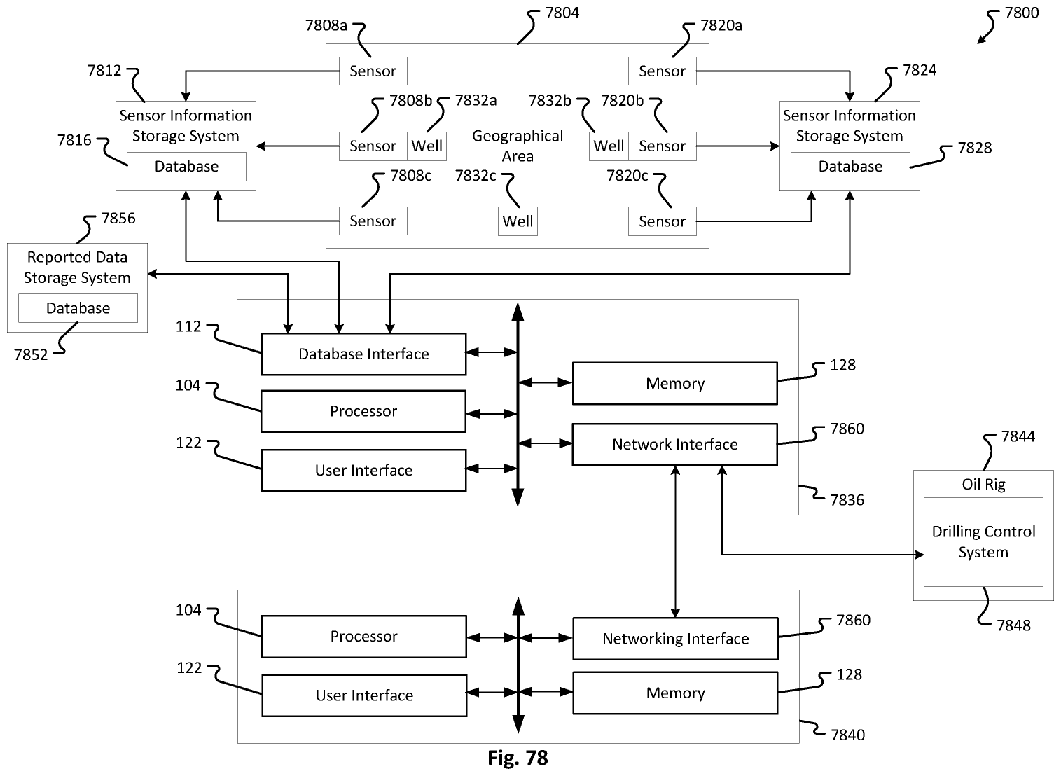

Referring now to FIG. 78, a system 7800 comprises a plurality of sensors 7808 and 7820 that sense or measure one or more geologic attributes within a defined geographic area 7804. Some of the sensors 7808 and/or 7820 may also sense or measure one or more well attributes of wells 7832 located within the geographic area 7804. The sensors 7808 are configured to report sensed or measured data to a sensor information storage system 7812. The sensors 7808 may be configured to report the data via a wired or wireless connection with the sensor information storage system 7812. In some embodiments, the sensors 7808 may be configured to transmit the data to the sensor information storage system 7812 via a local area network or a wide area network (such as the Internet). The sensors 7820 may be configured to report sensed or measured data to a sensor information storage system 7824, which reporting may happen in any of the ways described above with respect to the sensors 7808 and the sensor information storage system 7812.

The sensor information storage systems 7812 and 7824 are configured to receive data from one or more sensors and to store the received data in a database 7816 or 7828, respectively, or other data compilation. The sensor information storage systems 7812 and 7824 may be equipped with a processor, a memory, one or more sensor interfaces, one or more network interfaces, and/or other components necessary or useful for collecting data from the sensors 7808 and 7812 and storing the data for later retrieval.

In some embodiments, information about one or more attributes of one or more of the wells 7832 within the geographical area 7804, and/or information about one or more geologic attributes of the geographical area 7804 itself may be measured, detected, collected, or otherwise obtained from a source other than the sensors 7808 and 7812. Such data may be reported to a reported data storage system 7856 (which may, in some instances, may be operated by a government or regulatory agency with jurisdiction over the geographical area 7804). The reported data storage system 7856 may compile the reported data in one or more databases 7852. The reported data storage system 7856 may comprise a processor, a memory, one or more network interfaces, a user interface, and/or other components useful or necessary for receiving or collecting reported data and storing the data for later retrieval.

The system 7800 also comprises a computational device 7836, which may be the same as or similar to the device 100 described elsewhere herein. The computational device 7836 comprises a processor 104, a database interface 112, a user interface 122, and a memory 128, all of which are described above. The computational device 7836 also comprises a network interface 7860. The database interface 112 enables the processor 104 to transmit queries to both the sensor information storage system 7812 and the sensor information storage system 7824, and also facilitates receipt of at least some data from the database 7816 and of at least some data from the database 7828.

The memory 128 stores instructions for causing the processor 104 to execute any one or more of the processes and methods described herein. For example, in some embodiments, the memory 128 stores instructions for causing the processor 104 to generate structural model for at least some of the geographical area 7804 based on at least some of the data from the database 7816 and at least some of the data from the database 7828. The structural model may also be based on at least some of the data from the database 7852, which may also be queried by the processor 104 via the database interface 112, and which may also provide data to the processor 104 via the database interface 112. The structural model may be generated by the processor 104 based on not only the data identified above, but also based on a set of rules that define one or more characteristics of geologic layers or formations corresponding to the defined geographic area 7804. The processor 104 may also execute instructions stored in the memory 128 that cause the processor 104 to assign one or more of the wells 7832 to a geologic layer or formation within the generated structural model.

The memory 128 may further store instructions for causing the processor 104 to prepare an analysis of the generated structural model that includes a prediction of performance for at least one of the wells 7832 within the geographical area 7804, or for a planned well that has not yet been drilled in the geographical area 7804. The prediction of performance may be based, at least in part, on a location of the at least one well within the structural model, a length of the at least one well, an average distance from the at least one well to a bottom of a formation in the structural model, a distance between wells in the geographical area, and an average percentage location between a top and bottom of a primary formation in the structural model.

The memory 128 may still further store instructions for causing the processor 104 to generate a geologic property map for at least some of the geographical area 7804 based on some or all of the data received from the databases 7816, 7828, and/or 7852. The geologic property map may be generated with reference to historical production information for the at least one well.

The memory 128 may still further store instructions for causing the processor 104 to generate user interface presentation instructions for causing the display of the prediction of performance for the at least one well along with one or both of: (i) the geologic property map and (ii) the structural model. The instructions may be provided to the user interface 122, or transmitted via the network interface 7860 to the user device 7840. The instructions may result in the display of the performance prediction, the geologic property map, and/or the structural model in a browser-based format. in some embodiments, the instructions may also cause the display of a probability associated with the performance prediction. In some embodiments, the memory 128 may store instructions for causing the processor 104 to transmit an optimal well design (or instructions for drilling a well having an optimal design), generated based on the structural model and for a specified location, to the drilling control system 7848 of an oil rig 7844. The drilling control system 7848 may then use the optimal well design received from the computational device 7836, or the instructions for drilling a well having an optimal design received from the computational device 7836, to drill a well having the optimal design at the specified location. In such embodiments, the oil rig 7844 may already be located at the specified location within the geographical area 7804, or the oil rig may be moveable to the specified location within the geographical area 7804. In embodiments where the user interface presentation instructions are provided to the user interface 122 of the computational device 7836 itself, the instructions may cause a display of the user interface 122 to display the prediction of performance for the at least one well along with one or both of: (i) the geologic property map and (ii) the structural model. Regardless of the location of the display that receives the user interface presentation instructions, the display may comprise at least one graphical user interface (GUI) element based on the user interface presentation instructions.

The user device 7840 comprises a network interface 7860, a processor 104, a memory 128, and a user interface 122, which comprise, for example, at least a display. The user interface presentation instructions transmitted by the computational device 7836 may be received at the network interface 7860 of the user device 7840, and may further be stored in the memory 128 of the user device 7840. The processor 104 of the user device 7840 may execute the received and stored instructions, as a result of which the display of the user interface 122 may display to a user the prediction of performance for the at least one well along with one or both of: (i) the geologic property map and (ii) the structural model. In some embodiments, the display may comprise one or more controls for adjusting one or more parameters utilized by the computational device 7836 to generate the performance prediction, and the user may adjust the one or more controls. Such adjustment may cause the processor 104 to transmit one or more corresponding signals to the computational device 7836 via the network interfaces 7860. The computational device 7836 may then update the performance prediction based upon the information received from the user device 7840, and transmit updated user interface presentation instructions to the user device 7840. The processor 104 of the user device 7840 may execute the updated user interface presentation instructions, so as to display the updated performance prediction to a user thereof.

In some embodiments, the user device 7840 may receive sufficient information about the performance prediction, the geologic property map, and/or the structural model to permit the processor 104 to update the performance prediction based on any changes in parameters specified by a user of the user device 7840.

In some embodiments, all of the data received by the computational device 7836 may be obtained from one or more reported data storage systems 7856. Also in some embodiments, all of the data received by the computational device 7836 may be obtained from one or more sensor information storage systems 7812 and 7824. In still other embodiments, the data received by the computational device 7836 may be obtained from both the sensor information storage systems 7812 and 7824 and the reported data storage system 7856.

In some embodiments, database interface 112 of the computational device 7836 (or the processor 104 of the computational device 7836) structures the queries to the sensor information storage systems 7812 and 7820 based on an identifier of the at least one well, a location of the at least one well, a location of the geographical area, and/or an identifier of the geographical area. Also in some embodiments, the memory 128 of the computational device 7836 temporarily stores the at least some of the data received from the sensor information storage systems 7812 and 7820 and/or from the reported data storage system 7856, while the instructions stored in the memory 128 are executed by the processor 104.

The sensor information storage system 7812 and the sensor information storage system 7824 may be operated by different entities. Communications between the computational device 7836 and the sensor information storage systems 7812 and 7824 may utilize a standard-based database query protocol, and may be transmitted either directly between the computational device 7836 and the sensor information storage systems 7812 and 7824, or indirectly over a communication network.

A number of variations and modifications of the foregoing disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, and ARM® Cortex-A and ARIV1926EJ-S™ processors. A processor as disclosed herein may perform computational functions using any known or future-developed standard, instruction set, libraries, and/or architecture.

1. A system, comprising:
a plurality of sensors distributed throughout a geographical area, wherein the plurality of sensors convert information related to the geographical area into sensor data;
a first sensor information storage system that receives sensor data from a first subset of the plurality of sensors and stores the sensor data received from the first subset of the plurality of sensors in a first database as first sensor data;
a second sensor information storage system that receives sensor data from a second subset of the plurality of sensors and stores the sensor data received from the second subset of the plurality of sensors in a second database as second sensor data, wherein the second sensor data is different from the first sensor data and is used to describe a different physical aspect of the geographical area;
at least one well positioned in or near the geographical area; and
a computational device, comprising:
a processor;
a database interface that enables the processor to transmit queries to both the first sensor information storage system and the second sensor information storage system, wherein the database interface further facilitates receipt of at least some first sensor data and at least some second sensor data from the first sensor information storage system and second sensor information storage system, respectively;
a memory device that includes instructions stored thereon that enable the processor to perform the following:
generate a structural model for at least some of the geographical area based on the at least some first sensor data and the at least some second sensor data, wherein the structural model is generated with reference to a set of rules that define one or more characteristics of geologic layers or formations, and wherein the structural model includes an assignment of the at least one well thereto;
prepare an analysis of the structural model that includes a prediction of performance for the at least one well, wherein the prediction of performance is based, at least in part, on a location of the at least one well within the structural model, a length of the at least one well, an average distance from the at least one well to a bottom of a formation in the structural model, a distance between wells in the geographical area, and an average percentage location between a top and bottom of a primary formation in the structural model;
generate a geologic property map for at least some of the geographical area based on the at least some first sensor data and the at least some second sensor data, wherein the geologic property map is generated with reference to historical production information for the at least one well; and
generate user interface presentation instructions for causing the display of the prediction of performance for the at least one well along with one or both of: (i) the geologic property map and (ii) the structural model.

2. The system of claim 1, wherein the database interface structures the queries to the first sensor information storage system and the second sensor information storage system based on an identifier of the at least one well, a location of the at least one well, a location of the geographical area, and/or an identifier of the geographical area.

3. The system of claim 1, wherein the memory device of the computational device temporarily stores the at least some first sensor data and the at least some second sensor data while the instructions are executed.

4. The system of claim 1, wherein the computational device comprises a user interface that renders at least one graphical user interface (GUI) element based on the user interface presentation instructions.

5. The system of claim 1, wherein the computational device further comprises a network interface that transmits the user interface presentation instructions to a client device in a browser-based format.

6. The system of claim 1, wherein the prediction of performance is displayed along with a probability of the prediction of performance.

7. The system of claim 1, wherein the prediction of performance is also based on a determined depletion metric or attribute.

8. The system of claim 1, wherein the first sensor information storage system is operated by a first entity, wherein the second sensor information storage system is operated by a second entity, and wherein the database queries are transmitted over a communication network using a standard-based database query protocol.

9. The system of claim 1, further comprising a reported data storage system in which reported data is stored;
wherein the database interface further enables the processor to transmit queries to the reported data storage system and further facilitates the receipt of at least some reported data from the reported data storage system;
wherein the generating the structural model is further based on the at least some reported data; and
wherein the generating the geologic property map is further based on the at least some reported data.

10. A server configured to predict well performance, comprising:
a processor;
a database interface that enables the processor to transmit queries to a plurality of databases, and facilitates the receipt of at least first data from a first database and second data from a second database, the first data and the second data corresponding to a plurality of wells within a geographic area;
a user interface comprising a display; and
a computer-readable memory storing instructions for execution by the processor that, when executed by the processor, cause the processor to:
identify one or more data gaps within the first data and the second data;
generate, for each data gap and using a mapping-set based machine learning technique, predicted data;
replace each data gap with the missing data to yield quality-controlled first data and quality-controlled second data;
generate, for each of the plurality of wells and based on the quality-controlled first data and the quality-controlled second data, a well attribute;
generate a structural model corresponding to the geographic area based on the well attribute of each of the plurality of wells, and based on a rule set that corresponds to one or more geological characteristics; and
predict, for a planned well within the geographic area and using the structural model, a planned well attribute.

11. The server of claim 10, wherein the well attribute is a depletion estimate attribute or metric.

12. The server of claim 11, wherein the depletion estimate attribute or metric for each well is based on both lateral and vertical distance to one or more neighboring wells.

13. The server of claim 10, wherein the computer-readable memory stores additional instructions for execution by the processor that, when executed by the processor, further cause the processor to:
generate instructions for causing the display to depict a graphical representation of the structural model, the planned well, and the planned well attribute.

14. The server of claim 10, wherein the generating a well attribute comprises generating a plurality of well attributes, the generating a structural model is based on the plurality of well attributes, and the predicting a planned well attribute comprises predicting a plurality of planned well attributes.

15. The server of claim 14, wherein the computer-readable memory stores additional instructions for execution by the processor that, when executed by the processor, further cause the processor to:
generate a production prediction for the planned well based on the plurality of planned well attributes.

16. The server of claim 15, wherein the computer-readable memory stores additional instructions for execution by the processor that, when executed by the processor, further cause the processor to:
identify, based on the structural model, a location within the geographic area where a new well would have a maximum production prediction.

17. The server of claim 14, wherein the computer-readable memory stores additional instructions for execution by the processor that, when executed by the processor, further cause the processor to:
generate a production prediction for each of a plurality of planned wells based on the structural model, wherein the production prediction accounts for depletion effects of the plurality of planned wells.

18. A method of predicting well production, comprising:
receiving at a processor, via a network interface and from a plurality of information storage sources, received information about a plurality of wells in a defined geographic area, the received information comprising well location data, fracking data, production test data, completion data, production data, and directional survey data;
detecting, with the processor, gaps within the received information, each gap corresponding to a missing data point;
generating, with the processor, a predicted data point corresponding to each missing data point using a mapping-set based machine learning technique;
substituting, with the processor, the gaps with the corresponding predicted data points to yield quality-controlled received information;
generating, with the processor, for each well in the plurality of wells and based on the quality-controlled received information, a plurality of attributes;
generating, with the processor and based on the quality-controlled received information and the plurality of attributes, and with reference to a set of rules defining characteristics of geologic layers or formations, a structural model corresponding to the defined geographic area;
analyzing, with the processor, the structural model to yield a result comprising one or more of (i) an optimal design for a new well at a specified location within the defined geographic area; (ii) an optimal number of new wells for the defined geographic area to maximize production from the defined geographic area; and (iii) a predicted performance of a new well at a specified location within the defined geographic area and having a specified design; and
transmitting, from the processor, instructions for displaying a graphical depiction of the result.

19. The method of claim 18, wherein the result is an optimal design for a new well at a specified location with the defined geographic area, and the method further comprises:
transmitting, from the processor and to a drilling control system of an oil rig, instructions for drilling a well having the optimal design.

20. The method of claim 18, wherein the structural model is three-dimensional, and further wherein generating the structural model comprises generating, with the processor and based on the plurality of attributes, a plurality of two-dimensional geologic property maps, and stacking the plurality of two-dimensional geologic property maps to yield the three-dimensional structural model.
